(19) United States
(12) Patent Application Publication
(10) Pub. No.: US 2024/0257228 A1
(43) Pub. Date: Aug. 1, 2024

(54) SYSTEMS AND METHODS FOR FACILITATING THE MANAGEMENT OF AUCTIONS INVOLVING BOTH FRACTIONAL OWNERSHIP BIDDERS AND WHOLE OWNERSHIP BIDDERS

(71) Applicant: ASHAREX INC., Los Angeles, CA (US)

(72) Inventors: Alan Snyder, Los Angeles, CA (US); Eric Arinsburg, Encino, CA (US); Kevin Hughes, Malibu, CA (US); Ryan Lesser Johnston, Los Angeles, CA (US); John Baohua Smith, Studio City, CA (US)

(21) Appl. No.: 18/411,851

(22) Filed: Jan. 12, 2024

Related U.S. Application Data
(60) Provisional application No. 63/438,874, filed on Jan. 13, 2023.

(51) Int. Cl. G06Q 30/08

(52) U.S. Cl. CPC G06Q 30/08

(57) ABSTRACT

Systems and methods facilitate managing an auction for contested resources between full bidding entities and fractional bidding entities that are enabled to place bids on the contested resources. Systems identify different bidding entities, including full bidding entities and fractional bidding entities, that are bidding on a contested resource. In a current bidding round corresponding to a current asking price of the contested resource, systems determine whether a total fractional bidding amount received from a fractional bidding group or a full bidding amount received from a full bidding entity at least meets the current asking price. When a bidding amount at least meets the current asking price, the systems terminate the current bidding round and initiate a new bidding round with a new, higher asking price for the contested resource.

### CROSS-REFERENCE TO RELATED APPLICATION

This application claims the benefit and priority of U.S. Provisional Patent Application Ser. No. 63/438,874 filed on Jan. 13, 2023, entitled “SYSTEM, METHODS, AND INTERFACES FOR FACILITATING FRACTIONAL BIDDING, POOLED REQUESTS, AND MANAGED ALLOCATIONS OF LIMITED RESOURCES,” and which application is expressly incorporated herein by reference in its entirety.

### BACKGROUND

Computers are capable of accessing and interfacing with various types of information stored in disparate formats and locations. Computers are able to process this information very quickly and efficiently. As a result, computers have become highly integrated in almost all industries.

Many software applications have been designed and customized to run on the computers to perform a wide variety of functions including the execution of specific tasks that can assist users' participating in business endeavors, schoolwork, entertainment, and more. Some of the tasks a computer may perform include the creation and management of electronic records that define or represent real-world objects, as well as digital/virtual objects. These electronic records, comprising files and metadata, can also be used to facilitate the tracking of ownership, authorship and other attributes associated with the referenced objects.

Some software applications have also been created to facilitate consumer transactions involving the purchase of a product or service (collectively referred to herein as a good or item). These software applications include marketplace applications, such as Amazon and direct retailer interfaces, where goods are sold at fixed prices. Other software applications facilitate consumer transactions through auctions, such as eBay and other auction-type interfaces.

An auction is a widely known form of conducting business. In an auction, a seller will publish an item or good that the seller wishes to sell. Buyers will view that item and, if they desire to purchase it, will submit a bid. If multiple buyers are interested in the item, then each buyer will attempt to outbid the other buyers until the highest bid price is reached. At that point in time, in some traditional auctions, the buyer having the highest bid will win the item. In other types of auctions, other criteria may be used to determine the winner of the auction item (e.g., priority of timestamp or other criteria).

While a few auction applications are currently available, they suffer many deficiencies and fail to satisfy many of the needs of today's consumers. For instance, conventional auction software does not currently facilitate management or participation in auctions that include bidding between multiple types of bidders, such as grouped entities of fractional bidders, and wherein the different bidders may each have different levels of investment qualifications (e.g., pre-approved investment amounts, accreditations, or other endorsements) and/or different bidding interests for obtaining fractional or full ownership of the auction items.

Such deficiencies in consumer transactions are also relevant to the limitations of conventional computer networks. For instance, conventional computer networks often include a plurality of distributed consumer nodes that compete for limited server resources (e.g., services, bandwidth, storage, tokens, processing, etc.).

In conventional systems, the contested resources are often awarded to the competing nodes on a predetermined first-to-request priority scheme, a round-robin allocation and/or as a result of a conflict resolution based a predetermined priority. In this regard, the competing nodes are essentially bidding for resources within a winner-take-all all type paradigm.

Sometimes a system may award requested resources (e.g., storage) to a requesting party based only upon first determining that the requesting party will provide certain reciprocating consideration (e.g., processor cycles for shared cloud computing, storage for distributed storage tasks, bandwidth of network links, etc.) which will be utilized by the server in consideration for awarding or providing the resources that are being requested by the competing nodes.

Unfortunately, even when the contested resources could be potentially shared among multiple requesting parties, conventional systems are not configured to consider and process shared requests as batched fractional requests. This prevents current systems from prioritizing and awarding the contested resources to the requesting entities (even if batched) that could otherwise provide the greatest consideration and reciprocal value for requested resources.

In view of the foregoing, it will be noted that conventional networks can be viewed as suffering an undesired computational opportunity cost represented by the potential computing cycles, storage or other consideration that is not received from a batched or shared group of nodes that could otherwise be received in consideration for awarding the requested resources (e.g., storage) to the shared group of nodes. This opportunity cost is caused, at least in part, because the conventional systems award the contested resources to only a single node according to a conventional winner-take-all paradigm, as mentioned above, even though the winning node may offer less consideration (e.g., computing cycles, storage, bandwidth) for the requested resources than could otherwise be obtained if the requested resources were awarded to a shared group of fractional bidding nodes.

In view of the foregoing, it will be appreciated that there is an ongoing need and desire for improved methods, systems, and interfaces for facilitating fractional bidding for goods and resources in auction-type transactions, as well as for records management software for facilitating allocation and tracking of the shared ownership of the goods/resources to be awarded to winning bidders associated with fractional bids.

The subject matter claimed herein is not limited to embodiments that solve any disadvantages or that operate only in environments such as those described above. Rather, this background is only provided to illustrate one sample technology area where some embodiments described herein may be practiced.

### SUMMARY

Disclosed embodiments are directed toward systems and methods for managing an auction for contested resources between full bidding entities and fractional bidding entities that are enabled to place bids on the contested resources. For example, systems are configured to identify a contested resource (e.g., an artwork, a document, a real estate property, a financial security, a computer resource, a transferable right or any other resource that is finite, defined and transferable) and different bidding entities wanting to bid on the contested resource. The different bidding entities include full bidding entities that are registered to individually bid on the contested resource for full ownership of the contested resource and fractional bidding entities that are registered to bid on the contested resource for fractional ownership of the contested resource.

The fractional bidding entity is included as part of a fractional bidding group that includes multiple fractional bidding entities. The fractional bidding entities of the fractional bidding group are collectively bidding for full ownership of the contested resource. After the contested resource and corresponding bidding entities have been identified, the systems are configured to initiate a first or current bidding round corresponding to a first or current asking price for the contested resource. After initiating the current bidding round, the systems identify a fractional bidding group comprising a plurality of fractional bidding entities and a total fractional bidding amount associated with the fractional bidding group relative to the current asking price.

The fractional bidding group is dynamically determined for the current bidding round based on (i) a fractional bidding amount for each fractional bidding entity of the fractional bidding group, (ii) a pre-determined minimum bid amount, and (iii) an amount of remaining available shares of the contested resource. In some instances, the systems also identify a full bidding amount received from at least one full bidding entity.

The systems then determine whether the total fractional bidding amount or the full bidding amount meets or exceeds the current asking price for the contested resource in the current bidding round. Alternatively, or additionally, the systems assess the different bidding amounts based on a timestamp-based prioritization of bids. If the total fractional bidding amount at least meets the current asking price, the systems terminate the current bidding round and initiate a new bidding round corresponding to a new asking price for the contested resource. The new bidding amount is higher than the previous bidding amount associated with the prior bidding round.

Alternatively, if the systems determine that the full bidding amount received from a full bidding entity at least meets the current asking price for the contested resource in the current bidding round, the systems terminate the current bidding round and initiate a new bidding round corresponding to a new, higher asking price for the contested resource.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments that are illustrated in the appended drawings. Understanding that these drawings depict only typical embodiments and are not, therefore, limiting in scope, embodiments will be described and explained with additional specificity and detail through the use of the accompanying drawings in which:

FIG. 1 illustrates an example computing environment in which a computing system incorporates and/or is utilized to perform disclosed aspects of the disclosed embodiments.

FIG. 2 illustrates an example process flowchart for managing an auction involving fractional ownership bidders and whole ownership bidders in an initial bidding round.

FIG. 3 illustrates an example embodiment of different bidding criteria for rejecting or accepting various bidding requests.

FIGS. 4-5 illustrate various example embodiments of managing an auction with fractional ownership bidders and whole ownership bidders in subsequent bidding rounds.

FIGS. 6-18 illustrate various example embodiments of user interfaces configured to manage the registration of different bidders at various investment levels in auctions.

FIGS. 19-24 illustrate various example embodiments of user interfaces configured to facilitate the registration of fractional ownership bidders and whole ownership bidders in an auction for a contested resource.

FIG. 25 illustrates an example embodiment of a user interface configured to facilitate an increase in spending limit for a bidder in an auction for a contested resource.

FIGS. 26-31 illustrate various example embodiments of user interfaces to facilitate a pre-bidding portion of an auction for a contested resource.

FIG. 32 illustrates an example embodiment of a user interface configured to display a bidder's waiting room of an auction for a contested resource.

FIGS. 33-38 illustrate various example embodiments of user interfaces configured to facilitate the management of bidding requests from fractional ownership bidders in an auction for a contested resource.

FIGS. 39-41 illustrate various example embodiments of user interfaces configured to facilitate payment from a bidder for fractional allocation of shares for a contested resource after an auction has been closed.

FIG. 42 illustrates an example embodiment of a user interface configured to facilitate management of an auction between fractional ownership bidders and whole ownership bidders by an auctioneer.

FIG. 43 illustrates an example embodiment of a user interface configured to facilitate management of an auction between fractional ownership bidders and whole ownership bidders by an auction clerk.

FIG. 44 illustrates one embodiment of a flow diagram having a plurality of acts associated with a method for facilitating the management of auctions involving both fractional ownership bidders and whole ownership bidders.

FIG. 45 illustrates one embodiment of a flow diagram having a plurality of acts associated with a method for processing bid requests in auctions involving both fractional ownership bidders and whole ownership bidders.

FIG. 46 illustrates one embodiment of a flow diagram having a plurality of acts associated with a method for managing post-auction processes and distribution of ownership interests associated with fractional ownership bidders.

FIGS. 47-49 illustrate various example embodiments of flow diagrams having a plurality of acts associated with a method for generating and modifying user interfaces for facilitating management of auctions involving fractional ownership bidders and whole ownership bidders.

FIG. 50 illustrates an example embodiment of a flow diagram having a plurality of acts associated with a method for managing allocation of limited computing resources between singular node entities and distributed node entities.

### DETAILED DESCRIPTION

The disclosed embodiments can be utilized to facilitate improvements in the computing systems, methods, and user interfaces for enabling auctions including fractional and full bidders. The following description references a system, referred to herein as the “Auction System,” which facilitates fractional bidding in consumer auction transactions.

This Auction System includes hardware and software. The hardware includes processors and storage devices that store executable instructions that are executable by the hardware processors to implement the disclosed functionality. The software includes interfaces that render the referenced information associated with the auctions and user-selectable controls and interactive elements that enable a user to provide input and to make selections that correspond with the functionality disclosed herein, such as for placing and modifying bids, selecting a type of Bid to be placed and item to Bid on, for providing user information, for providing financial transaction information, for viewing shares or fractional ownership of items being Bid on and won, etc.

The Auction System may be used to facilitate consumer bidding on various goods, including art and other items that may be priced above the amount a single consumer wishes to pay for in its entirety, but for and of which the bidder may be willing to share ownership and for which the consumer may participate in a Fractional Bid to own through an auction transaction. The goods that can be bid on can also include services. In a broad sense, the disclosed embodiments relate to techniques for facilitating and managing bidding on any contested resource (whether referred to herein as a good, service or resource), wherein the contested resources can be any combination of artwork(s), document(s), real estate property(ies), security(ies), computer resource(s), transferable right(s), service(s) and/or any other resource(s) having attributes of being finite, defined and transferable.

In some embodiments, The Auction System delivers market-based pricing to buyers and sellers of museum-quality fine art, collectibles and other asset types via a revolutionary auction and exchange. The unique auction system enables artworks and other assets to be fractionalized into affordably-priced, securitized ownership interests (“Shares”). Asset buyers previously priced out of these markets can now participate in auctions of highly-valued artworks and other assets, and institutional buyers such as pension plans, endowments and foundations will have a familiar investment vehicle with which they can transact, namely, the Shares of a bona fide corporation.

The Auction System can utilize the Regulation A Tier 2 exemption for public offerings or other exemptions from the registration requirements of the Securities Act of 1933 to issue securities for assets that have been fractionalized. The Auction System can also utilize other accepted and/or regulated ownership entity associated with different types of ownership and different jurisdictions. (The Regulation A Tier 2 is an exemption from SEC registration for public offerings. Under Regulation A Tier 2, an issuer is allowed to offer securities totaling up to $75 million in a 12-month period. Issuers in Tier 2 offerings are not required to register or qualify their offerings with state securities regulators).

The exchange provided by Auction System may also be connected to the interfaces of broker-dealers and other secondary market entities, thereby enabling the subsequent trading of Shares and for providing liquidity to the Shareholders.

In some embodiments, a fractionalized asset is held in a secure location associated with the Auction System, e.g., in a secured, climate-controlled and fire-suppressed storage facility or museum for the duration of the asset holding period, the management entity facilitates the asset's sale and distributes the net proceeds to the asset's Shareholders. An electronic record that tracks the ownership Shares is created when the auction is complete. The electronic record may be stored in a distributed ledger, such as a blockchain ledger that is immutable to reflect ownership and rights associated with the referenced auction item. In other instances, a transfer agent is used to maintain the electronic record for tracking ownership.

Artworks and other assets won by 100% Bidders (also referred to herein as full bidders, full bidding entities, whole bidders, or whole bidding entities) are treated in the same manner as a traditional auction, with no Shares issued.

The Auction System enables participation by a new class of bidders (“Fractional Bidders”) by aggregating their Fractional Bids in real-time and consolidating them for entry as a singular Bid in traditional English auctions, or other types of auctions, such as Dutch auctions by way of non-limiting example. These Fractional Bidders compete among themselves for allocations of Shares; they also compete with 100% Bidders who desire ownership of the entire asset.

As a result, the true market demand for an asset can be determined. The historically high price points of blue-chip art, collectibles, and other high-value asset types are no longer an impediment to this category of Fractional Bidders, creating a new and broad cohort of potential buyers.

The Auction System is designed to mirror traditional auction process as closely as possible. The Auction System increments the price when each asking price (a representation of a price point) is filled via either a 100% Bid or Fractional Bids aggregating to the total price of the asset in a particular asking price. Bidding continues until an asking price cannot be filled to 100%, at which point the auction ends.

The referenced auction process is designed to be fair, simple and to rely on participants' existing understanding of how traditional auctions are conducted. In some instances, the Auction System manages the auction in a manner that is (1) Fair: All Fractional Bidders pay the same winning price per Share (2) Simple: The only required input from a Fractional Bidder is the amount they want to buy of an asset at a specified price and (3) Familiar: As many parallels to traditional auctions as possible.

Auction participants consist of Fractional and 100% Bidders. Fractional Bidders compete among themselves as well as against any 100% Bidders. 100% Bidders compete against filled asking prices (“Valid Bids”) from either other 100% Bidders or Fractional Bidders. Fractional Bidders create a Valid Bid when sufficient aggregated Fractional Bids in the current asking price equals the total price of the asset in that asking price. A partially-filled asking price of Fractional Bids does not constitute a Valid Bid and will be given no standing if a 100% Bid is received prior to the Fractional Bidders filling the current asking price.

Fractional Bidders compete with each other and a clock for an allocation as they fill an asking price. The clock can refer to the auctioneer ending the auction due to lapsed time or, alternatively, the actual passing of the allotted time in a timed auction. Once 100% of the asset's price is Bid for in that asking price, no additional Fractional Bids at that asking price will be accepted. At the same time, a Valid Bid from Fractional Bidders competes with 100% Bids from full bidders.

The number of outstanding Shares will be determined by an administrator of the Auction System and will be balanced between minimizing the number of Shares unaccounted for due to rounding and having a “reasonable” starting Share price. To participate in an auction with the Auction System, the minimum Fractional Bid Amount will be set at a predetermined amount, such as $5,000, or a different amount designated by an administrator of the Auction System.

Shareholder restrictions will be defined by the regulatory environment of the auction. For example, in the United States, shareholders who own 10% or more of the outstanding Shares will be subject to 1) ordinary income treatment under U.S. Controlled Foreign Corporation rules, 2) additional Cayman Island KYC requirements and 3) SEC ownership disclosure. The Auction System may require advance notification of those who want to own 10% or more of the outstanding Shares to allow for time for additional Cayman Island KYC processes prior to the start of an auction.

If Shareholders who own Shares in an ERISA plan account cumulatively own 25% or more of the outstanding Shares, the asset can be considered an ERISA plan asset, subjecting the Auction System and the Share issuer to additional reporting and requirements. In some instances, a Buyer's Premium and any applicable taxes will be added to the Hammer Price upon the auction's conclusion. If Fractional Bidders win, they will also pay a Sourcing Fee.

The Auction System auctions can either be held as live events or can be run as online-only events. When held live, auctions may include an in-person auctioneer to manage the auction, an auctioneer's clerk to effectuate the auctioneer's instructions, and Customer Service Representatives to take bids from participants who elect to Bid in-person or by telephone. These bids can be entered into the system by the customer service representative. During a live action when-in-person participants raise a paddle, a customer service representative may track and enter the corresponding bids. Live auctions may also be broadcast to all online bidders.

When run as online events, the auction may still use an auctioneer, an auctioneer's clerk, and Customer Service Representatives. These roles and jobs will be managed by owners or administrators of the Auction System, or by third-party partners or affiliates. In some instances, no in-person bidders will be allowed but telephone bidders may still be accepted. There are two general categories of bidders in the Auction System auctions, namely, (1) 100% Bidders who Bid for full physical ownership of the asset(s), and (2) Fractional Bidders who Bid for partial ownership interests in an asset(s).

### Example Computing Systems

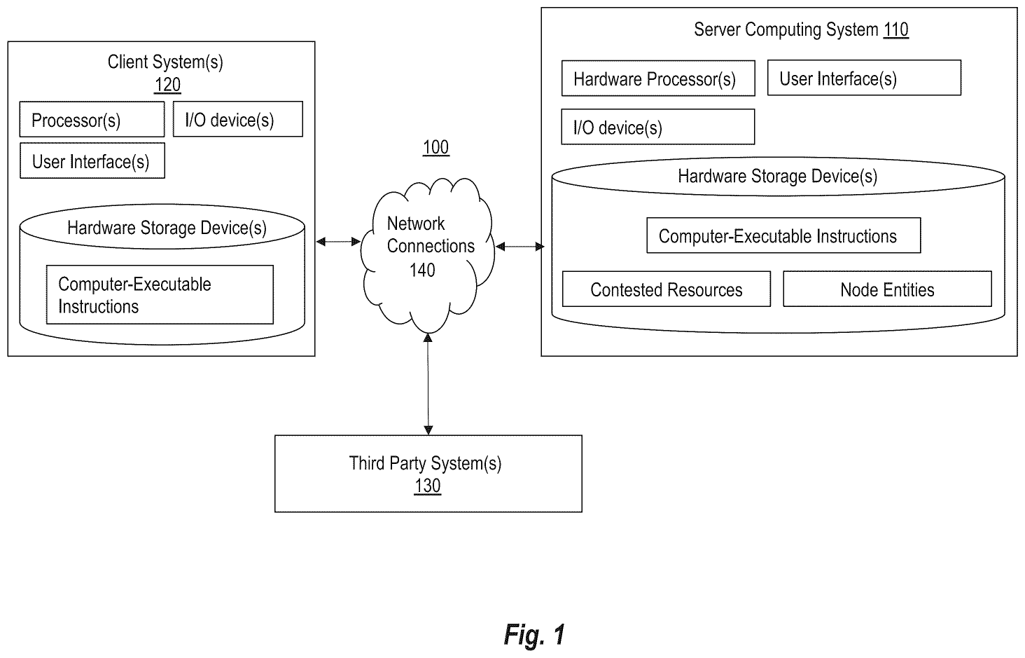

Attention will now be directed to FIG. 1, which illustrates the computing system 100 as part of a computing environment 100 that includes client system(s) 120 and third-party system(s) 130 in communication (via a network 140) with the computing system 110. These third-party systems can include different service providers via an API or other connection, such as broker-dealers, transfer agents, cash accounts, etc.) As illustrated, computing system 110 is a server computing system configured to compile, modify, and implement one or more machine learning models configured to facilitate the management of an auction between Fractional Bidders and 100% Bidders.

The computing system 110, for example, includes one or more processor(s) (such as one or more hardware processor(s) and one or more hardware storage device(s) storing computer-readable instructions. One or more of the hardware storage device(s) is able to house any number of data types and/or any number of computer-executable instructions by which the computing system 110 is configured to implement one or more aspects of the disclosed embodiments when the computer-executable instructions are executed by the one or more hardware processor(s). The hardware storage device(s) is/are configured to comprise and/or access different resources that can be shared and allocated between different tenants for fulfilling model requests using machine learning models (e.g., LLMs). The hardware storage device(s) are configured to store data associated with the operation of the auction, including bidding histories, auction items, lot numbers, user account/profiles and corresponding information, asking prices, bidding criteria, information about prior or current bidding rounds, or any other information or data that is material to the operation of the auction as described herein.

The computing system 110 is also shown including user interface(s) and input/output (I/O) device(s) (such as audio inputs like microphones and other audio input devices, and audio outputs such as speakers and other audio output devices).

As shown in FIG. 1, the hardware storage device(s) is shown as a single storage unit. However, it will be appreciated that the hardware storage device(s) is a distributed storage that is distributed to several separate and sometimes remote systems and/or third-party system(s). Computing system 110 can also comprise a distributed system with one or more of the components of computing system 110 being maintained/run by different discrete systems that are remote from each other and each performs different tasks. In some instances, a plurality of distributed systems performs similar and/or shared tasks for implementing the disclosed functionality, such as in a distributed cloud environment.

The computing system is in communication with client system(s) 120 comprising one or more processor(s), one or more user interface(s), one or more I/O device(s), one or more sets of computer-executable instructions, and one or more hardware storage device(s).

The computing system is also in communication with third-party system(s). It is anticipated that, in some instances, the third-party system(s) 130 further comprise databases housing additional resources, for example, resources not included in local storage. Additionally, or alternatively, the third-party system(s) 130 includes machine learning systems external to the computing system 110.

Embodiments of the present invention may comprise or utilize a special-purpose or general-purpose computer (e.g., computing system 110) including computer hardware, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media (e.g., hardware storage device(s) of FIG. 1) that store computer-executable/computer-readable instructions are physical hardware storage media/devices that exclude transmission media. Computer-readable media that carry computer-executable instructions or computer-readable instructions in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 140 of FIG. 1) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

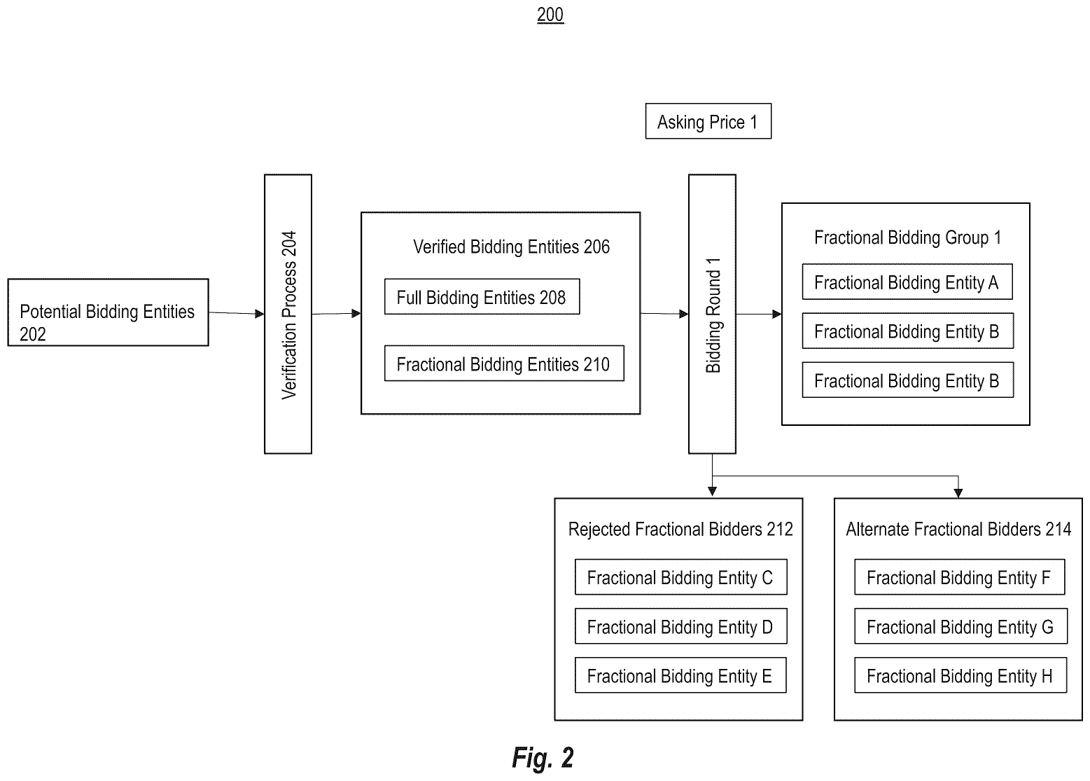

Attention will now be directed to FIG. 2, which illustrates an example process flowchart for managing an auction involving fractional ownership bidders and whole ownership bidders (also referred to as full bidders or full bidding entities herein) in an initial bidding round. For example, FIG. 2 shows a set of potential bidding entities 202 requesting entry into an auction platform that facilitates auctions between fractional bidding entities and full bidding entities. Before being allowed to participate in an auction, all potential bidding entities are verified through one or more different verification processes, such as Know Your Client (KYC) or Know Your Business (KYB) protocols. As will be described in more detail below, potential bidding entities are verified through varying levels of verification processes (e.g., verification process 204) based on a requested investment amount that is an aggregate limit to how much they can bid with their account across any auctions/lots they choose to bid on.

Once the potential bidding entities 202 are verified, the verified bidding entities 206 are able to register for an auction for a particular contested resource. The verified bidding entities 206 are able to register for an auction as a full bidding entity or a fractional bidding entity. In some instances, the ability to choose between different bidding types is conditional on their spending limit relative to a lower estimated value of the contested resource. A full bidding entity 208 is registered to place a bid on the contested resource for full ownership of the contested resource. A fractional bidding entity 210 is registered to place a fractional bid for fractional ownership of the contested resource in an auction. Each auction is conducted through a series of bidding rounds. Each bidding round is associated with an Asking Price for the contested resource being auctioned. When a full bidding entity is bidding during the bidding round (e.g., bidding round 1) associated with asking price 1, the full bidding entity is placing bids for a full ownership of the auction item (e.g., bids at or above the asking price).

When a fractional bidding entity is bidding during the bidding round, the fractional bidding entity is placing fractional bids (e.g., at a fraction of the asking price) in exchange for fractional ownership of the asset. When a fractional bid is accepted, the fractional bidding entity is included in a fractional bidding group (e.g., fractional bidding group 1). As shown in FIG. 2, fractional bidding group 1 includes fractional bidding entity A, fractional bidding entity B, and fractional bidding entity C. Collectively, fractional bidding group 1 is bidding for an entire or full ownership of the auctioned item and is associated with a total fractional bidding amount.

The total fractional bidding amount is an aggregation or proration of all of the individual fractional bids from each of the fractional bidding entities in the fractional bidding group. Each bidding request from a bidding entity (either fractional or full bidding entity) is analyzed to determine if it meets one or more bidding criteria set for the bidding round and/or set by the bidder himself. In some instances, one more fractional bids do not meet the bidding criteria and are rejected fractional bidders, such as fractional bidding entity C, fractional bidding entity D, and fractional bidding entity E. It should be appreciated that the system is configured to implement a prioritization system or schema, in which bids that are received earlier than other bids receive priority in being included in the fractional bidding group for a particular bidding round. Thus, in some instances, the bidding round is conducted as a first come, first serve bidding round. In some instances, the system is configured to implement a combination of time priority and bidding criteria during the bidding round.

For example, in some instances, bidding requests may meet the bidding criteria but are still not accepted into the fractional bidding group for the corresponding bidding round because other bids received/earned higher priority. It should also be appreciated that bids may earn priority based on attributes other than a timestamp, like a bidding amount (e.g., higher bids or lower bids receive priority). The bidding entities associated with such bidding requests may be designated as alternate fractional bidders (e.g., fractional bidding entity F, fractional bidding entity G, and fractional bidding entity H). Alternate bidding entities can be added to the fractional bidding group during the bidding round or at a subsequent point in time during the auction or even after the auction has closed. Alternate fractional bidding entities can replace fractional bidding entities when fractional bidding entities drop out of the bidding round or auction or are unable to make final payment on the auction item if their fractional bidding group wins the auction.

As shown in FIG. 2, fractional bidding group 1 including fractional bidding entity A, fractional bidding B, and fractional bidding entity C has won the first bidding round. After each bidding round of an auction, in some instances, the systems determine a percentage or fractional interest of the contested resource that may be awarded to each fractional bidder in the fractional bidding group if the fractional bidding group for a particular bidding round were to win the contested resource. The percentage or fractional interest is directly or approximately proportional to the fractional bid placed by a fractional bidder. This percentage or fractional interest is then converted to or is determined to correspond to a number of shares (e.g., equity shares) of a business entity that owns the contested resource, thereby awarding each fractional bidder their fractional ownership of the contested resource. After a bidding entity (either full bidding entity or fractional bidding group) has won a bidding round, the auction is advanced to a subsequent bidding round with an increased asking price that is higher than the previous asking price. The new asking price can be increased by a predetermined increment (e.g., a predetermined table of increments), by a dynamically determined increment, or set to meet or exceed the winning bid from the previous bidding round if the winning bid was greater than the corresponding asking price. In some instances, the new asking price is determined by a predetermined mathematical formula. It should be appreciated, that in some auctions, instead of increasing the asking price in each subsequent round, some auctions (e.g., Dutch auctions) begin at a higher or highest asking price and decrease the asking price in each subsequent round until the asking price is met. In such auctions, the bidding round is not advanced by satisfying the current asking price, but rather by failing to satisfy the current asking (e.g., in a certain period of time, or other bidding round policies).

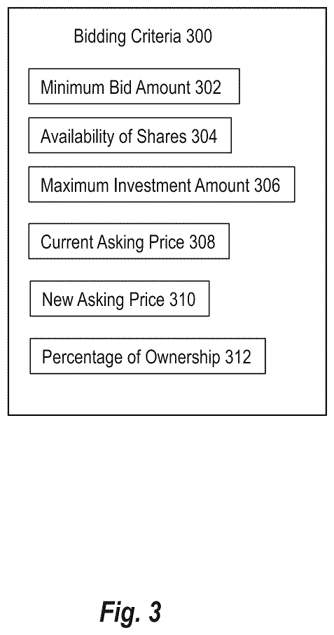

Attention will now be directed to FIG. 3, which illustrates an example embodiment of different bidding criteria for rejecting or accepting various bidding requests. For example, as shown in FIG. 3, bidding criteria 300 includes one or more of the following: a minimum bid amount 302, availability of Shares associated with the auction item 304, a maximum investment amount that a bidding entity has been verified to invest in the auction 306, a current asking price 308, a new asking price 310, and/or a minimum or maximum percentage of ownership of the auction item 312.

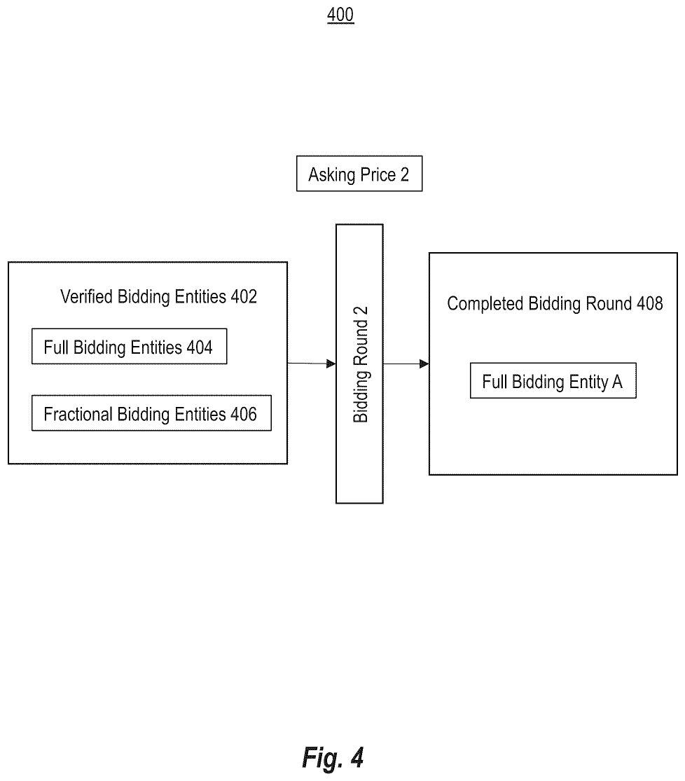

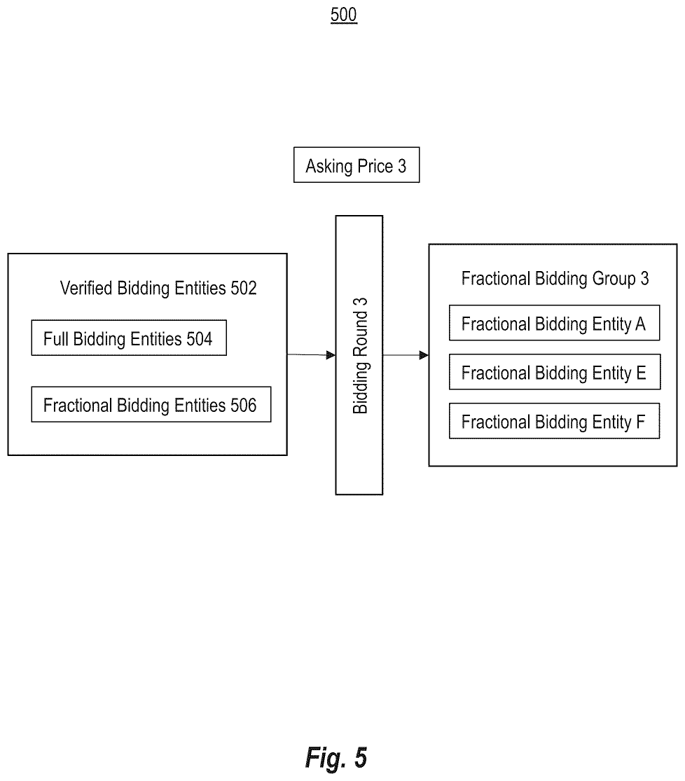

Attention will now be directed to FIGS. 4-5, which illustrate various example embodiments of managing an auction with fractional ownership bidders and whole ownership bidders in subsequent bidding rounds. For example, after fractional bidding group 1 won bidding round 1 (as shown in FIG. 2), the auction is advanced to bidding round 2. In bidding round 2, verified bidding entities that are registered as full bidding entities and fractional bidding entities are now allowed to place bids at the new asking price (e.g., asking price 2) associated with bidding round 2. As shown in FIG. 4, full bidding entity A placed a winning bid that at least meets asking price 2. Bidding round 2 is now completed (e.g., completed bidding round). Because the full bidding entity's bid won bidding round 2, it means that a fractional bidding group was unable to secure enough fractional bids to reach asking price 2 associated with bidding round 2.

As shown in FIG. 5, after bidding round 2 is completed, the auction advanced to a third bidding round (e.g., bidding round 3) associated with asking price 3, which is higher than asking price 2 associated with bidding round 2. Here, as in previous rounds, full bidding entities and fractional bidding entities place bids for the auction item based on the new asking price (e.g., asking price 3). As shown in FIG. 5, fractional bidding group 3 including fractional bidding entity A, fractional bidding entity E, and fractional bidding entity F have won bidding round 3. Notably, as shown in FIG. 5, fractional bidding group 3 comprises a different set of fractional bidding entities than fractional bidding group 1 from bidding round 1. For example, fractional bidding entity A is included in both fractional bidding group 1 and fractional bidding group 3, but fractional bidding entities B and C are no longer included in fractional bidding group 3. Instead, fractional bidding entity A is in fractional bidding group 3 with fractional bidding entity E and fractional bidding entity F.

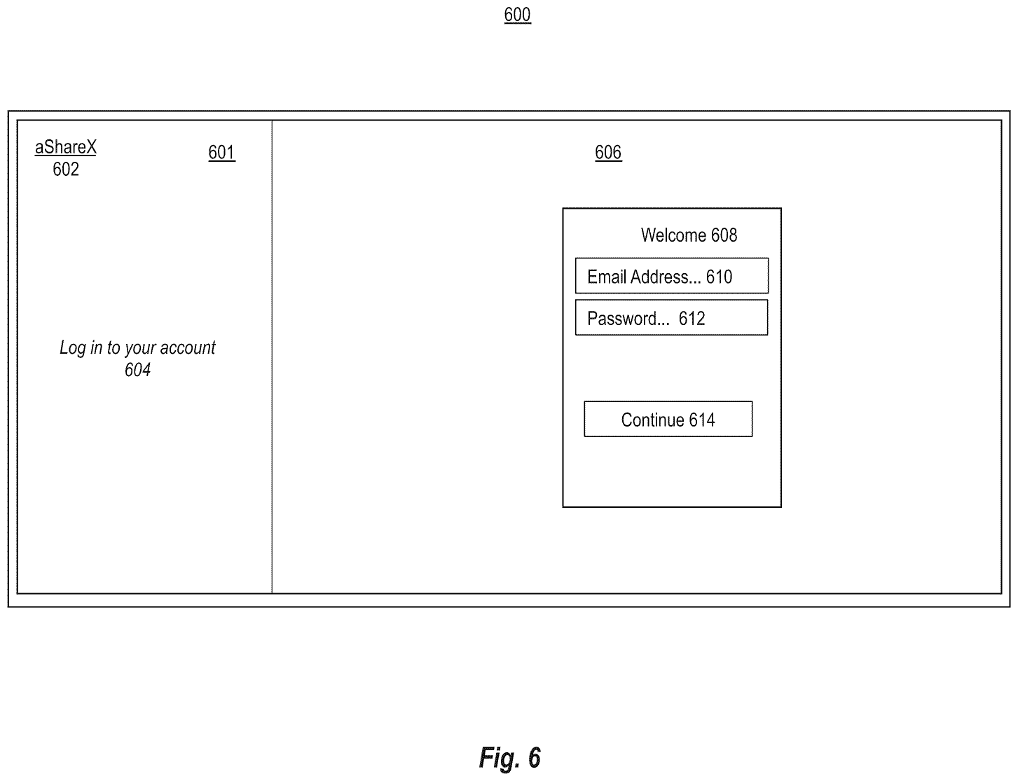

Attention will now be directed to FIGS. 6-18, which illustrate various example embodiments of user interfaces configured to manage the registration of different bidders at various investment levels in auctions. For example, FIGS. 6-8 are shown illustrating various user interfaces, such as user interface 600 including a first window pane that displays a selectable home button 602 (e.g., “aShareX”) that when selected, takes a user back to a home screen. The left side window pane also includes a heading 604 (e.g., “Log in to your account”) that helps a user identify at what point of the account creation or registration process the user is currently completing. As shown in FIG. 6, a welcome window 606 includes a plurality of input boxes or form fields (e.g., email address input box 608 configured to receive and store an email address associated with a bidding registrant, password input box 610 configured to receive and store a password associated with the email address of the bidding registrant). Welcome window 606 also comprises a selectable continue button 612 that is configured to cause the computing system to display a subsequent user interface associated with next steps of the registration process. By clicking continue 614, or other link/selectable icon, the user's account is created and stored in the application system. It should be appreciated that while FIGS. 6-18 do not illustrate a dashboard, some embodiments of the user interfaces shown will also include a dashboard window comprising one or more selectable elements or icons.

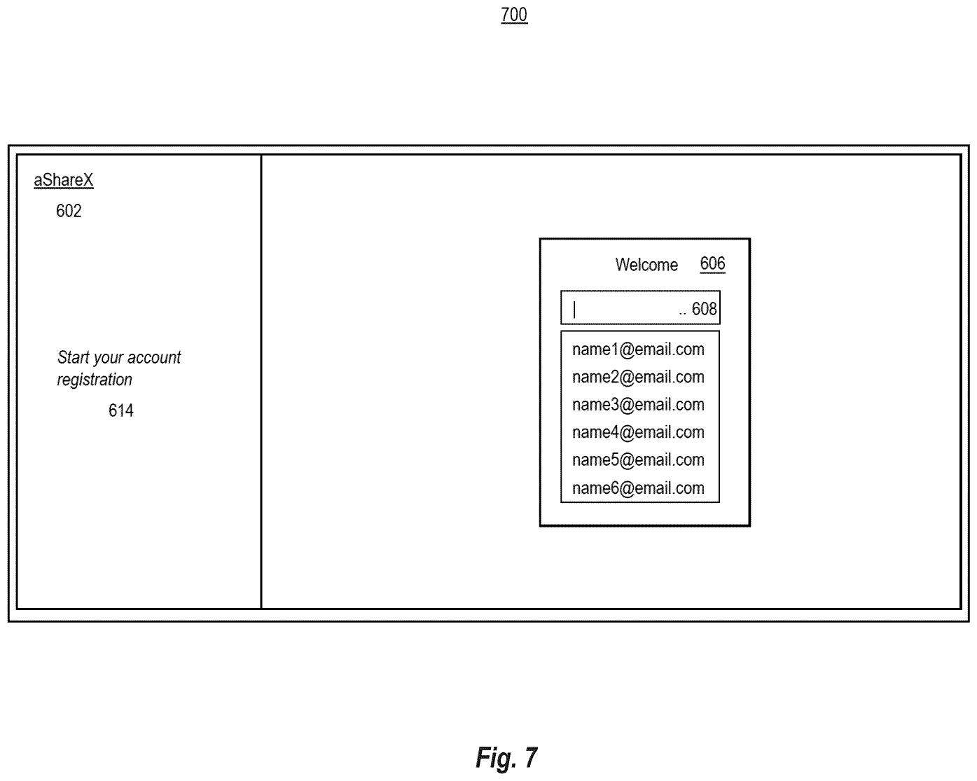

In FIG. 7, the user may select their email from a listing of presented emails that are presented in response to a user directing focus or a prompt to the email address input box 608.

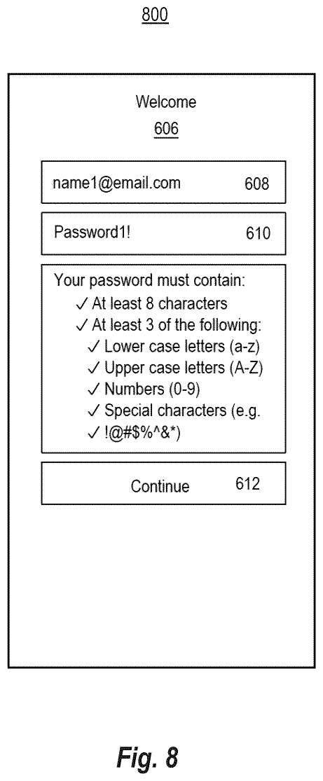

In FIG. 8, the user is able to create a password (e.g., Password1!) by typing in a preferred password into the password input box 610. When the password satisfies preconfigured rules, the user's name and password are stored and used for controlling future access to the user's account. The user may select a continue button 612 to proceed with the registration process.

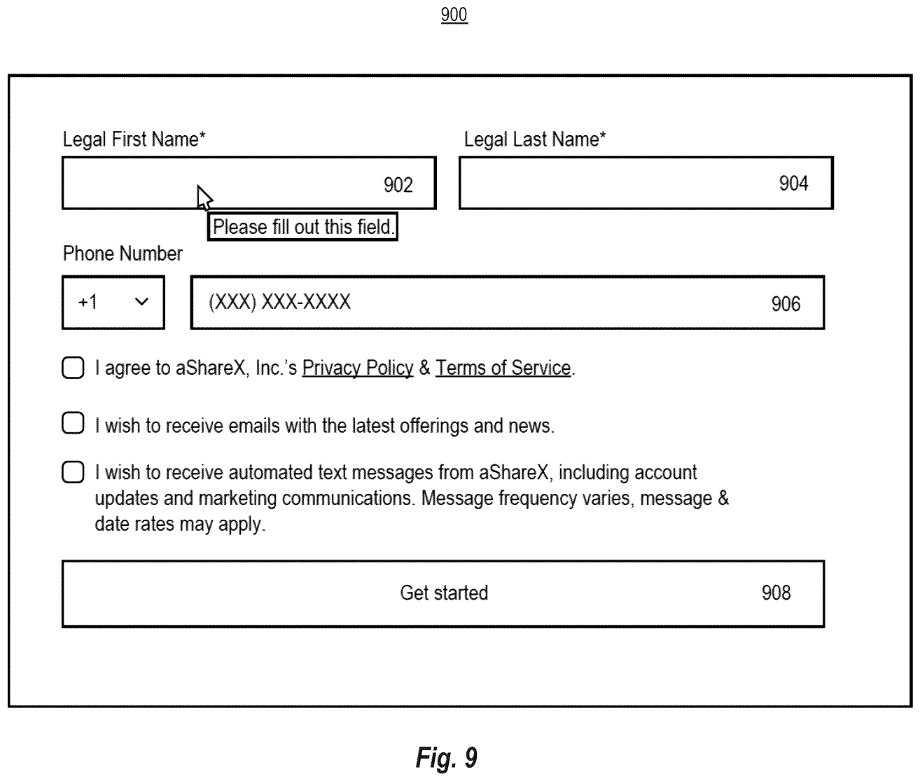

Attention will now be directed to FIG. 9, which illustrates some additional registration processes and corresponding user interface elements. FIG. 9 illustrates, for example, a user interface 900 comprising a plurality of input boxes or form fields configured to receive and store various pieces of user personal identifying information. For example, user interface 900 is shown displaying an input box 902 for receiving and storing a legal first name, input box 904 is shown displaying an input box 904 for receiving and storing a legal last name, and input box 906 is configured for receiving and storing a phone number. User interface 900 is also showing a selectable icon 908 configured to trigger the display of user interfaces for subsequent steps of the registration process. Some selectable icons include compliance checkboxes.

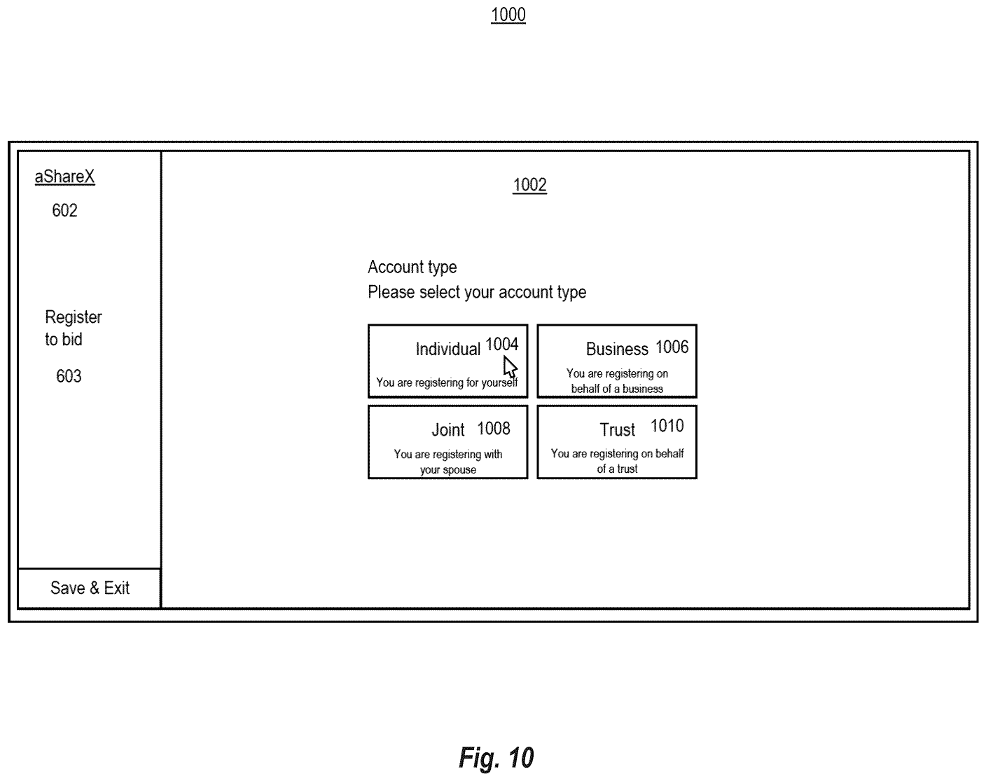

Attention will now be directed to FIG. 10, which illustrates an example embodiment of a user interface to facilitate registration of a bidding entity. For example, FIG. 10 illustrates a user interface 1000 comprising a left-hand window displaying the home button 602 and window heading 603 and a right-hand window 1002 comprising a plurality of selectable account type icons. For example, user interface 1000 is shown displaying an individual account type icon 1004, a business account type icon 1006, a joint account type icon 1008, and a trust account type icon 1010. An individual account type is for users registering for themselves as individual bidders. A business account type is for users registering on behalf of a business entity. A joint account type is for users that are registering with a co-bidder (e.g., a spouse). A trust account type is for users registering on behalf of a trust or other legal entity.

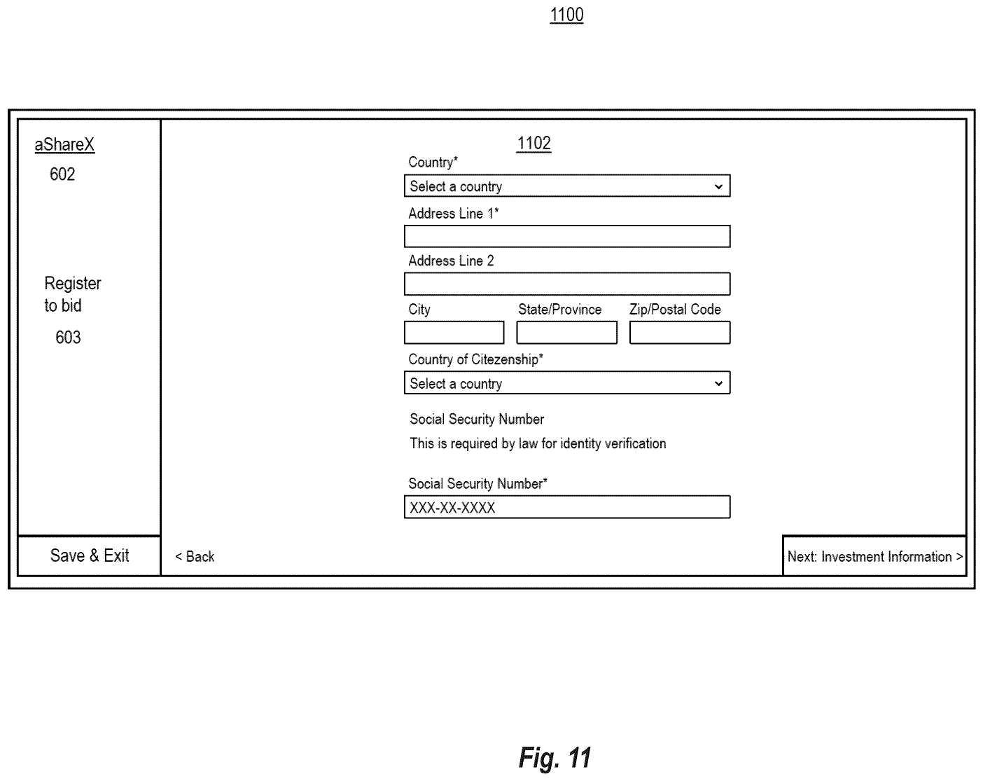

Attention will now be directed to FIG. 11, which illustrates an example embodiment of a user interface configured to receive and store additional information associated with the account type registration including a window 1102 comprising a plurality of input box for receiving and storing an address, country of citizenship, and social security number (or other government-issued identification number).

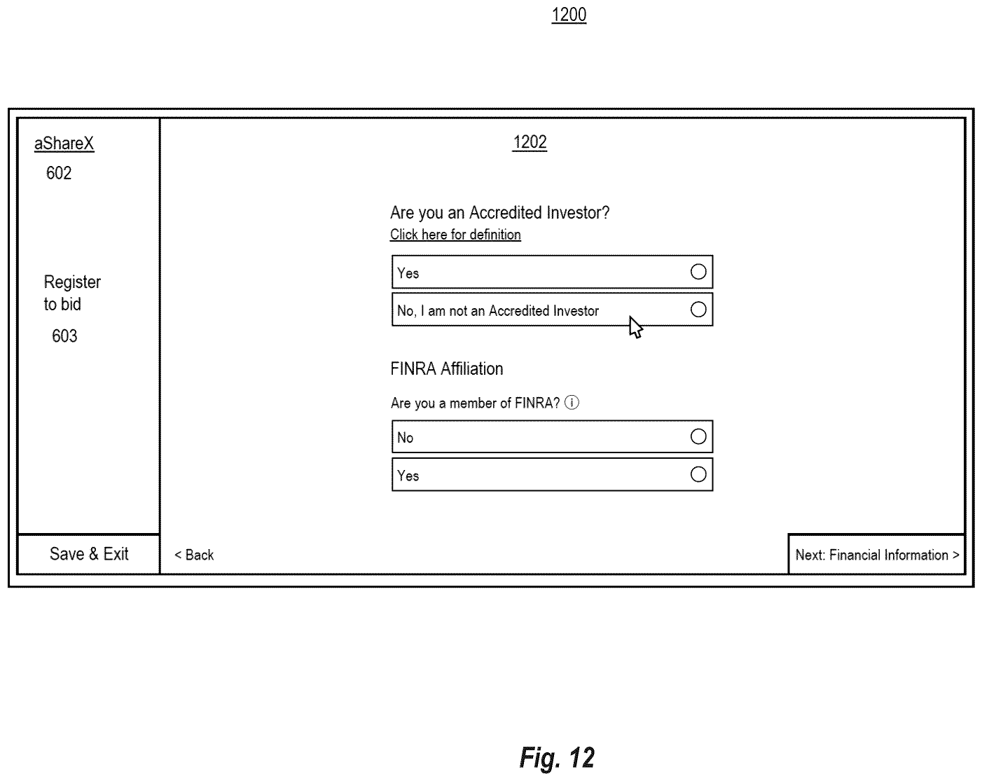

Attention will now be directed to FIG. 12, which illustrates a user interface 1200, including left-hand window comprising a home button 602 and a window heading 603. User interface 1200 also includes a right-hand window 1202 comprising a plurality of input boxes for receiving and storing information about the account being registered. For example, user interface 1202 comprises input boxes for a user to provide self-accreditation as an accredited investor and/or self-identification as a member of FINRA.

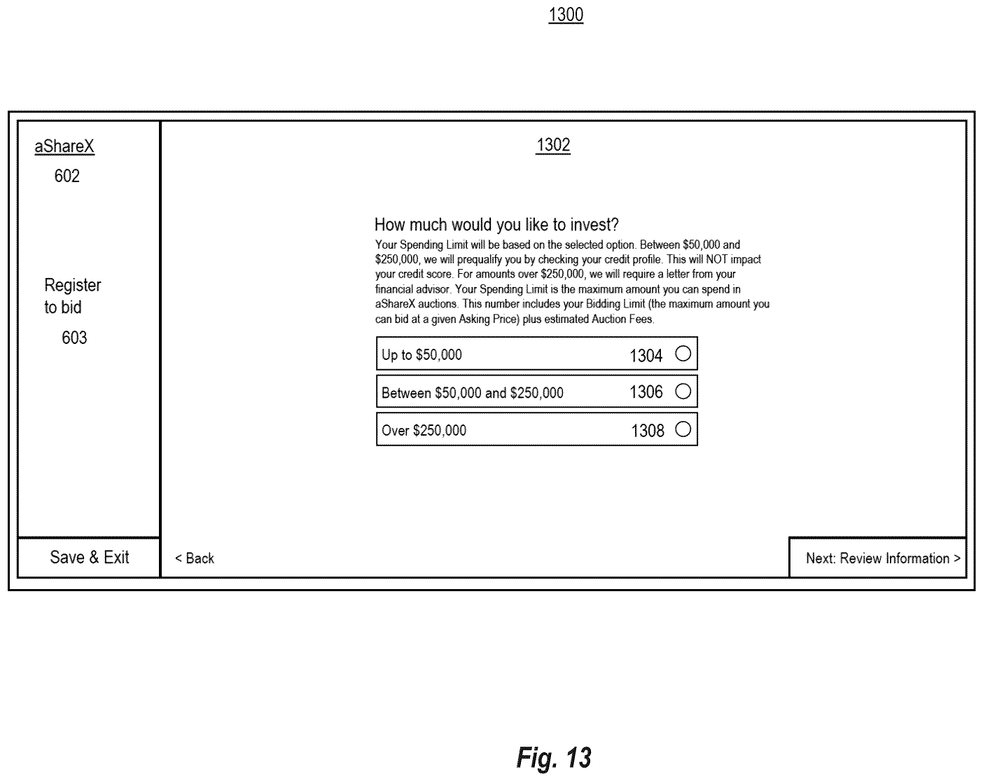

Attention will now be directed to FIG. 13, which illustrates a user interface 1300 including a right-hand window 1302 comprising a plurality of selectable icons for verifying a maximum investment amount that will be registered with the account. For example, users are able to request different maximum investment amounts that reflect a maximum amount of investment that they are allowed to bid in total during the auction, including a bid amount and any fees incurred. In some embodiments, maximum investment amounts are divided into different tiers or ranges of investment amounts.

By way of example, the illustration shown in FIG. 13 shows investment or bidding threshold amounts are divided into three different categories: category 1304 for up to $50,000, category 1306 for between $50,000 and $250,000, and category 1308 for over $250,000. Each investment amount category is associated with a different level or type of verification process. It will be appreciated that these threshold amounts set for the different categories can be modified to accommodate different needs and preferences. Additionally, in some alternative embodiments, when the consideration being offered in a bid comprises a computing resource or other resource other than money, it is possible for these categories to specify the ranges and limits of those resources.

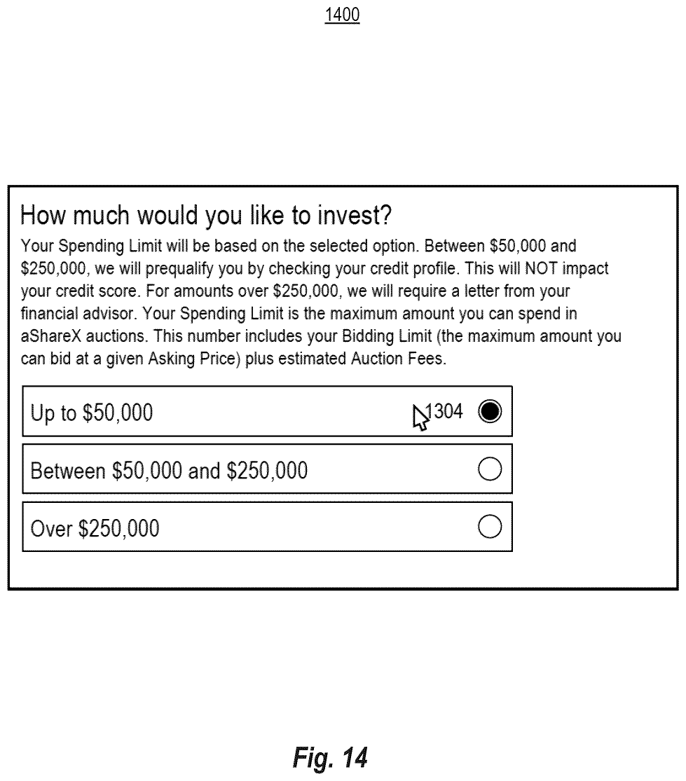

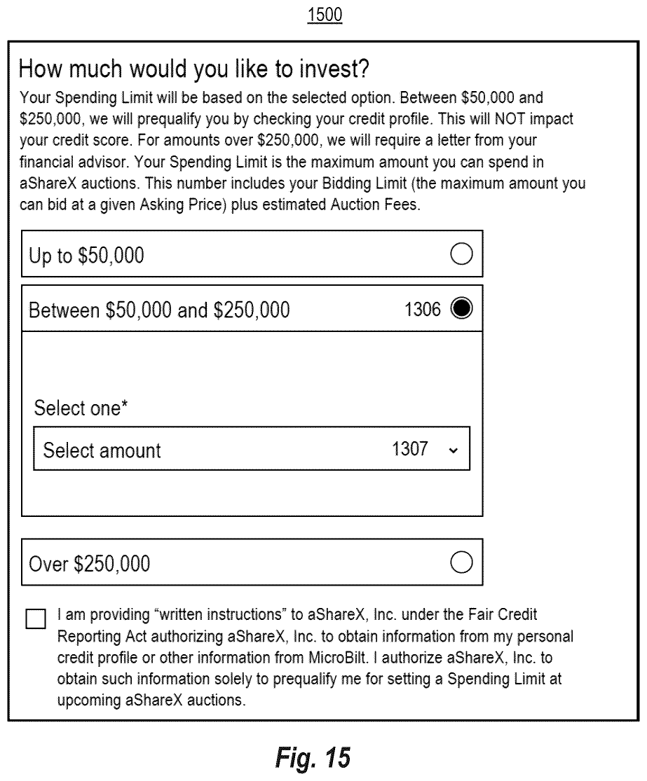

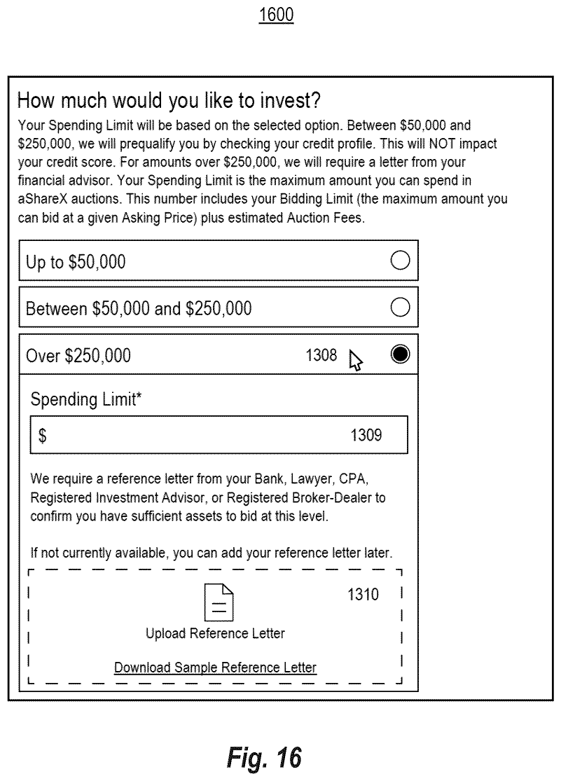

Attention will now be directed to FIGS. 14-16, which illustrate various user interfaces for facilitating different verification processes based on a requested maximum investment amount or investment range. For example, FIG. 14 illustrates user interface 1400, wherein category 1304 has been selected. For this first tier of investment, no additional verification process steps are triggered. FIG. 15 illustrates user interface 1500, wherein category 1306 has been selected, wherein a drop-down menu 1307 is displayed for selecting a maximum investment amount between $50,000 and $250,000. By selecting and confirming this investment category, the user authorizes the auction platform company to run the relevant credit check for the account type associated with the user. In some instances, a third-party service is used to assess creditworthiness (i.e., perform the credit check). As shown in FIG. 16, category 1308 has been selected, wherein a spending limit input box 1309 is triggered to be displayed and configured to receive a spending limit amount submitted by the user. An additional input box 1310 is also displayed in response to selecting investment category 1308, which is configured to receive and verify a reference letter uploaded by the user that provides an affidavit for the user's requested spending limit. While FIGS. 14-16 illustrate three different investment category types, it should be appreciated that any number of investment category types can be displayed and selected by a user, to trigger various different verification processes, as mentioned above.

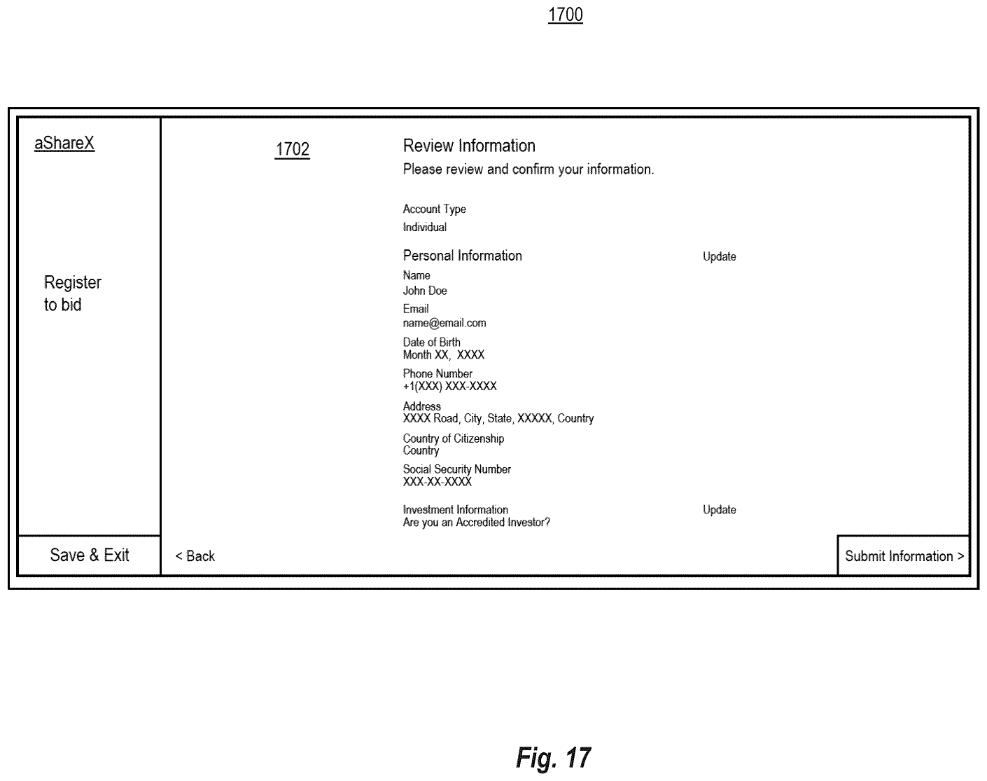

Attention will now be directed to FIG. 17, which illustrates user interface 1700 displaying a review window 1702 including textual information summarizing account information that will be registered, including account type, and personal information such as name, email, date of birth, phone number, address, citizenship, identification number, and self-accreditation. After reviewing the information for accuracy, a user is then able to submit the information via a selectable icon.

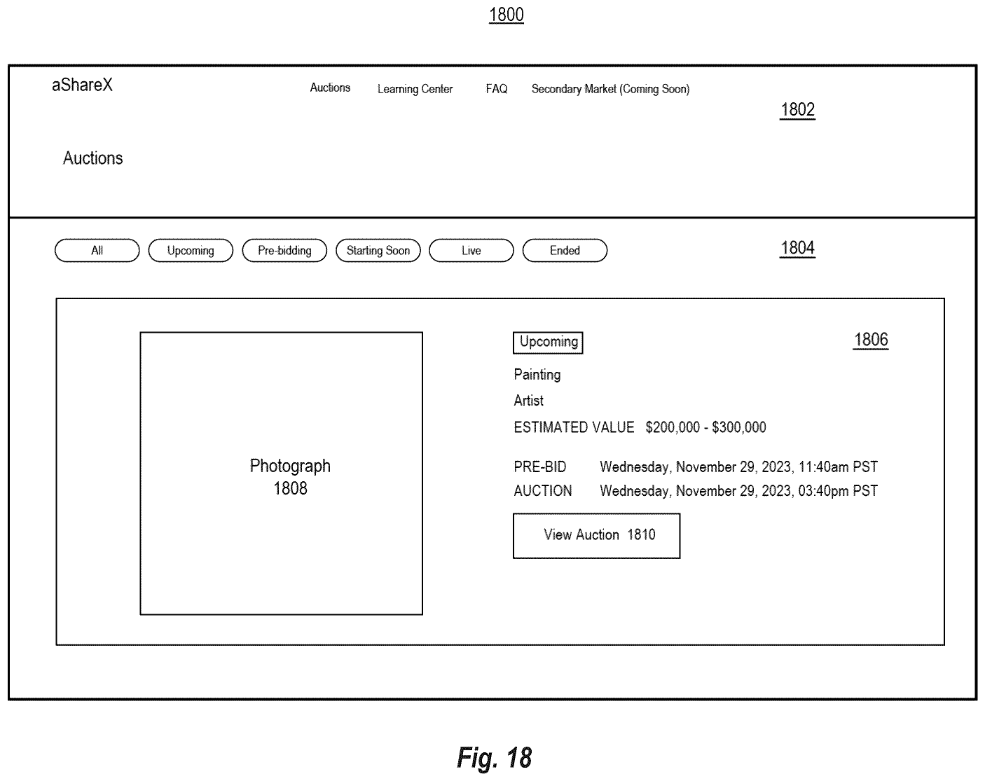

Attention will now be directed to FIG. 18, which illustrates user interface 1800 comprising a plurality of windows displaying different information and selectable icons. For example, window 1802 is a header window configured to display a plurality of selectable icons that are configured to display various different user interfaces, including a home button configured to display a home screen, an auctions link configured to display an auctions page, a learning center, a FAQ page, and/or other associated user interfaces.

User interface 1800 has been triggered to display the auctions window 1804 which comprises a plurality of selectable auction-related icons and an upcoming auctions window 1806 corresponding to a specific auction for a particular auction item. Auction-related icons included icons for “all” to display all auctions available through the auction platform, “upcoming” to display and filter to upcoming auctions, “pre-bidding” to display and filter to any auctions in the pre-bidding stage, “starting soon” to display and filter to any auctions that have completed the pre-bidding stage and are about to open an initial bidding round, “live” to display and filter any auctions that are currently live (i.e., currently open bidding rounds), and “ended” to display and filter any auctions that have already ended.

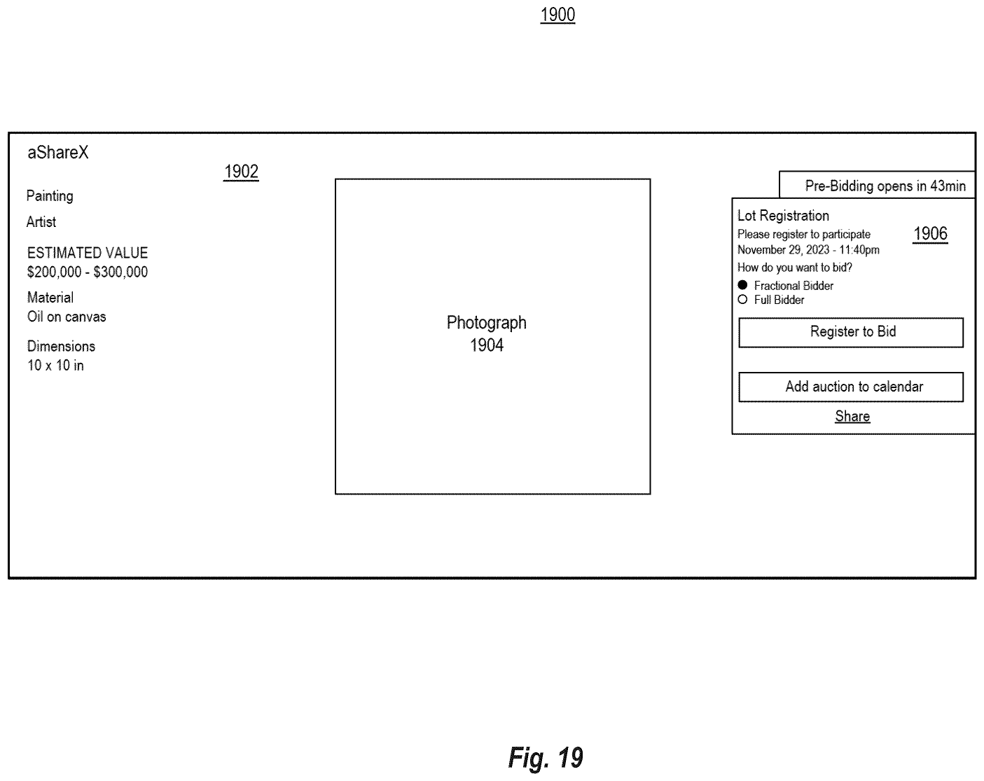

FIG. 18 is shown with upcoming auctions window 1806 showing a first upcoming auction associated with a painting. Window 1806 is shown with textual and graphical information describing the auction lot, including the type and title of auction item, the artist associated with the artwork, an estimated value (e.g., “$200,000-$300,000), a photograph 1808 of the artwork, a pre-bid start time (e.g., Wednesday, Nov. 29, 2023, 11:40 am PST), and an auction start time (e.g., Wednesday, Nov. 29, 2023, 03:40 pm PST). Window 1806 also comprises a selectable “view auction” button 1810 that triggers the display of the auction page associated with the particular upcoming auction (see FIG. 19).

FIGS. 19-24 illustrate various example embodiments of user interfaces configured to facilitate the registration of fractional ownership bidders and whole ownership bidders (also referred to herein as 100% bidders and full bidders) in a specific auction for a contested resource. Attention will now be directed to FIG. 19, which illustrates user interface 1900 that displays information and selectable icons related to a particular auction lot (e.g., triggered to be displayed by a view auction button (e.g., selectable icon. 1810, FIG. 18). As shown in FIG. 19, user interface 1900 is associated with an auction for a painting by an artist. The estimated value of the painting is between $200,000 and $300,000. The material of the painting is oil on canvas and has dimensions of 10×10 inches. Widow 1902 also shows a photograph 1904 of the painting. On the right-hand side of the user interface, a window 1906 is displayed displaying a plurality of selectable icons for a user to select which type of bidder they would like to register as for the lot registration. In some instances, a user is only able to choose between fractional bidder and full bidder is their spending limit is high enough relative to the lower estimated value of the lot. Once the type of bidder is selected, a user is able to “register to bid” for the auction and/or add the auction to their calendar via the “add auction to calendar” selectable icon.

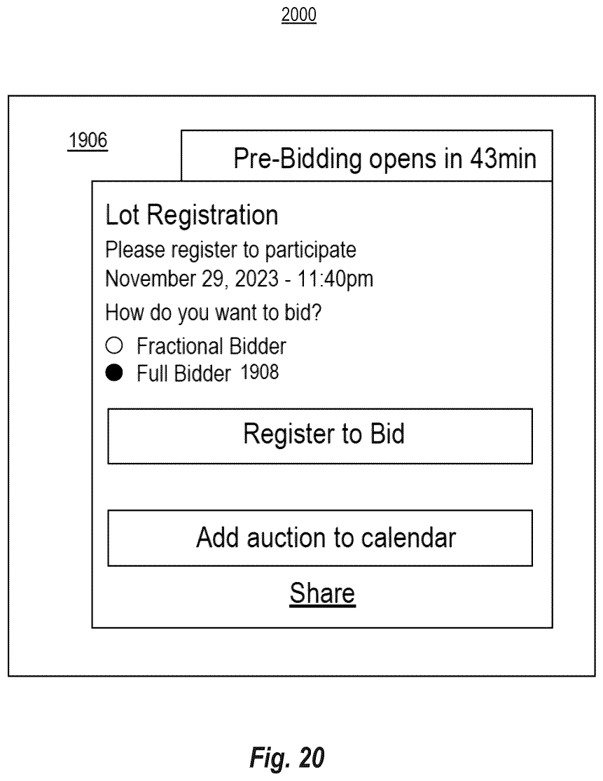

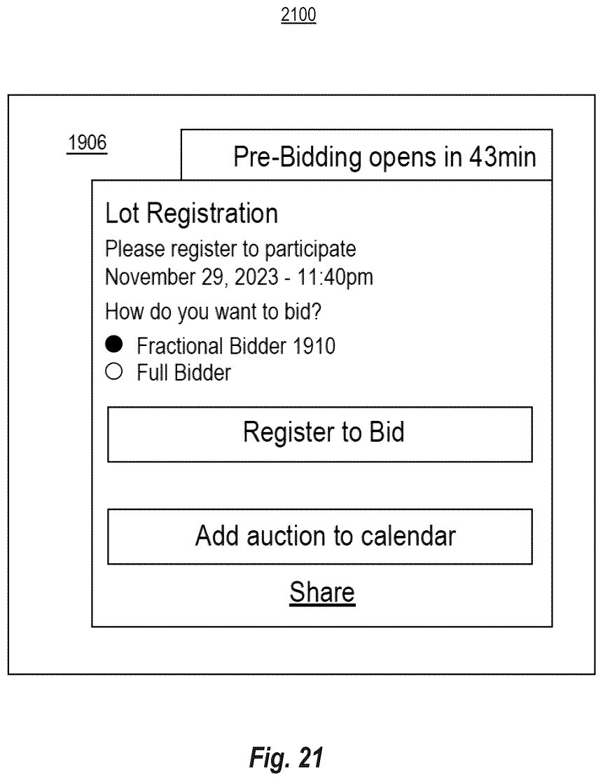

As shown in FIG. 20 and FIG. 21, a user is able to select between registering for the lot as a fractional bidder 1910 or a full bidder 1908. In some instances, window 1906 also shows a notification banner comprising information about the stage of the auction and timing (e.g., “pre-bidding opens in 43 min”).

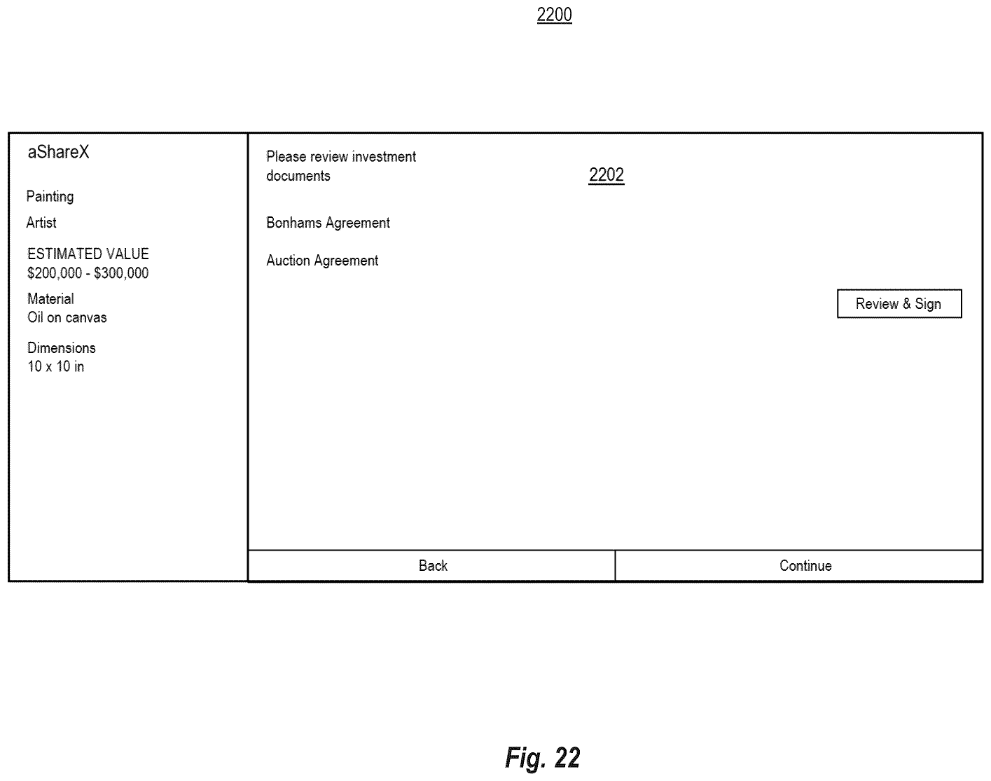

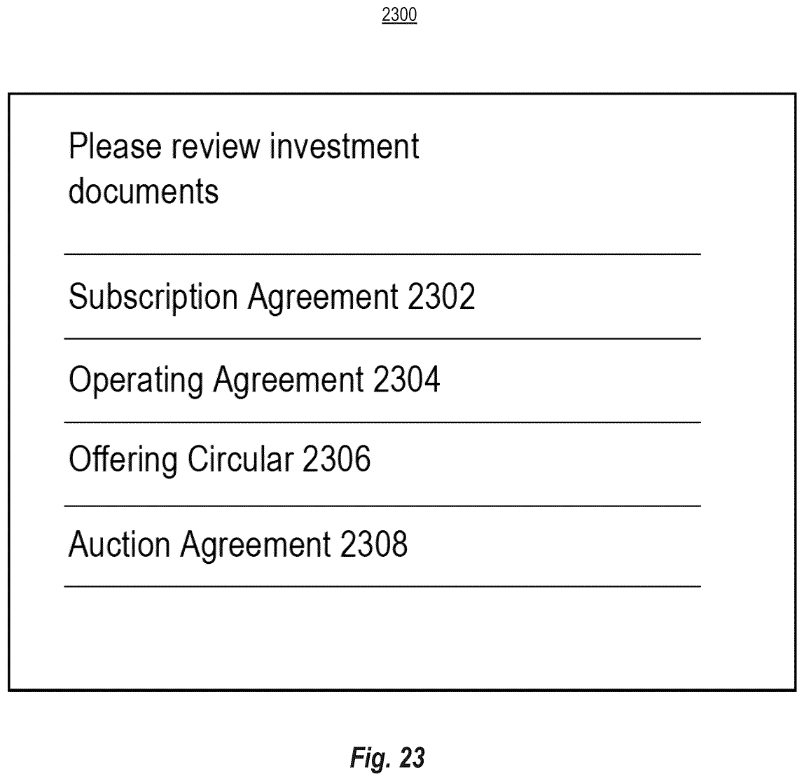

As shown in FIG. 22, after a user selects a certain type of bidder (e.g., fractional bidder or full bidder), the selectable icon “register to bid” from FIG. 21 triggers a new user interface 2200 to be generated and displayed. For example, FIG. 22 shows a window 2202 that prompts a user to review one or more investment documents associated with the auction (e.g., a Bonham agreement, an Auction Agreement, etc.). After a user reviews the associated documents, the user interface presents a “review & sign” selectable icon which triggers a new user interface for reviewing and signing various registration documents. As shown in FIG. 23, in some instances, a user is prompted to review a subscription agreement 2302, an operating agreement 2304, an offering circular 2306, and an auction agreement 2308.

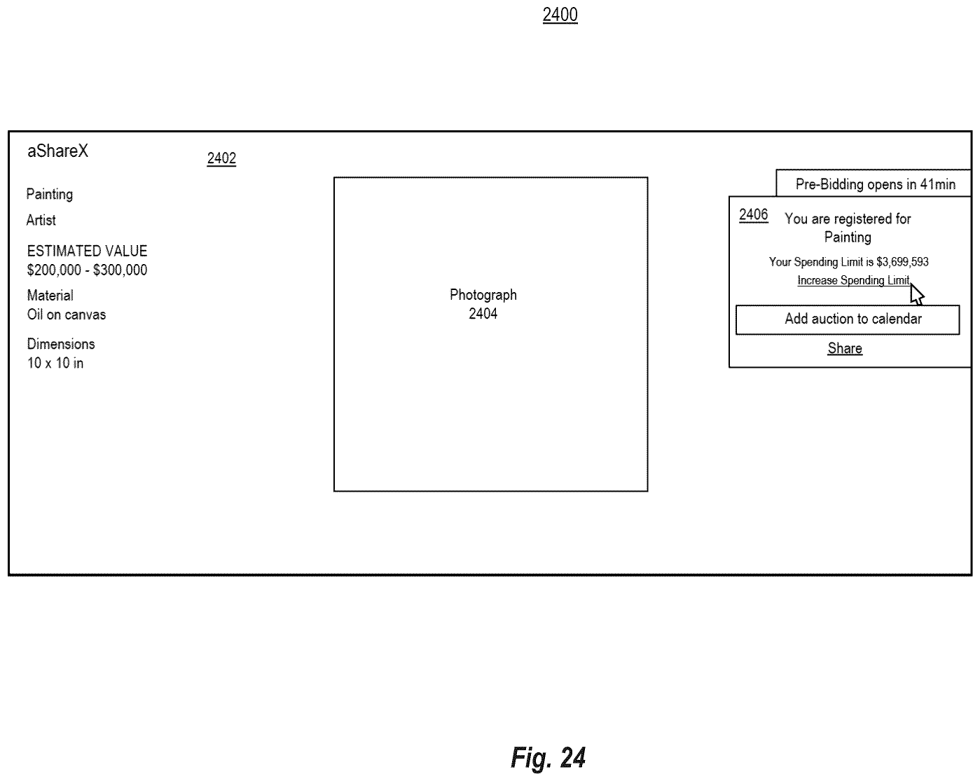

Attention will now be directed to FIG. 24, which illustrates user interface 2400 comprising a summary of the auction for which the user has registered, including auction item information, a photograph 2404 depicting the auction item, and window 2406 comprising textual information indicating that the user is registered for the auction, along with an approved/verified spending limit (i.e., maximum investment amount). In some instances, a user may wish to increase their spending limit.

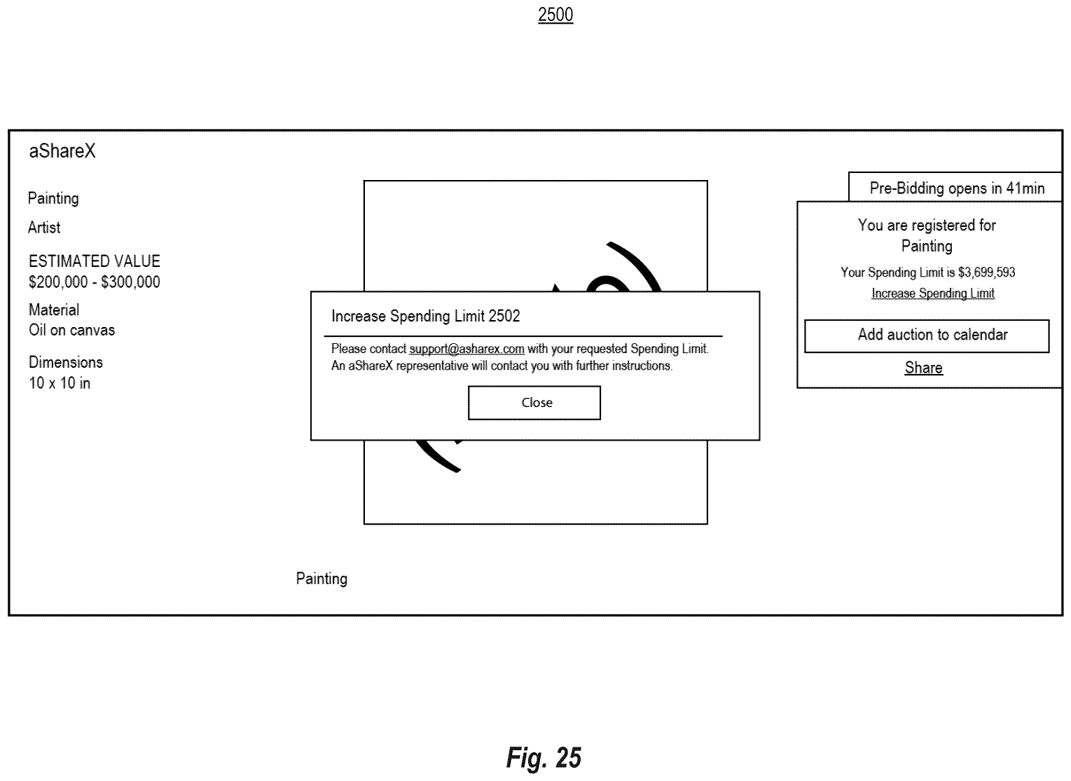

Attention will now be directed to FIG. 25, which illustrates an example embodiment of a user interface configured to facilitate an increase in spending limit for a bidder in an auction for a contested resource. For example, dialogue box 2502 is triggered to be displayed after a user selects the selectable icon for “increase spending limit”. Dialogue box 2502 comprises instructions and related links for facilitating an increase in a user's spending limit, including prompting the user to contact a platform administrator.

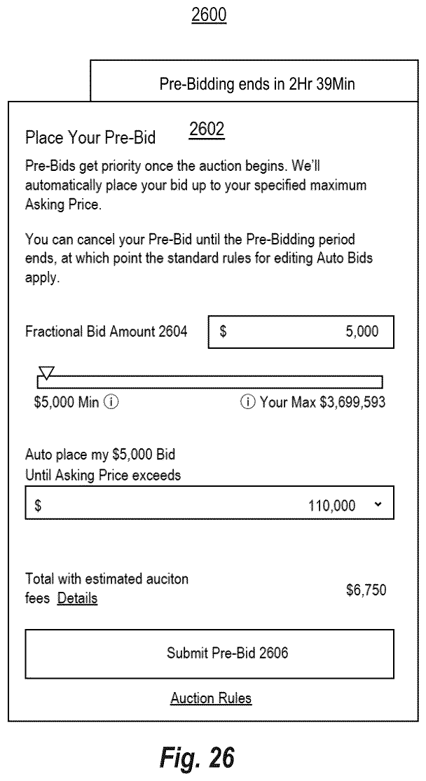

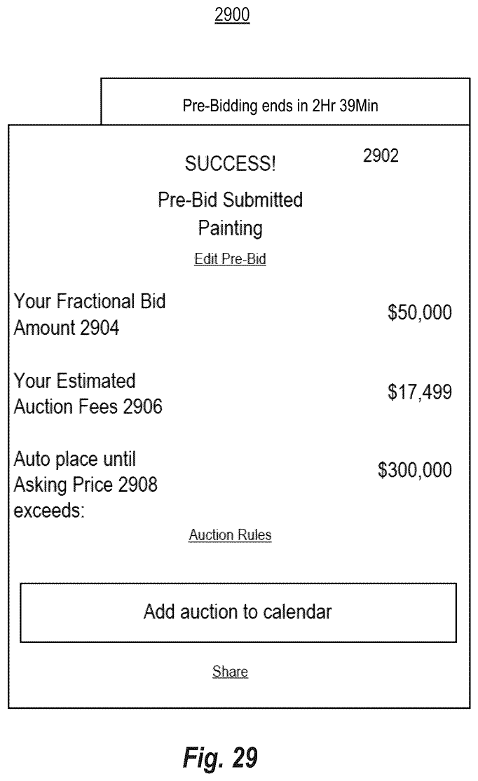

FIGS. 26-31 illustrate various example embodiments of user interfaces to facilitate a pre-bidding portion of an auction for a contested resource. Attention will now be directed to FIG. 26, which illustrates user interface 2600 comprising textual information and various form fields for a user to place a pre-bid during a pre-bidding portion of an auction. For example, user interface 2600 comprises a notification banner displaying an auction status and related timing (e.g., Pre-bidding ends in 2 hr 39 min). Window 2602 is provided for a user to place a fractional pre-bid via input box 2604 (e.g., $5000) or graphical slider 2604 that allows a user to manipulate the slider select 2604 any pre-bid amount between a minimum bid set (e.g., $5000) for the auction and a maximum investment amount (e.g., $3,699,593) for which the user has been verified, or an auction-defined upper limit, whichever is smaller. in some instances, an arbitrary limit of no more than a certain predefined percentage (e.g., 70% or 99% or other percentage) is set for a fractional bidder. In addition to placing a pre-bid, the user interface comprises input boxes for setting criteria for placing automatic bids during the auction after pre-bidding ends and the first bidding round starts. For example, in some instances, users are able to set a criteria to auto-place a bid (e.g., $5000 bid) until the asking price associated with the auction item exceeds a certain amount (e.g., $110,000). This value of the $110,000 can be selected from a pull-down menu, for example, which (when selected) provides many different values for a threshold asking price thresholds.

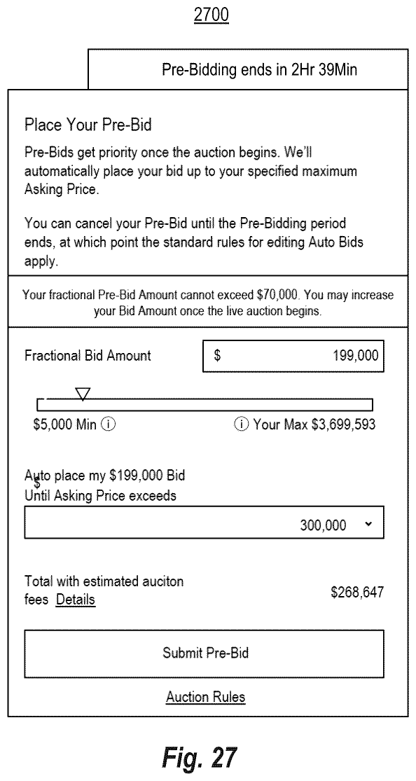

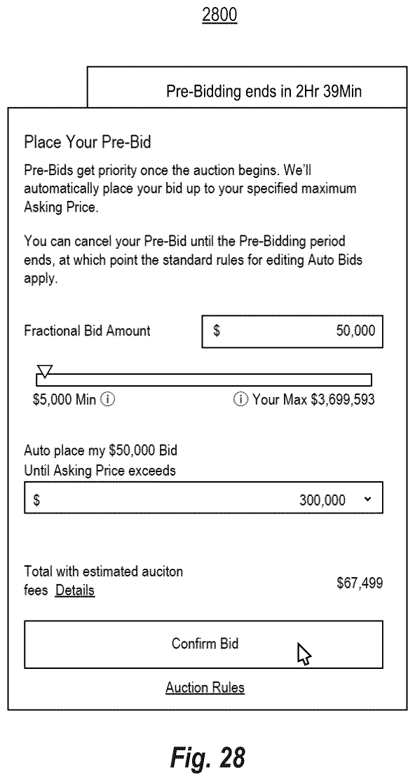

This means that the system will automatically submit the pre-determined bid amount each bidding round until the asking price exceeds the pre-determined maximum asking price set by the user. Window 2602 also is shown displaying a total amount that the user will pay if the bid is accepted and the fractional grouping wins. The total amount includes the bid amount and any auction fees. Window 2602 also displays selectable icon 2606 for submitting the pre-bid, along with an auto-bid settings. As shown in FIG. 27, as a user changes different amounts and settings within the user interface, the user interface (e.g., user interface 2700) is updated to display the new bid amounts, the new maximum asking price associated with placing auto-bids, and the total with estimated auction fees. Even after an initial pre-bid is submitted, if the pre-bidding has not ended, the user is able to edit their pre-bid and submit a new confirmation for the new pre-bid (see FIG. 28).

After a pre-bid is submitted and confirmed, a new user interface 2900 is triggered to be displayed, which displays a confirmation message to the user that the pre-bid was submitted, including a summary of pre-bid information (e.g., a fractional bid amount 2904, estimated auction fees 2906), and the maximum asking price 2908 to place auto-bids.

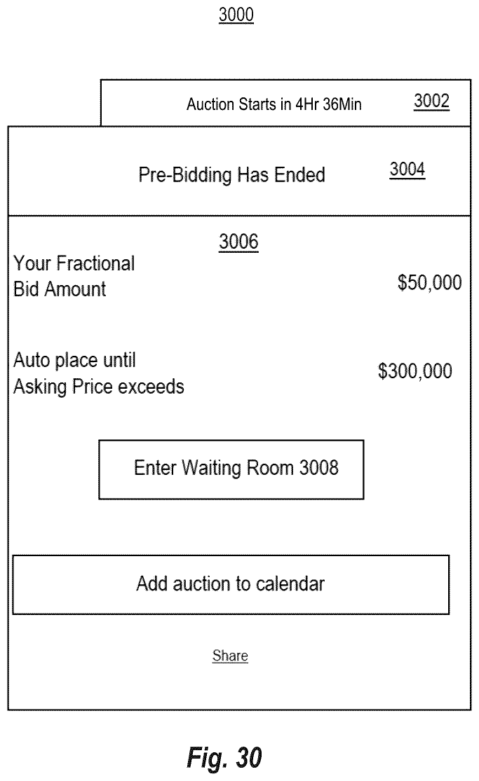

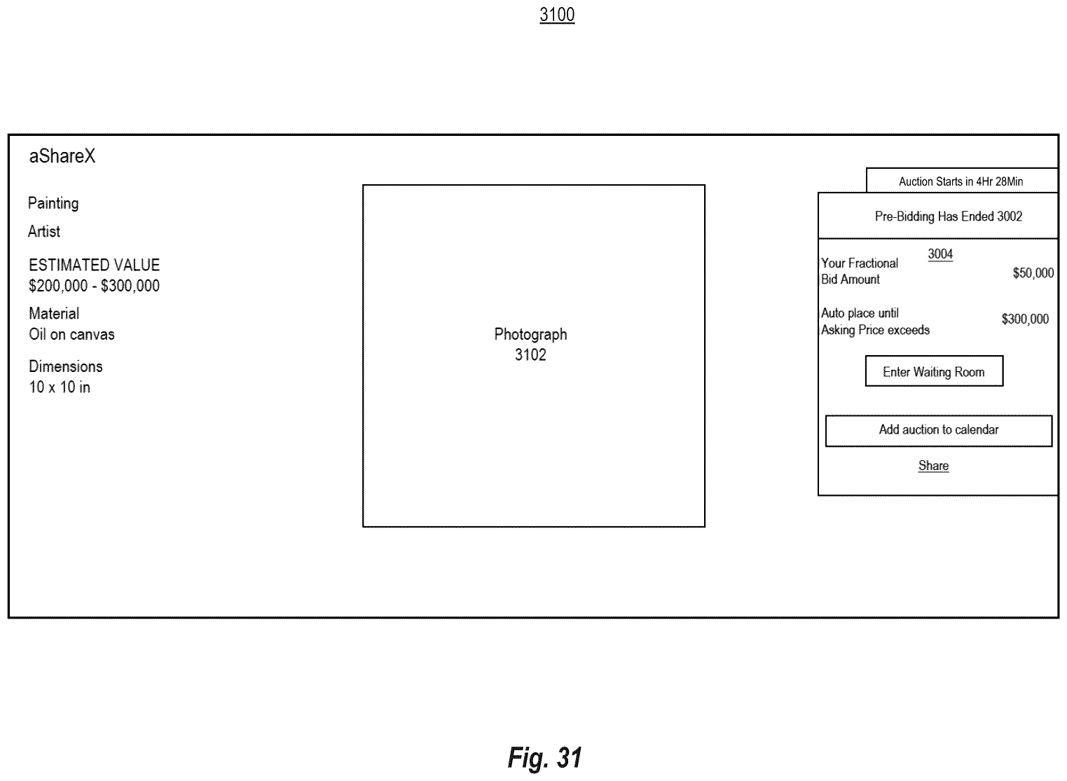

Attention will now be directed to FIGS. 30-31, which illustrate user interface 3000 (and user interface 3000 as part of larger user interface 3100) which displays a time notification banner 3002, an auction status banner 3004, and a bid summary window 3006. As shown in FIG. 30, the time notification banner 3002 displays textual information (e.g., “Auction starts in 4 hr 36 min”). The status banner 3004 has been dynamically updated to reflect the current status of the auction (e.g., “Pre-Bidding Has Ended”). Bid summary window 3006 comprises textual information about a user's fractional bid amount (e.g., “Your Fractional Bid Amount, $50,000) and textual information about auto-bid settings (e.g., “Auto place until Asking Price exceeds $300,000).

Bid summary window 3006 also is configured to display a plurality of selectable icons or links (e.g., “Enter Waiting Room” icon 3008, “Add auction to calendar”, and/or “Share”). Upon selecting the “Enter Waiting Room” icon 3008, the system is caused to present a new user interface corresponding to the waiting room of the current auction. Upon selecting the “Add auction to calendar” link, the system will add the auction to the user's calendar by sending a calendar invite and/or interfacing with a calendar app linked to the user based on registration information received.

Upon selecting the “Share” link (configured to allow a user to share information related to the auction item—not to be conflated with the shares/equity shares described herein), the system will open an interface window for the user to add an email address or phone number to send a link and/or calendar invite of the auction to share the link to the auction or other information related to the auction.

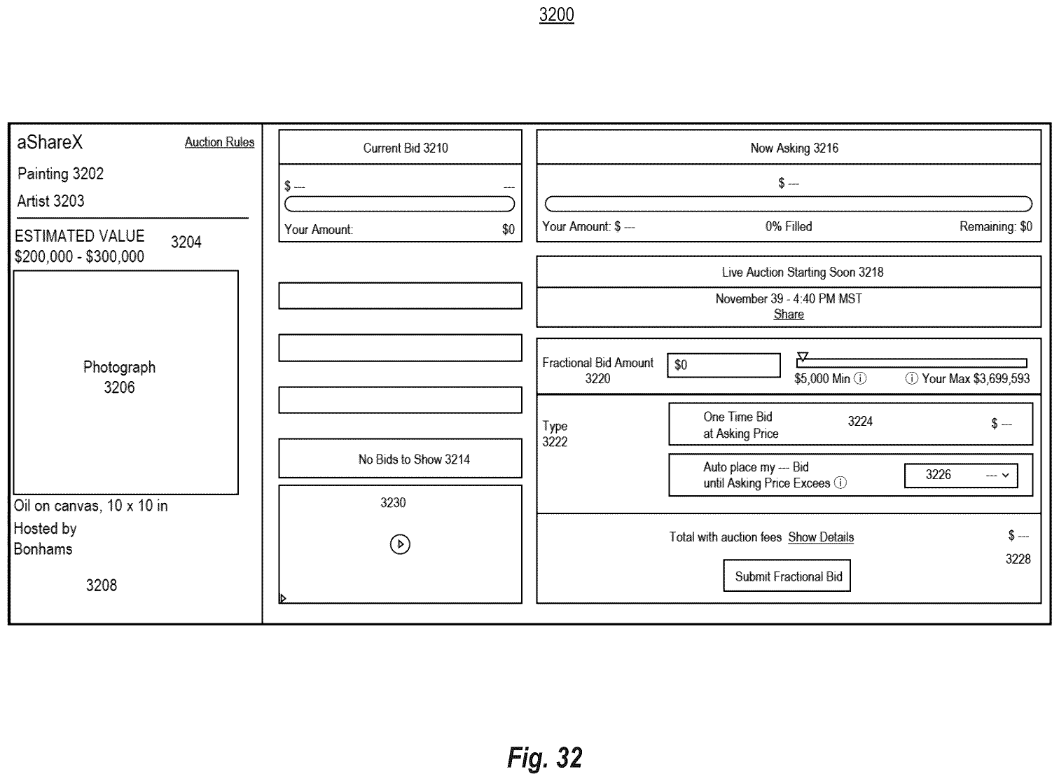

For example, FIG. 32 illustrates an example embodiment of a user interface configured to display a bidder's waiting room of an auction for a contested resource. In an auction, the waiting room refers to the user interface that a user will be presented and interact with after pre-bidding has ended but prior to the first bidding round of the auction starting. User interface 3200 is configured as a waiting room for a fractional bidder.

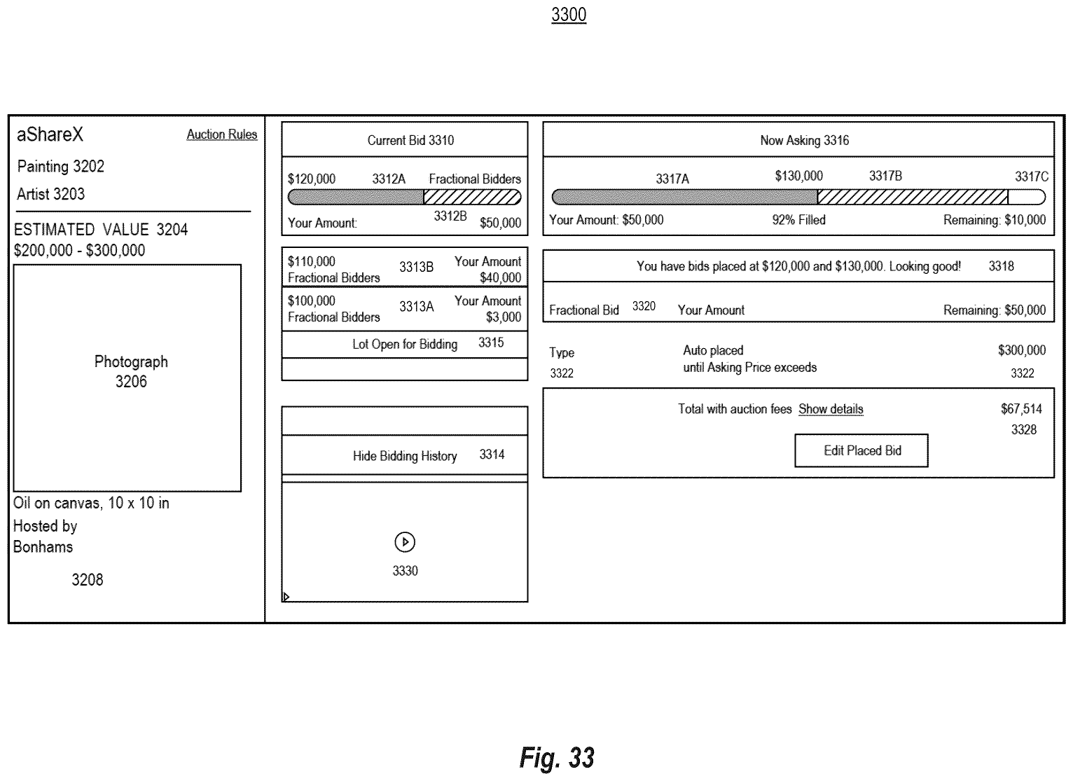

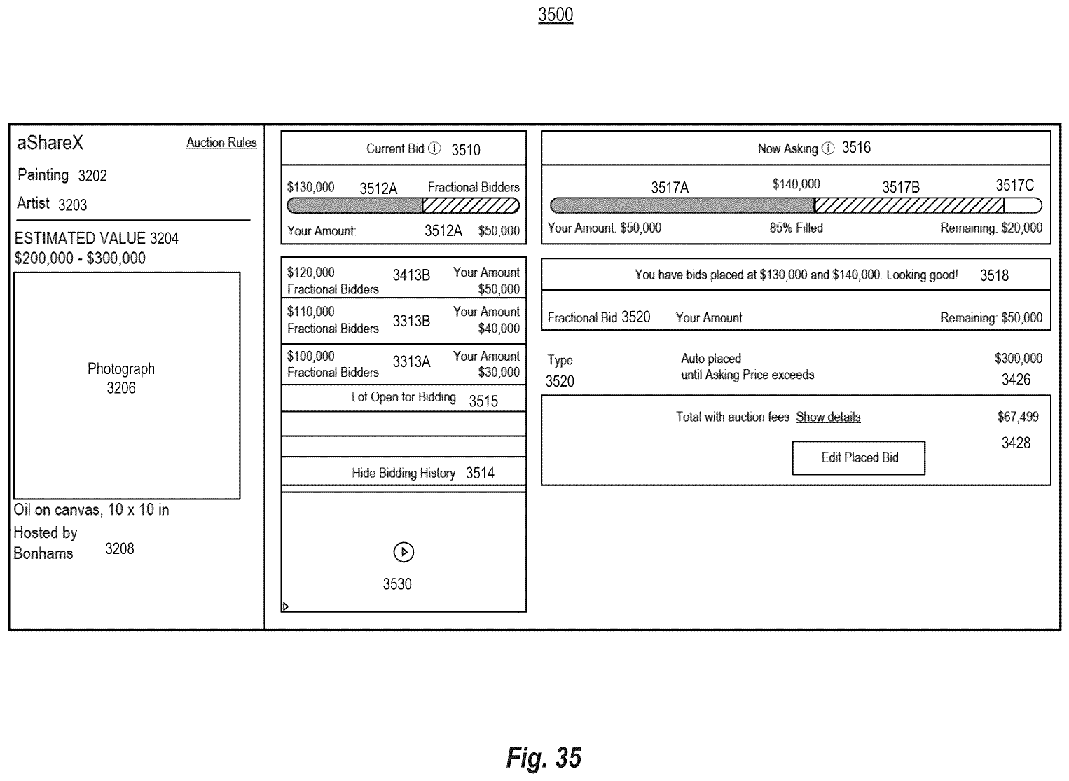

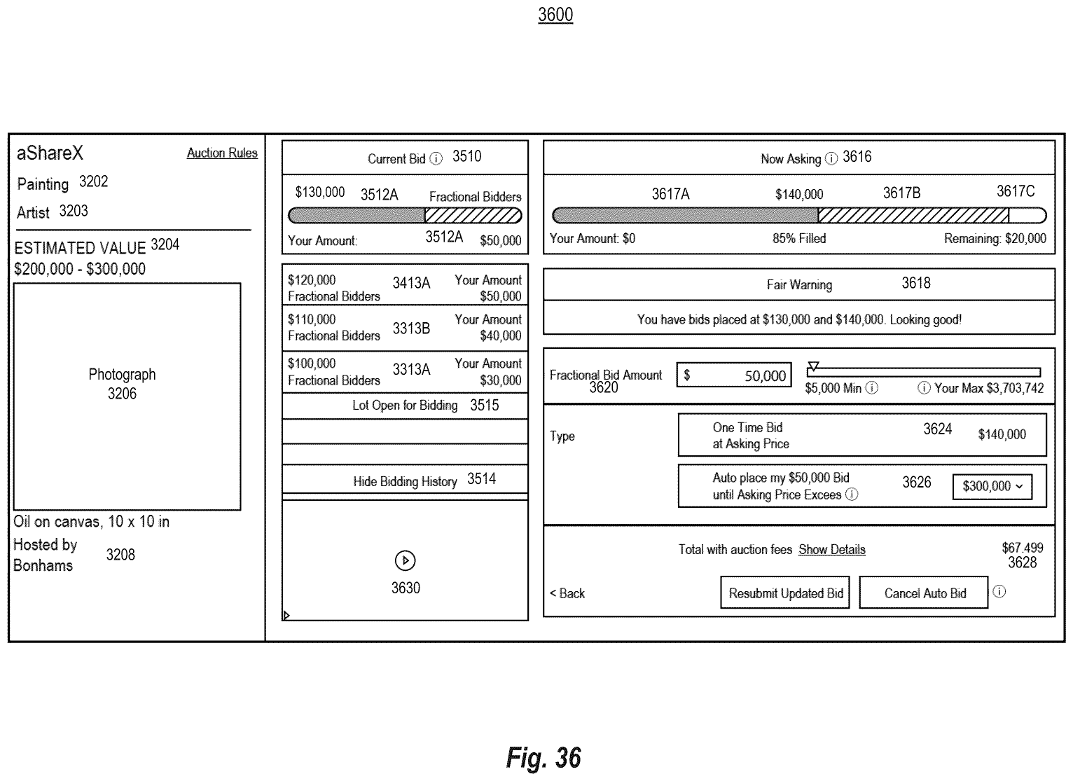

Attention will now be directed to FIGS. 33-38, which illustrate various example embodiments of user interfaces configured to facilitate the management of bidding requests from fractional ownership bidders in an auction for a contested resource. These figures will also illustrate a non-limiting example auction process utilizing the disclosed systems.

FIGS. 33-38 show various different windows or interface frames comprising textual and graphical information representing different categories of information related to the auction. As shown in FIG. 33, user interface 3300 is shown displaying auction item description information, such as the title 3202 of the auction item (e.g., “Painting”), the artist 3203, an estimated value 3204 (e.g., “$200,000-$300,000), a photograph 3206 or other graphical depiction of the auction item, and other descriptive information 3208 (e.g., “Oil on canvas”, dimensions like “10×10 in”, and “Hosted by Bonhams”).

User interface 3300 also displays a current bid window 3310 comprising textual information about the current bid (e.g., $120,000) and a graphical status bar comprising a first portion 3312A representing the user's bid amount (e.g., $50,000) and a second portion 3312B representing bid amounts from additional fractional bidders. As shown in FIG. 33, the first portion is displayed in a first format (e.g., shaded grey) to represent the primary bidder's amount and the second portion is displayed in a second format (e.g., filled with diagonal lines) to represent that the other bidders' portion corresponds to additional fractional bidders.

User interface 3300 also displays a bidding history window comprising textual information corresponding to previously completed bidding rounds. For example, a first bidding round 3313A is shown having an initial asking price of $100,000 that was bid by fractional bidders, with a primary bidding amount of $30,000. A second bidding round 3313B is shown having an asking price of $110,000 submitted by fractional bidders, with a primary or current user's bid amount at $40,000. In some instances, additional fractional bidders are secondary bidders (i.e., bidders that are participating in the auction/bidding round but not the bidders associated with using/interacting with user interface 3300).

User interface 3300 is shown displaying a selectable icon 3314 that, when selected, is configured to hide the bidding history (e.g., any previous bidding rounds, such as bidding round 3313A or bidding round 3313B). It should be appreciated that the systems are configured to store (e.g., using hardware storage device(s) shown in FIG. 1) all bidding history, including bids by each bidder (full or fractional) for every round of an auction. This storage can be volatile and/or non-volatile storage contained at a single server system and/or within distributed storage contained in any combination of the server system storage and third-party storage systems. FIG. 33 is also shown having an auction status notification window 3315 (e.g., Lot Open for Bidding) that is configured to display different statuses of the auction.

In some instances, user interface 3300 is also configured with a video frame that displays a live feed 3330 of the actual auction environment (e.g., a live feed of the room in which the live auction is taking place), if there is a live component to the auction. Additionally, or alternatively, a video frame may be presented that renders a virtual conference room screen that shows participants and the auctioneer. In other instances, a video frame is presented and selectable to trigger the playing of a video of information about the item being bid on.

As shown in FIG. 33, user interface 3300 also displays a “Now Asking” window 3316 that comprises textual information specifying the now asking price (e.g., $130,000) and a graphical status bar having different status bar portions. For example, a first status bar portion 3317B is displayed in a first format and represents the primary bidding entity's amount (e.g., Your Amount: $50,000). A second status bar portion 3317A is displayed in a second format and represents a total bid amount from additional fractional bidders. A third status bar portion 3317C is displayed in a third format (e.g., empty fill) and represents a remaining amount of resources needed to satisfy the now asking price. As shown in FIG. 33, in the current status of the bidding round, 92% of the asking price has been filled by the primary fractional bidding entity and additional fractional bidding entities, with $10,000 of the $130,000 asking price remaining.

User interface 3300 is shown having a notification banner 3318 that displays different messages to the user based on different status updates and changes in the auction. For example, as shown in FIG. 33, notification banner 3318 updates the user on the status of their bids (e.g., “You have bids placed at $120,000 and $130,000. Looking good!). Underneath the notification banner 3318, user interface 3300 also displays information about the primary fractional bidding entity's current fractional bid (e.g., fractional bid 3320, with an amount of $50,000).

The user interface 3300 displays the bid type 3322, along with how the bid was placed (e.g., “Auto placed until asking price exceeds $300,000”). In this case, the bidding criteria for placing an automatic bid was a maximum asking price 3326. User interface 3300 is also configured to display a total with auction fees amount 3328 (e.g., $67,514) that represents the primary bidding entity's investment amount including the bid amount and the fees associated with placing the bid amount. The user interface 3300 is also configured to allow a user to edit a previously placed bid by selecting a selectable link 3332 to an edit bid interface.

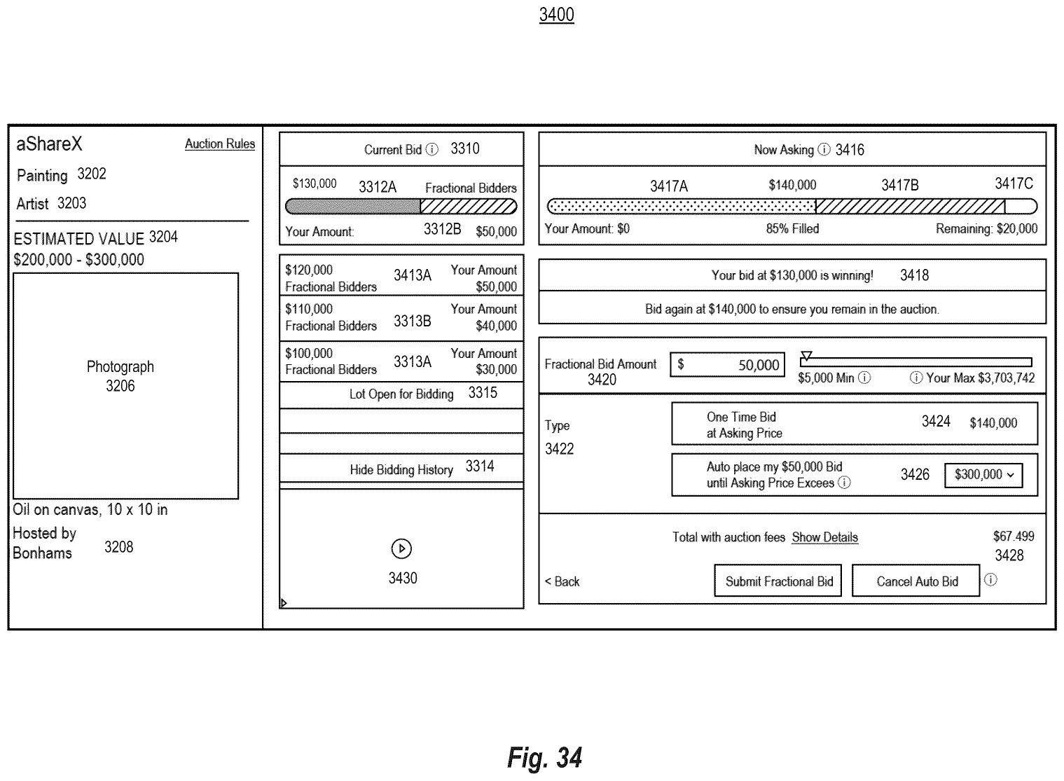

As shown in FIGS. 34-38, the bidder's user interface is updated throughout the auction, including updates during each bidding round and in response to initiating new bidding rounds during the auction. As shown in FIG. 34, the auction item information does not need to be updated during the auction (e.g., title 3202, artist 3203, estimated value 3204, photograph 3206, or other descriptive information 3208). However, other windows of the user interface are updated accordingly. For example, user interface 3400 has been updated to reflect that the previous bidding round associated with user interface 3300 has terminated and a new bidding round has been initiated. The current bid window 3310 reflects that the current bid (or previously completed asking price) is $130,000 and was satisfied by a fractional bidding group including a primary fractional bid and additional fractional bids, with the primary or current user's fractional bid amount being $50,000. The current bid is represented by a graphical status bar having a first portion 3312A representing the primary fractional bid amount and a second portion 3312B representing the additional fractional bid amounts.

The bidding history has been updated to now include the previously closed bidding round (e.g., bidding round 3413A) of $120,000 that was satisfied by fractional bidders, including a primary or current fractional bidding entity's bid amount of $50,000. Because the lot is still open for bidding, notification banner 3315 remains unchanged in displaying the notification for “Lot Open for Bidding”. The option for the user to hide the bidding history (e.g., icon 3314) is still displayed, since the bidding history is still being displayed and updated after each bidding round.

Because user interface 3400 is associated with a new bidding round, the now asking window 3416 has been updated to reflect the new asking price (e.g., $140,000). At this point in the new bidding round, the primary fractional bidding entity has not yet placed a new bid. Thus, the first status bar portion 3417A is formatted in a different formatting (e.g., polka dot filling) to indicate that the primary user's bid is currently $0, but would result in 85% of the bid being fulfilled with the additional fractional bidding amounts if the user were to place another bid at $50,000 in this bidding round. The now asking window 3416 shows that even if the primary fractional bidding entity were to place a new bid, there would still be $20,000 remaining in order to satisfy the new asking price of $140,000.

The notification bar 3418 is updated to alert the user to the status of the bid (e.g., “Your bid at $130,000 is winning!). The notification bar 3418 includes a secondary message prompting the user to “Bid again at $140,000 to ensure you remain in the auction.” This message is displayed because if the primary fractional bidding entity were to refrain from bidding in the bidding round associated with the new asking price of $140,000, they would not be included in the winning fractional bidding group for this round, if the new asking price was satisfied.

User interface 3400 also displays a bidding placement window including input fields for a user to define a fractional bid amount 3420 (e.g., $50,000) and a graphical input field bar by which a user is able to slide a dial across the input field bar to identify an amount at which to place a bid. The graphical input field bar has a minimum bid amount that was predetermined for the current bidding round and a maximum bidding amount that corresponds to a maximum investment amount for which the user was verified to invest during the auction registration process.

User interface 3400 also displays additional windows for applying different settings to the bid for the current bidding round, including a bid type 3422 (e.g., a one time bid at asking price 3424 or settings for placing auto-bids, like maximum asking price 3426). As in previous user interfaces, user interface 3400 also displays the total with auction fees (e.g., investment amount 3428) that the primary fractional bidding entity will pay if their corresponding fractional bidding group succeeds in meeting the asking price.

In response to the primary fractional bidding entity placing a bid, user interface 3500 is dynamically updated to reflect this new bid in the current bidding round. For example, the first status bar portion 3517A is dynamically updated in a new formatting to indicate that the primary user's bid has been placed and accepted. The notification bar 3518 is updated to also reflect the placement of the new bid (e.g., “You have bids placed at $130,000 and $140,000. Looking good!).

In some embodiments, after a certain amount of time has elapsed, the system is configured to display a warning banner 3618 (e.g., “Fair Warning” or “Last Call”) to indicate that time is running out in the current bidding round to place a bid. Alternatively, the fair warning is triggered when a corresponding selectable icon or button is selected on a user interface configured to receive input from an auction clerk user. The user interface 3600 is also updated to provide different input fields for the primary fractional bidding entity to resubmit/update a previously submitted bid, change settings for auto-bids, or cancel future auto-bids.

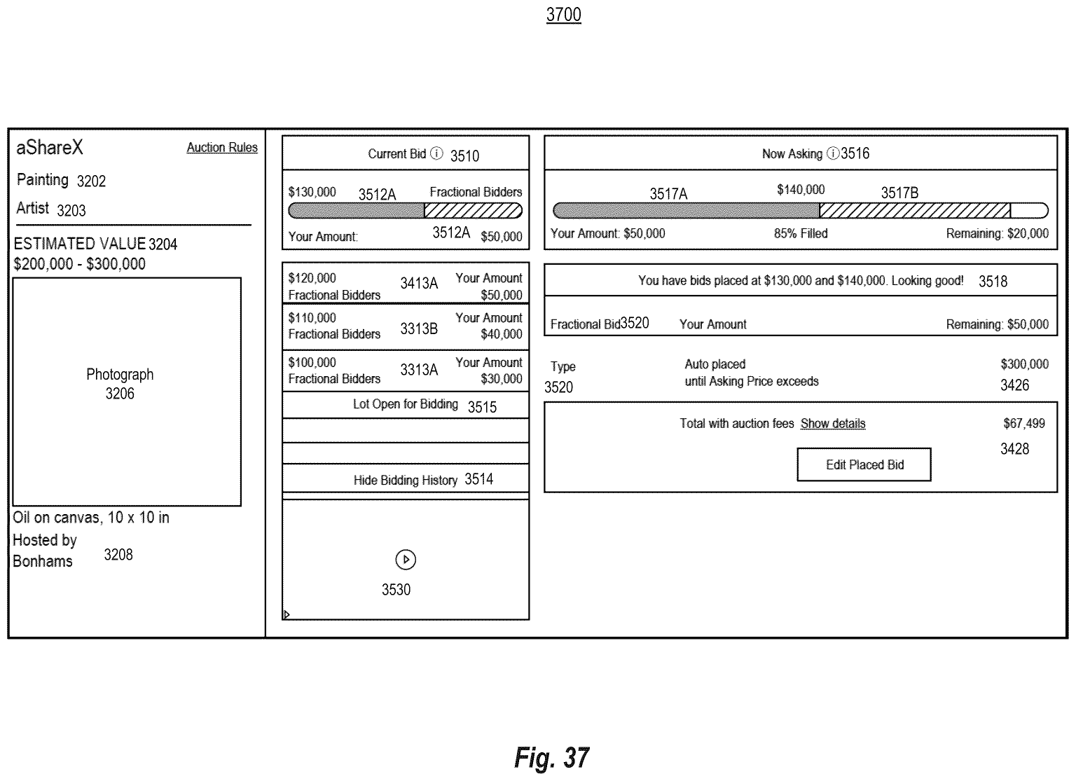

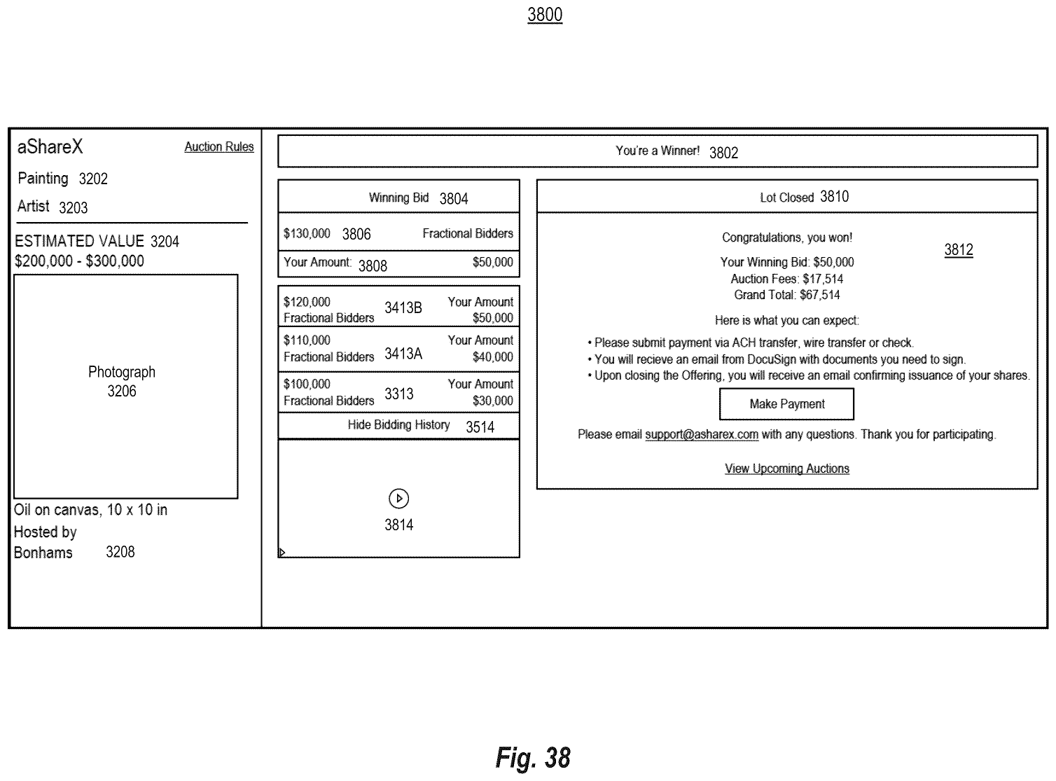

As shown in FIG. 37, the fair warning notification has been removed from the display, indicating that the bidding round is about to come to a close, while still allowing any last minute bidders to enter the bidding round or for previously accepted bidding requests to be altered. In this instance, no new bidders entered the bidding round and no previously accepted bids were changed. Thus, as shown in FIG. 38, the bidding round associated with user interface 3700 was terminated because the asking price of $140,000 was never satisfied in the last bidding round. The user interface 3800 is updated to reflect the winners of the auction, which is the fractional bidding group who satisfied the previous asking price of $130,000.

As shown in FIG. 38, the current bid window is no longer displayed. Instead, a winning bid window 3804 is shown displaying the winning bid amount 3806 and by whom the winning bid amount was satisfied (e.g., Fractional Bidders). If the winning bid amount 3806 was associated with a full bidding entity instead of fractional bidding entities, the winning bid window 3804 would read “Full Bidder”. The winning bid window 3804 also displays the primary user's bid amount 3808 (e.g., $50,000). User interface 3800 is also configured to display an auction status notification bar 3810, which has been updated to display textual information that the lot has been closed (e.g., “Lot Closed”) and is no longer accepting any new bids in any new bidding rounds.

A video frame 3814 may be selected to trigger a live action or replay of the auction room where the auction is taking place. This auction room may be an actual physical room and/or a virtual conference room screen that shows participants and the auctioneer. In other instances, the video frame 3814 or another frame is presented and selectable to trigger the playing of a video of information about the item being bid on.

User interface 3800 also displays a summary window 3812 which displays textual information congratulating the primary fractional bidding entity on winning the auction, along with other bid information. The summary window 3812 also comprises a selectable payment icon 3816 that is configured to trigger a set of user interfaces that allow the primary user to complete payment of their individual fractional bid.

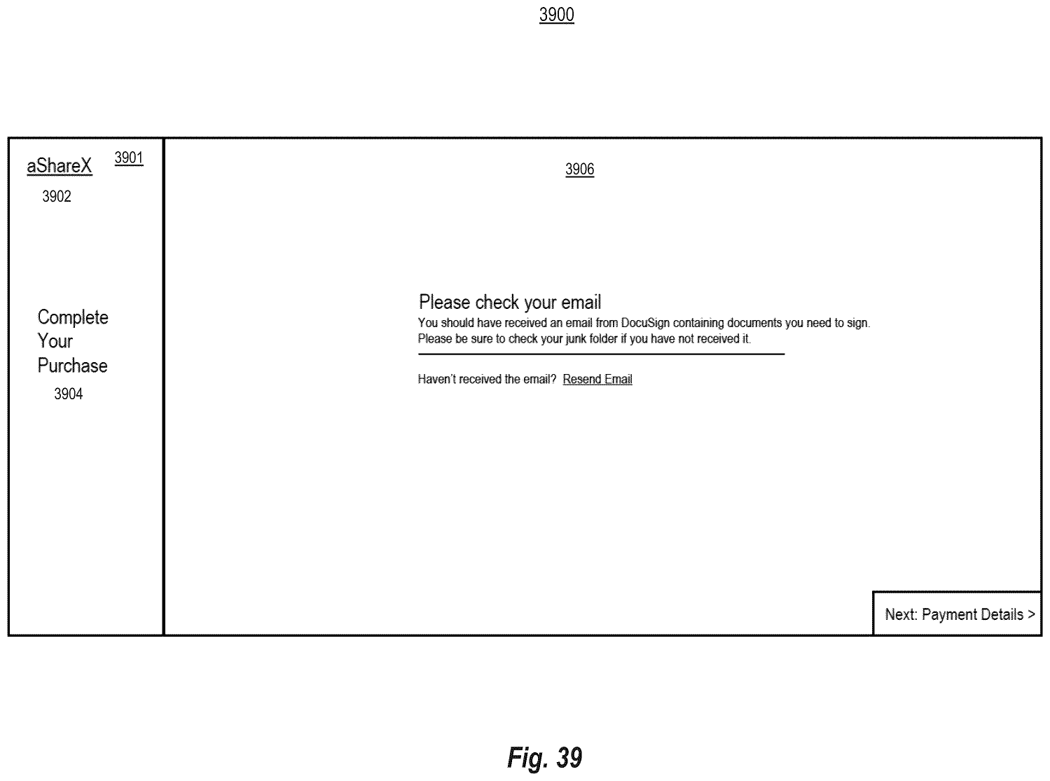

Attention will now be directed to FIGS. 39-41, which illustrate various example embodiments of user interfaces configured to facilitate payment from a bidder for fractional allocation of shares for a contested resource after an auction has been closed. For example, user interface 3900 comprises a left-hand window 3901 displaying a selectable link 3902 to return to a homepage (e.g., “aShareX”) and a page heading title 3904 (e.g., “Complete Your Purchase”). User interface 3900 also is shown displaying a right-hand window 3906 comprising textual information prompting the user to check their email for documents to sign as part of completing the auction payment process.

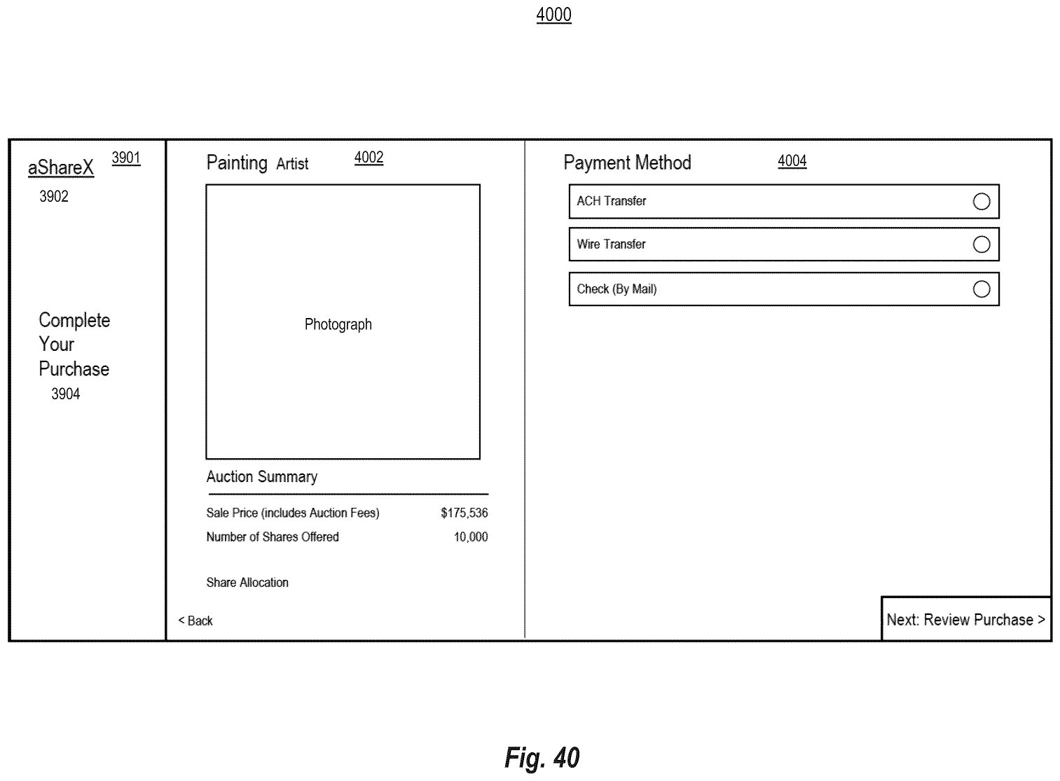

As shown in FIG. 40, user interface 4000 is shown illustrating right-hand window 3901, a middle window 4002, and a new left-hand window 4004. The right-hand window 3901 has not been changed from the last user interface 3900. The middle window 4002 is shown displaying a graphical representation of the auction item (e.g., “Photograph”) along with a brief auction summary, including the sale price of the auction item with included auction fees (e.g., $175,536) and the number of Shares offered (e.g., 10,000) to the fractional bidding group who won the auction. The system also determines a Share allocation for each individual fractional bidding entity in the fractional bidding group.

Window 4004 is shown displaying a plurality of selectable payment icons (e.g., ACH Transfer, Wire Transfer, or Check) which when selected, trigger different payment processes depending on the type of payment the user would like to make to pay their fractional bid amount.

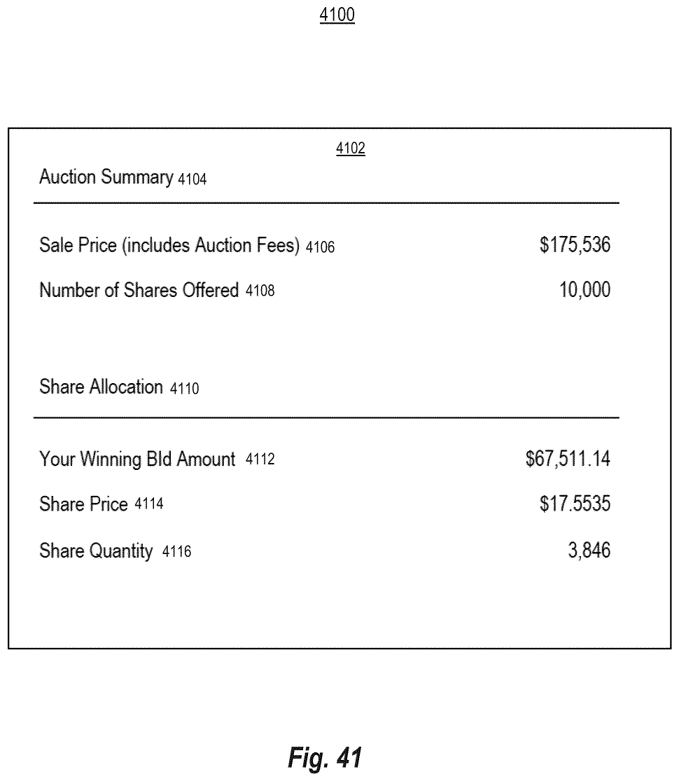

As shown in FIG. 41, the user interface is updated to display a detailed summary window 4102, which includes an auction summary 4104. The auction summary includes a sale price 4108 (including auction fees—e.g., $175,536) and a predetermined total quantity of Shares 4108 associated with the auction item. Window 4102 also displays a Share allocation summary 4110, including the primary user's winning bid amount 4112, including fees (e.g., $67,511.14), a Share price 4114 (e.g., $17.5535) and a Share quantity 4116 (or subset of Shares) determined to be in proportion with the user's individual winning bid amount (e.g., 3,846). In some instances, the user's bid amount is adjusted upwards or downwards such that the bid amount equals a whole number of Shares that will be allocated to the fractional bidding entity.

The interface of FIG. 40 also shows a Review Purchase icon that can be selected to cause the system to display a new purchase summary interface that reflects details of the purchased asset and shares in the asset owned by the user. The user can also select a user portfolio icon that can be displayed on the current interface of FIG. 40 (not currently shown), or in the purchase summary interface or in any of the other interfaces described herein (not presently shown). When a user selects the user portfolio icon, the system will identify from the user's stored profile information the bidding history of the user and/or the assets that have been acquired and/or the shares the user owns in different auction assets. The system will also display that information in a portfolio interface (not presently shown). The portfolio interface can also present information about upcoming auctions, current auctions and previously completed auctions, as well as the bidding information and status information of those auctions relevant to the user (e.g., the user's bids).

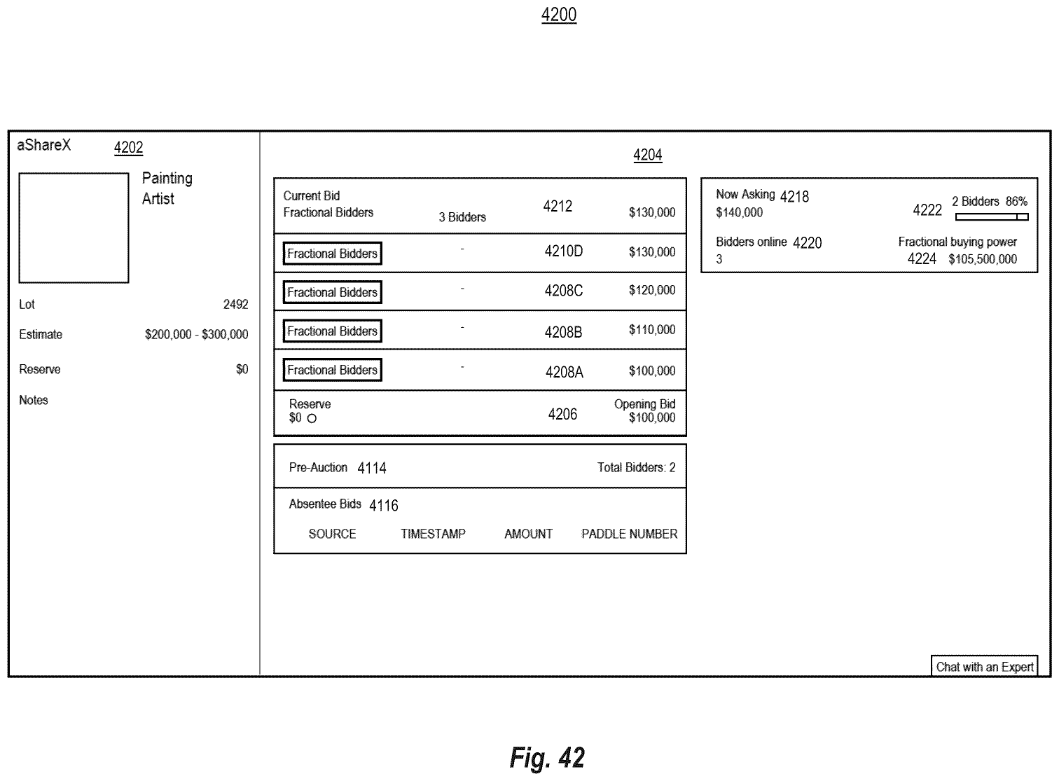

Attention will now be directed to FIG. 42, which illustrates an example embodiment of a user interface configured to facilitate management of an auction between fractional ownership bidders and full bidders by an auctioneer. For example, FIG. 42 is shown illustrating an auctioneer user interface 4200 comprising an auction item description window 4202 and an auction status window 4204. The auction item description window 4202 is shown displaying textual and graphical information about the auction item (e.g., contested resource) including the auction item title (e.g., “Painting”), artist, lot number (e.g., “2492”), estimated value (e.g., $200,000-$300,000), a reserve (e.g., $0), and other notes.

The auction status window 4204 is shown displaying textual information 4212 about the current bid, including a type of bidder (e.g., fractional bidders), the amount of bidders (e.g., 3 bidders), and asking price (e.g., $130,000). The auction status window 4204 also is shown displaying textual information about previously completed bidding rounds (e.g., bidding round 4208A, bidding round 4208B, bidding round 4208C, and bidding round 4208D). For example, bidding round 4208A including a type of bidder (e.g., Fractional Bidders) and asking price (e.g., $100,000). Bidding round 4208B includes fractional bidders and an asking price of $110,000. Bidding round 4208C was won by fractional bidders at an asking price of $120,000. Bidding round 4208D was also satisfied by fractional bidders at an asking price of $130,000, which is the currently winning bid. The textual information for the type of bidder and/or corresponding bidding round, including the currently winning bid, is formatted in a different format based on the type of bidder associated with the bidding round.

Window 4204 is also shown displaying information about a reserve 4206 associated with the auction lot. In this case, as shown in FIG. 42, there was no reserve. Window 4204 is also shown displaying textual information 4114 about a pre-auction stage of the auction. As shown in FIG. 42, there were a total of two bidders who submitted pre-bids before the lot was officially opened. Textual information about any absentee bids 4116 is also shown, including the source, timestamp, amount, and paddle number. An absentee bid is a full bid for full ownership made by a full bidding entity during the pre-bidding stage of the auction.

Finally, window 4204 also shows textual information 4218 about the now asking amount in the current bidding round (e.g., $140,000), textual information 4222 about the number of bidders (e.g., 2 bidders) along with textual and graphical information (i.e., a graphical status bar) showing the percentage of the asking price that has been accounted for by the received bids. The user interface 4200 is also shown displaying the number of bidders 4220 currently online (e.g., 3 bidders online) and the corresponding fractional buying power 4224 associated with one or more of the bidders. By displaying and updating this information in real-time through the auctioneer's user interface 4200, including displaying different information in different formats, the auctioneer is able to quickly understand the current state of the auction and be able to call out the correct asking prices for the auction item during each bidding round.

Window 4204 also includes a selectable option 4224 which, when selected, initiates a call or messaging session with an expert about the auction process and/or the item being bid on.

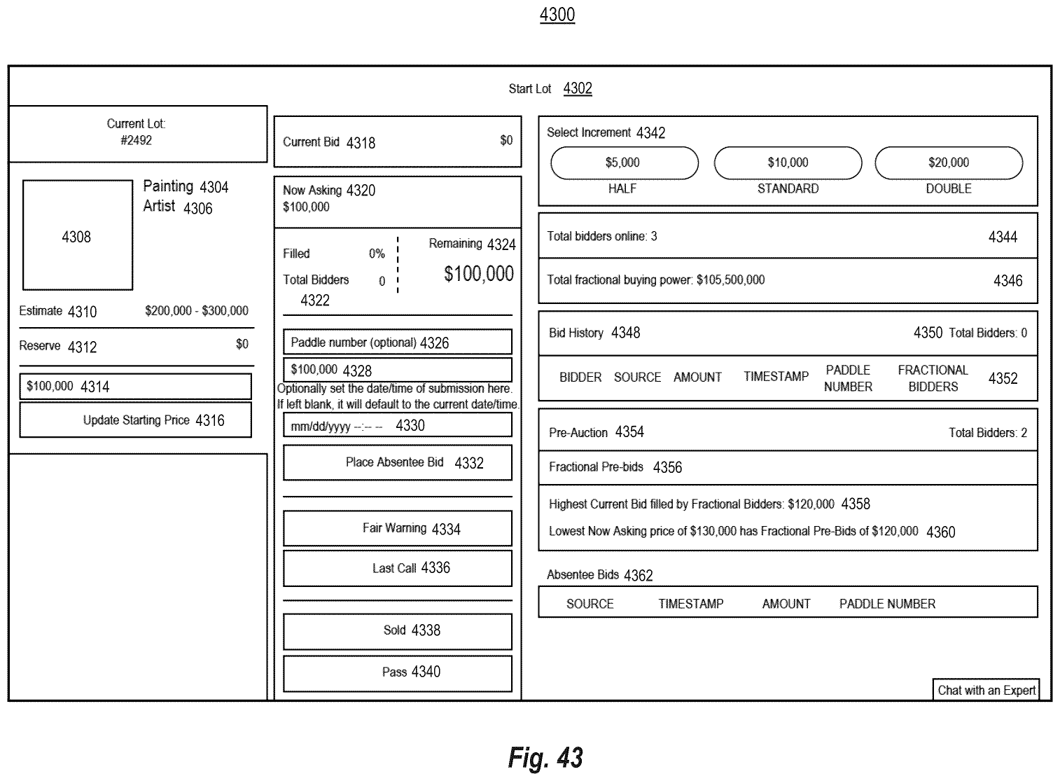

Attention will now be directed to FIG. 43, which illustrates an example embodiment of a user interface configured to facilitate management of an auction between fractional ownership bidders and full bidders by an auction clerk. It should be appreciated that the user interface related to FIG. 43 can be adapted for both internal and external auctions. An external auction is one that utilizes a third-party auctioneer for accepting the bid. For example, auction clerk user interface 4300 includes a current lot summary including the current lot number (e.g., #2492), a graphical depiction 4308 of the auction item, auction item title (e.g., “Painting 4304), artist 4306, estimated value 4310 (e.g., $200,000-$300,000), a reserve 4312 (e.g., $0), and a starting price 4314 (or initial asking price) (e.g., $100,000) at which the auction will start the first bidding round. Using the selectable icon 4316, the auction clerk can also update the starting price. Any update in the starting price is reflected in the starting price 4314 displayed within the start lot window 4302.

As shown in FIG. 43, user interface 4300 is shown displaying information related to an auction in the pre-bidding phase. For example, start lot window 4302 is also shown displaying the current bid 4318 and now asking amount 4320 that will be associated with the first bidding round. Because the first bidding has not started, the current bid 4318 is shown at $0 and the now asking amount 4320 is shown as the starting price 4314 set by the auction clerk. The bidding round summary sub-window displays a percent filled (e.g., 0%) total bidders 4322 (e.g., 0) and remaining amount 4324 (e.g., $100,000).

User interface 4300 also displays any absentee bids that have been received, as well as interface components for an auction clerk to submit an absentee bid that has been received by a full bidder during the pre-bidding of the auction. This is done by updating the paddle number 4326, the absentee bid amount 4328 (e.g., $100,000), the date/time 4330 of submission, and selecting the selectable submit icon 4332 for placing the absentee bid.

User interface 4300 is also shown displaying a plurality of selectable icons (e.g., fair warning 4334, last call 4336, sold 4338, and pass 4340). When any of these selectable icons are selected, the computing system causes the icon to be re-formatted in a different format to indicate that they have been selected. Additionally, by selecting any of the aforementioned selectable icons, a corresponding notification banner is generated and caused to be displayed in the bidder's user interface and/or auctioneer's user interface. In some instances, the icon is re-formatted for the time period that that the banner is shown on the other corresponding user interfaces. In some instances, each banner is configured to be displayed for a pre-determined amount of time. In other instances, the auction clerk determines the length of time the notification banner is being displayed by selecting the icon again, which removes the banner being displayed on corresponding user interfaces for other user types in the auction, as well as returns the formatting of the selectable icon back to its default display formatting.

User interface 4300 is also shown displaying an increment window 4342, a fractional bidder summary, including total bidders 4344 and total fractional buying power 4346, a bid history 4348, and a pre-auction summary 4354. The increment window 4342 is configured to display a plurality of selectable increment icons which, when selected, increase the asking price by a specified, pre-determined increment. For example, each new bidding round starts at a new asking price that is higher than the previous asking price in a previous bidding round. The auction clerk is able to select by how much the new asking price is increased from the previous asking price, including by a half increment (e.g., $5000), a standard increment (e.g., $10,000), or a double increment (e.g., $20,000).

When the auction clerk submits an increment increase in the asking price, the corresponding user interface components on the bidder's user interface and auctioneer's user interface are updated in real-time to reflect the increased asking price for the new bidding round.

The total bidders online 4344 is three (3) and have a total fractional buying power 4346 of $105,500,000. The bid history 4348 shows a total bidder count 4350 of zero (0). It shows zero bidders in the bid history because official bidding rounds have not begun yet. The pre-auction summary 4354 shows a total bidder count of 2 bidders, including a summary of fractional pre-bids 4356 and summary of absentee bids 4362. The fractional pre-bid summary 4358 is shown having a pre-bid with a highest current bid 4358 filled by fractional bidders at $120,000, while the lowest now asking price 4360 of $130,000 has fractional pre-bids up to $120,000. Here, no absentee bids are shown as being received in the absentee bid summary 4362. It is here from the summary portion that an auction clerk would be able to learn information about absentee bids and manually submit them into the auction via the place absentee bid selectable icon 4332.

It should be appreciated that the computing system is constantly monitoring the current stage of the auction, presence of registered bidders in the auction, and incoming bids by the different bidders, including fractional bidding entities and full bidding entities, in order to dynamically update the auction clerk's user interface and corresponding user interfaces for the auctioneer and bidder in real-time and in response to user input received at any one of the user interfaces. By providing a set of user interfaces that are each configured differently to enable efficient display and updating of interface components during the dynamically changing auction, the user experience is improved for each type of user, including the auctioneer, the auction clerk, and the different types of bidders (e.g., fractional bidders and full bidders).

By formatting and displaying the different information relating to the auction, as described herein, auction user interfaces are configured to enable seamless participation in the auction by both fractional bidders and full bidders.

### Example Methods

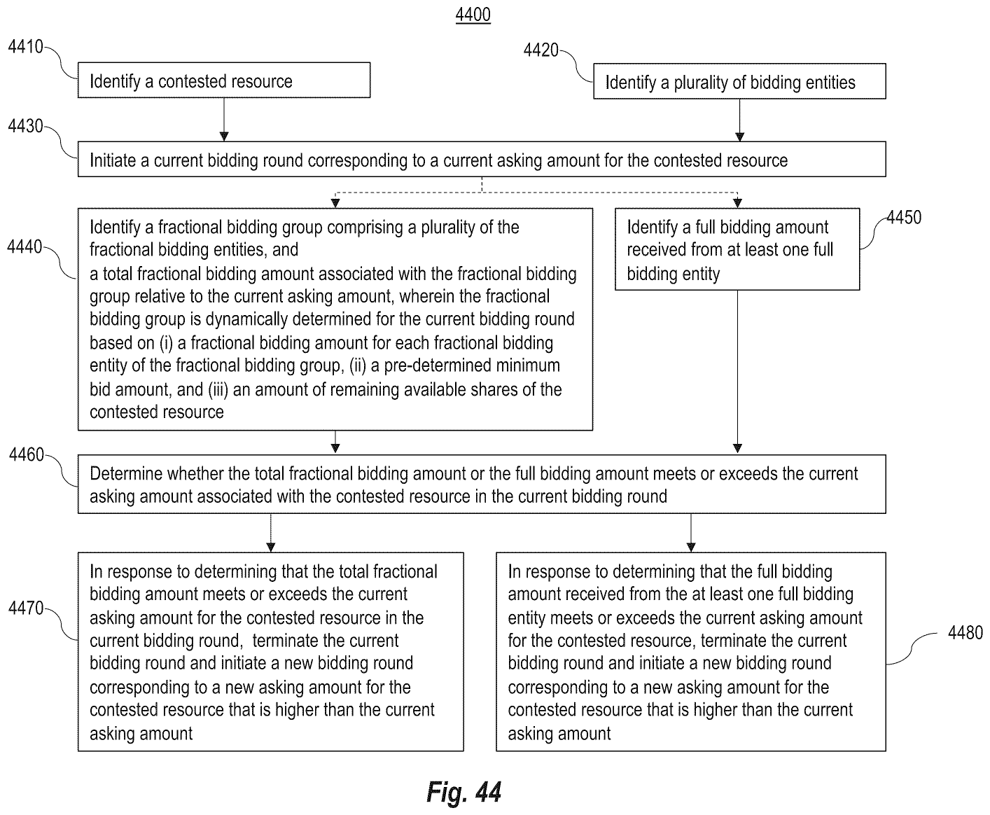

Attention will now be directed to FIGS. 44-50, which each illustrate different flow diagrams associated with methods described herein for managing different aspects of auctions with fractional bidders and full bidders. Attention will first be directed to FIG. 44, which illustrates one embodiment of a flow diagram having a plurality of acts (act 4410, act 4420, act 4430, act 4440, act 4450, act 4460, act 4470, and act 4480) associated with exemplary methods that can be implemented by computing system 110 for facilitating the management of auctions involving both fractional ownership bidders and full bidders.

A first illustrated act is provided for identifying a contested resource (act 4410) or auction item, like a painting or other artwork, or bottle of wine, or other auction item. Systems also identify a plurality of bidding entities (act 4420). The plurality of bidding entities include full bidding entities that are registered to individually bid on the contested resource for a full ownership of the contested resource, and fractional bidding entities that are registered to bid on the contested resource for a fractional ownership of the contested resource as part of a fractional bidding group that collectively has full ownership of the contested resource.

Subsequently, systems initiate a current bidding round corresponding to a current asking price for the contested resource (act 4430). After initiating the current bidding round, systems identify a fractional bidding group comprising a plurality of the fractional bidding entities, and a total fractional bidding amount associated with the fractional bidding group relative to the current asking price (act 4440). The fractional bidding group is dynamically determined for the current bidding round based on (i) a fractional bidding amount for each fractional bidding entity of the fractional bidding group, (ii) a pre-determined minimum bid amount, and (iii) an amount of remaining available Shares of the contested resource. It should be appreciated that the fractional bidding group is dynamically determined based on a priority schema (e.g., time priority) for determining which fractional bidding entities will be included in the fractional bidding group.

Systems identify a full bidding amount received from at least one full bidding entity (act 4450) and determine whether the total fractional bidding amount or the full bidding amount meets or exceeds the current asking price associated with the contested resource in the current bidding round (act 4460). It should be appreciated that in some instances, either act 4440 or 4450 can be performed alternatively (i.e., one or the other), wherein the system queues the bids and accepts a valid bid, or bid that meets the asking price, based on a time priority. In some instances, there may be a small window of time in which multiple valid bids (or multiple bids that meet the asking price) but have not yet been recognized by the system to trigger an advance to the next bidding round. Thus, in that small window of time before the round advances, another bid may be submitted. However, once a bid is recognized as meeting the asking price, the current bidding round is terminated and a new bidding round is initiated.

In response to determining that the total fractional bidding amount meets or exceeds the current asking price for the contested resource in the current bidding round, systems terminate the current bidding round and initiate a new bidding round corresponding to a new asking price for the contested resource that is higher than the current asking price (act 4470). Alternatively, the total fractional bidding amount, if it exceeds the current asking price, is rounded down, either by rounding each fractional bid proportionally or by rounding down the last fractional bid entry.

Alternatively, in response to determining that the full bidding amount received from the at least one full bidding entity meets or exceeds the current asking price for the contested resource, systems terminate the current bidding round and initiate a new bidding round corresponding to a new asking price for the contested resource that is higher than the current asking price (act 4480).

In some instances, systems also generate and cause to be displayed a user interface on a computing screen associated with the computing system, the user interface displaying textual and graphical information representing (i) the contested resource, (ii) the current bidding round, (iii) the current asking price, (iv) the fractional bidding group, and (v) the total fractional bidding amount relative to the current asking price.

The computing system is configured to monitor different aspects of the bidding rounds of the auction. For example, during the current bidding round, systems identify one or more new fractional bidding entities and one or more new fractional bidding amounts associated with the one or more new fractional bidding entities. In response to identifying one or more new fractional bidding entities, dynamically update the fractional bidding group with one or more new fractional bidding entities and dynamically update the total fractional bidding amount based on the one or more new fractional bidding amounts associated with the one or more new fractional bidding entities.

Based on new information or status updates in the auction, the computing system is configured to update corresponding user interfaces. For example, in response to dynamically updating the fractional bidding group and the total fractional bidding amount, systems dynamically update a user interface displayed on a computing screen associated with the computing system by updating the textual and graphical information with the updated fractional bidding group and the updated total fractional bidding amount relative to the current asking price associated with the current bidding round. By updating the user interfaces in real-time, the user experience of participating in the auction is greatly improved by bidders, auction clerks, and auctioneers having the most up to date or real-time information about the auction formatted in easily identifiable formatting.

After a bidding round is terminated, the fractional bidding group associated with the bidding round (if they are the winning bidders) is cached and a new fractional bidding group will be generated and updated during each new bidding round. For example, after initiating the new bidding round, systems define a new fractional bidding group based on a plurality of fractional bidding entities and corresponding fractional bid amounts submitted in the new bidding round.

In some instances, there might not be a new fractional bidding group if one of the fractional bidders was rounded down to the amount remaining, wherein the user receives a higher amount per their bid. This would then fill the subsequent/higher asking price. Alternatively, if a fractional bidding entity increases their bid during a particular bidding round, it may fill the new higher asking price. Additionally, it should be appreciated that fractional bidding groups from different rounds may comprise the same set of fractional bidders, but each group may have a different number of shares (e.g., at least one user will have a different number of shares in the latest bidding round as compared to a previous bidding round).

In response to defining the new fractional bidding group, systems dynamically update a user interface displayed on a computing screen associated with the computing system by updating the textual and graphical information with the new fractional bidding group and total fractional bidding amount corresponding to the new fractional bidding group.

In some instances, the new fractional bidding group is defined such that the plurality of fractional bidding entities in the new bidding round (i) comprises a new fractional bidding entity not included in the fractional bidding group from the current bidding round and (ii) excludes a fractional bidding entity previously included in the fractional bidding group from the current bidding round.

Additionally, or alternatively, the new fractional bidding group associated with the new bidding round is defined such that the plurality of fractional bid entities comprises one or more new fractional bidding entities in addition to the fractional bidding entities included in the fractional bidding group associated with the current bidding round.

For each new bidding round, a new asking price is defined. As described herein, there are different ways in which to determine the new asking price. In some instances, the new asking price is based on a user input received to increase the previous asking price by a specific increment. In some instances, the previous asking price is increased at pre-determined increments through each of the rounds unless a jump bid is entered by the clerk or administrator. In other instances, the new asking price for the contested resource in the new bidding round at least meets the total fractional bidding amount from the current bidding round.

For example, in some alternative embodiments, if the asking price for a particular bidding round was $100,000, but a full bidder submitted a full bid of $120,000 or a fractional bidding group collectively reached a total fractional bid of $120,000, the new bidding round would start at least at $120,000 if not higher than the highest accepted bid, even though the asking price for that round was only $100,000. In some instances, a bid that is received that is higher than a current asking price is adjusted down to the asking price, but then is automatically placed as a new bid in the next bidding round. In some instances, the new asking price for the contested resource in the new bidding round at least meets the full bidding amount from the current bidding round.

In some instances, there is a pre-bidding stage to the auction in which bidders are enabled to place one or more pre-bids during the predetermined pre-bidding timeframe. For example, prior to initiating a first bidding round, systems identify at least one initial fractional bidding group comprising one or more fractional bidding entities associated with one or more pre-bid amounts and at least one initial full bidding entity associated with an absentee bid. These bids can influence the starting asking price in the first bidding round, as well as be placed as bids during the first bidding round automatically or manually via user input at the various user interfaces.

As described herein, some embodiments are directed to methods for managing an auction for contested resources between full bidding entities and fractional bidding entities that are enabled to place bids on the contested resources. For example, methods are provided for identifying a contested resource and identifying a plurality of bidding entities. The plurality of bidding entities can be identified as full bidding entities that are registered to individually bid on the contested resource for a full ownership of the contested resource, fractional bidding entities that are registered to bid on the contested resource for a fractional ownership of the contested resource as part of a fractional bidding group that collectively has full ownership of the contested resource, or a mix of fractional and full bidding entities.

After identifying the contested resource (e.g., auction item) and the bidding entities (e.g., bidders online) who will be bidding on the contested resource, systems are configured for initiating a current bidding round corresponding to a current asking price for the contested resource. After initiating the current bidding round, systems identify a fractional bidding group comprising a plurality of the fractional bidding entities and a total fractional bidding amount associated with the fractional bidding group relative to the current asking price. The fractional bidding group is dynamically determined for the current bidding round based on (i) a fractional bidding amount for each fractional bidding entity of the fractional bidding group, (ii) a pre-determined minimum bid amount, and (iii) an amount of remaining available Shares of the contested resource.

Systems also identify a full bidding amount received from at least one full bidding entity and determine whether the total fractional bidding amount or the full bidding amount meets or exceeds the current asking price associated with the contested resource in the current bidding round.

In response to determining that the total fractional bidding amount meets or exceeds the current asking price for the contested resource in the current bidding round, systems terminate the current bidding round and initiate a new bidding round corresponding to a new asking price for the contested resource that is higher than the current asking price. Alternatively, in response to determining that the full bidding amount received from the at least one full bidding entity meets or exceeds the current asking price for the contested resource, systems terminate the current bidding round and initiate a new bidding round corresponding to a new asking price for the contested resource that is higher than the current asking price.

In some methods, each bidding entity in the plurality of bidding entities is verified based on applying a different verification process to different entities based on a maximum investment amount requested by the different entities. For example, in some instances, each bidding entity in the plurality of bidding entities is associated with a different maximum investment amount and the fractional bidding group is dynamically determined to include a particular fractional bidding entity based on determining that a pre-determined minimum bidding amount does not exceed the maximum investment corresponding to the particular fractional bidding entity. It should be appreciated that the different maximum bidding amount can be adjusted for fees incurred during a particular bidding round.

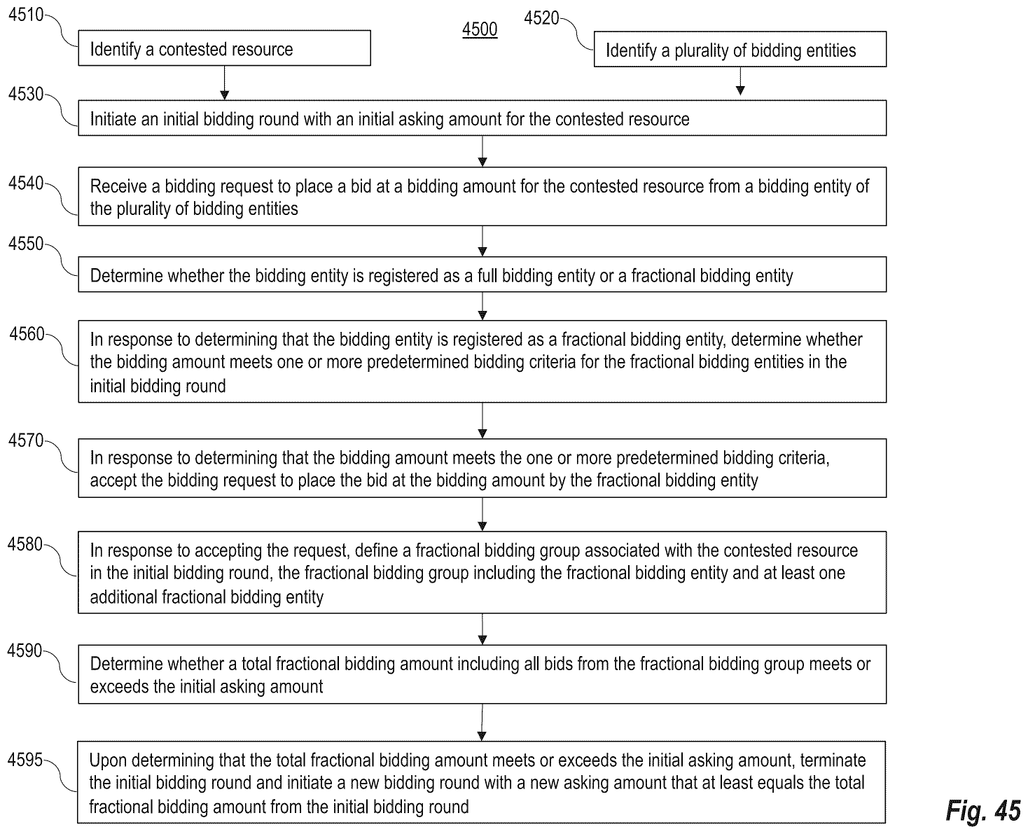

Attention will now be directed to FIG. 45, which illustrates one embodiment of a flow diagram having a plurality of acts (act 4510, act 4520, act 4530, act 4540, act 4550, act 4560, act 4570, act 4580, act 4590, and act 4595) associated with a method for processing bid requests in auctions involving both fractional ownership bidders and whole ownership bidders (also referred to herein as full bidders and 100% bidders).

A first illustrated act is provided for identifying a contested resource (act 4510). Systems also identify a plurality of bidding entities comprising: one or more full bidding entities that are registered to individually bid on the contested resource for a full ownership of the contested resource, and a plurality of fractional bidding entities that are registered to bid on the contested resource for a fractional ownership of the contested resource as part of a fractional bidding group that collectively bids for full ownership of the contested resource (act 4520).

After identifying the relevant entities and resources for the auction, systems initiate an initial bidding round with an initial asking price for the contested resource (act 4530). Systems are configured to monitor the receipt of different bidding requests from different bidders during each bidding round of the auction. For example, systems receive a bidding request to place a bid at a bidding amount for the contested resource from a bidding entity of the plurality of bidding entities (act 4540) and determine whether the bidding entity is registered as a full bidding entity or a fractional bidding entity (act 4550).

In response to determining that the bidding entity is registered as a fractional bidding entity, systems determine whether the bidding amount meets one or more predetermined bidding criteria for the fractional bidding entities in the initial bidding round (act 4560). In response to determining that the bidding amount meets the one or more predetermined bidding criteria, systems accept the bidding request to place the bid at the bidding amount by the fractional bidding entity (act 4570).

In response to accepting the request, systems define a fractional bidding group associated with the contested resource in the initial bidding round, the fractional bidding group including the fractional bidding entity and at least one additional fractional bidding entity (act 4580) and determine whether a total fractional bidding amount including all bids from the fractional bidding group meets or exceeds the initial asking price (act 4590).

Finally, upon determining that the total fractional bidding amount meets or exceeds the initial asking price, systems terminate the initial bidding round and initiate a new bidding round with a new asking price that at least equals the total fractional bidding amount from the initial bidding round (act 4595).

Alternatively, in response to determining that the bidding entity is a full bidding entity, determine whether the certain bidding amount meets one or more predetermined bidding criteria for full bidding entities in the initial bidding round. Subsequently, in response to determining that the certain bidding amount meets one or more predetermined bidding criteria for full bidding entities in the initial bidding round, accept the bidding request from the full bidding entity.

In some instances, each bidding entity of the plurality of bidding entities is associated with an individual maximum investment amount. Additionally, each bidding entity of the plurality of bidding entities is a verified bidding entity based on applying a different verification process for different individual maximum investment amounts.

As described in more detail above, the initial asking price is based, in some instances, on a fractional bidding group pre-bid amount associated with a plurality of fractional pre-bid requests or an absentee bid amount associated with a full pre-bid request. In some instances, the auctioneer will determine the starting price and can use the information learned from pre-bidding to start the initial asking price at a value that is determined to be reasonable by the auctioneer based on experience and the pre-bidding information.

In some instances, the one or more predetermined bidding criteria for fractional bidding entities in the initial bidding round comprises one or more of the following: a minimum fractional bidding amount, a verification that the bidding amount does not exceed a maximum investment amount corresponding to the bidding entity, an auction imposed fractional maximum ownership, or a determination that the certain bidding amount does not exceed a remaining available balance of the initial asking price.

Systems are also configured to determine whether the certain bidding amount exceeds the remaining available balance of the initial asking price. In response to determining that the certain bidding amount exceeds the remaining available balance of the initial asking price, automatically adjust the certain bidding amount to equal the remaining available balance of the initial asking price.

The system monitors the bidding requests in order to determine whether to accept or reject the bidding requests. For example, systems determine whether the bidding request meets one or more user-defined bidding criteria and determine that the bidding request does not meet the one or more user-defined bidding criteria. In response to determining that the bidding request does not meet the one or more user-defined bidding criteria, systems refrain from transmitting the bidding request to the computing system. Where the system has predetermined input field criteria, the system is configured to prevent a user from entering invalid data into the input field (e.g., preventing a user from submitting a numerical value in a text input field or vice versa).

It should be appreciated that the bidding criteria can be automatically set by the computing system based on characteristics of the auctions or manually set by one or more of the different types of users. For example, one or more user-defined bidding criteria includes: a minimum ratio of ownership of the contested resource based on the bidding amount associated with the bidding request relative to the initial asking price associated with the initial bidding round.

In some instances, systems determine whether a total bidding amount associated with an accepted bidding request from a full bidding entity or a total fractional bidding amount associated with a plurality of accepted fractional bidding requests from a plurality of fractional bidding entities meets or exceeds the initial asking price and reject the bidding request from the bidding entity in the initial bidding round. If the bidding entity is a fractional bidding entity, systems refrain from including the bidding entity in the fractional bidding group associated with the initial bidding round.

In other instances, systems accept new bidding requests until the initial asking price is met. In response to detecting that the initial asking price is met, the systems close the initial bidding round and freeze the fractional bidding group associated with the closed initial bidding round.

In response to closing the initial bidding round, systems initiate a subsequent bidding round with a new and higher asking price for the contested resource. As systems monitor real-time updates during the auction, systems are able to detect whether the auction has received one or more new bidding requests from fractional bidding entities in the subsequent bidding round. Systems then determine whether the one or more new bidding requests meet one or more predetermined criteria for fractional bidding entities in the subsequent bidding round and define a new fractional bidding group including fractional bidding entities whose bidding requests met the one or more predetermined criteria for fractional bidding entities in the subsequent bidding round.

In subsequent bidding rounds, in some instances, the new and higher asking price in the subsequent bidding round is increased from the initial asking price at a predetermined increment.

Systems also determine what type of bidding request is being made. For example, in some instances, the bidding request in the initial bidding round is an automatic bidding request, such that upon detecting the subsequent bidding round has been initiated, the computing system is caused to automatically transmit the automatic bidding request for the contested resource in the subsequent bidding round.

Based on detecting different real-time updates in the auction, systems are configured to generate and cause a user interface to be displayed on a computing screen associated with the computing system. The user interface is configured for displaying textual and graphical information representing the contested resource, the bidding round, the bidding amount, the fractional bidding group, and the total fractional bidding amount relative to the bidding amount.

Such methods associated with FIG. 45 are also related to methods for allocating computing resources between different types of computing nodes. For example, computing systems, like computing system 110, identify a limited resource and identify a plurality of node entities comprising singular computing nodes and distributed computing nodes requesting allocation of the limited resource, each node entity of the plurality of node entities being associated with a particular reciprocal resource amount.

In order to allocate the limited resources across the different node entities, systems initiate an initial allocation round with an initial reciprocal resource amount for the contested resource. Systems will receive different allocation requests from different computing nodes. For example, systems may receive an allocation request to allocate at least a portion of the limited resource in exchange for a certain reciprocal resource amount from a node entity of the plurality of node entities. Systems will then determine whether the node entity is a singular node entity or a distributed node entity.

In response to determining that the node entity is the distributed node entity, systems determine whether the certain reciprocal resource amount meets one or more predetermined criteria for distributed node entities in the initial allocation round. In response to determining that the certain reciprocal resource amount meets the one or more predetermined criteria, systems accept the request to allocate at least a portion of the limited resource at the certain reciprocal resource amount by the distributed node entity. Additionally, in response to accepting the allocation request, systems define a distributed node entity group associated with the limited resource in the initial allocation round, the distributed node entity group including the node entity. The distributed node entity can be dynamically redefined during an allocation round based on receiving new allocation requests from additional distributed node entities. It should also be appreciated that new and different distributed node groups can be defined for subsequent allocation rounds.

Alternatively, in response to determining that the node entity is a singular node entity, systems determine whether the certain reciprocal resource amount meets one or more predetermined criteria for singular node entities in the initial allocation round. In response to determining that the certain reciprocal resource amount meets one or more predetermined criteria for singular node entities in the initial bidding round, systems accept the allocation request from the singular node entity.

There are many different criteria that can be set for analyzing whether or not to accept a particular allocation request. For example, in some instances, the one or more predetermined criteria for distributed node entities in the initial allocation round comprises one or more of a following: a minimum individual reciprocal resource amount, a verification that the certain reciprocal resource amount does not exceed a maximum reciprocal resource amount corresponding to the node entity, or a determination that the certain reciprocal resource amount does not exceed a remaining availability of the limited resource during the initial bidding round. Additionally, or alternatively, system-imposed limits may apply.

Systems also determine whether a total reciprocal resource amount associated with an accepted allocation request from a singular node entity or a total distributed node reciprocal resource amount associated with a plurality of accepted distribute node requests from a plurality of distributed node entities meets or exceeds the initial reciprocal resource amount. If the systems reject the allocation request from the node entity in the initial allocation round, the systems will refrain from including the node entity in the distributed node entity group associated with the initial allocation round.

After a winning allocation request is identified, systems are configured to advance the allocation round to a new allocation round. For example, in response to closing an initial allocation round, systems initiate a subsequent allocation round with a new and higher reciprocal resource amount for the limited resource and receive one or more new allocation requests from distributed node entities in the subsequent allocation round. Systems then determine whether the one or more new allocation requests meet one or more predetermined criteria for distributed node entities in the subsequent allocation round and define a new distributed node entity group including distributed node entities whose allocation requests met the one or more predetermined criteria for distributed node entities in the subsequent allocation round.

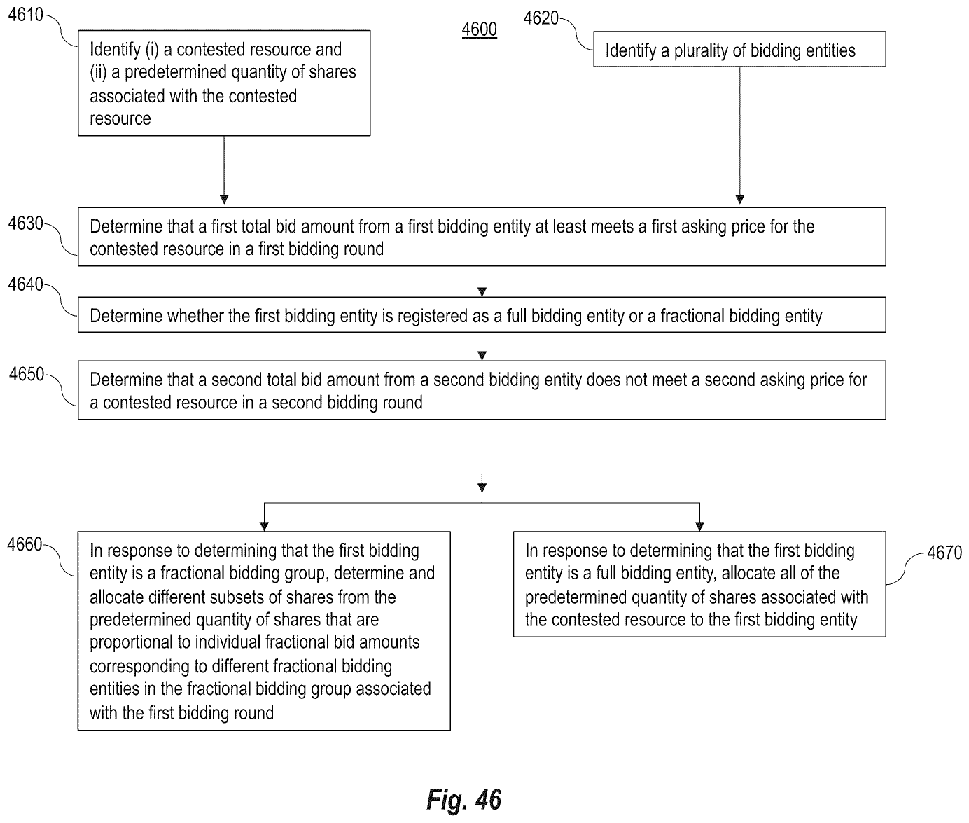

Attention will now be directed to FIG. 46, which illustrates one embodiment of a flow diagram having a plurality of acts associated with a method for managing post-auction processes and distribution of ownership interests associated with fractional ownership bidders. A first illustrated act is provided for identifying (i) a contested resource and (ii) a predetermined quantity of shares associated with the contested resource (act 4610) and a second illustrated act is provided for identifying a plurality of bidding entities in the auction bidding for one or more shares of the contested resource, the plurality of bidding entities (act 4620). The plurality of entities include one or more full bidding entities registered to bid on the contested resource for a full ownership of the contested resource and one or more fractional bidding groups, wherein each fractional bidding group comprises a plurality of fractional bidding entities that are registered to bid on the contested resource for a fractional ownership of the contested resource as part of a fractional bidding group that collectively bids for full ownership of the contested resource.

Systems determine that a first total bid amount from a first bidding entity at least meets a first asking price for the contested resource in a first bidding round (act 4630) and subsequently determine that a second total bid amount from a second bidding entity does not meet a second asking price for a contested resource in a second bidding round (act 4640). Systems determine whether the first bidding entity is a full bidding entity or a fractional bidding group (act 4650). The systems are also able to determine that the first bidding entity is a winning bidding entity.

In response to determining that the first bidding entity is a fractional bidding group and the winning bidding entity, systems determine and allocate different subsets of shares from the predetermined quantity of shares that are proportional to individual fractional bid amounts corresponding to different fractional bidding entities in the fractional bidding group associated with the first bidding round (act 4660).

Alternatively, in response to determining that the first bidding entity is a full bidding entity, systems allocate all of the predetermined quantity of shares associated with the contested resource to the first bidding entity (act 4670). In some embodiments, the contested resource is awarded to the full bidding entity without reference to or representation by shares, wherein the predetermined quantity of shares for the contested resource is only associated with fractional bidders. It should be appreciated that while the aforementioned acts refer to the allocation of shares (e.g., equity shares) after an auction has ended, the method is also applicable to assigning percentages or fractional interests to a winning fractional group at the end of a bidding round of an on-going auction that has not ended yet.

In some instances, systems determine that a third total bid amount from a third bidding entity in the first bidding round meets the first asking price for the contested resource but is received subsequent to the first total bid amount from the first bidding entity and reject the third total bid amount from the third bidding entity based on the third total bid amount being received after the first total bid amount.

In some instances, the computing system is configured to adjust a bid based on different factors in the auction. For example, based on a determined subset of shares for a particular fractional bidding entity, systems adjust an individual fractional bid amount corresponding to the particular fractional bidding entity to match a subset amount associated with the subset of shares. Alternatively, rounding is completed by the system based upon the dollar amount remaining at an asking price, instead of on the number of shares.

In response to adjusting the corresponding individual fractional bid amount, systems are provided for generating and updating a user interface that displays a summary window on a computing screen associated with the particular fractional bidding entity, the summary window comprising textual and graphical information about the subset of shares of the contested resource, the adjusted individual fractional bid amount relative to the first asking price, and any fees incurred.

In response to allocating different amounts of shares to different fractional bidding entities, systems trigger a request for payment from each different fractional bidding entity and receive a plurality of payment confirmations based on the request for payment from each different fractional bidding entities. Systems are also able to determine that all of the payment requests have been confirmed and will release the allocated shares of the contested resource to a respective fractional bidding entity based on the different subsets of shares that were allocated to different fractional bidding entities.

During the first bidding round, systems are able to identify one or more fractional bidding entities that attempted to place bids for the contested resource but whose bids were not included in the fractional group and maintaining a queue of alternate fractional bidding entities associated with the first bidding round.

In response to allocating different amounts of shares to different fractional bidding entities, systems trigger a request for payment from each different fractional bidding entity. The systems monitor for user inputs and payment confirmations from the different winning bidders. For example, systems receive a plurality of payment confirmations based on the requests for payment from each different fractional bidding entities and determine that at least one payment request for a certain fractional bidding entity has been denied.

In some embodiments, systems also trigger a request for payment from an alternate fractional bidding entity in the queue of alternate fractional bidding entities and determine that all outstanding payment requests, including the request for payment from the alternate fractional bidding entity, have been confirmed.

In response to confirming the request for payment from the alternate fractional bidding entity, systems redefine the fractional group to exclude the certain fractional bidding entity and include the alternate fractional bidding entity for re-allocating different amounts of shares associated with the contested resource to different fractional bidding entities included in the redefined fractional group. Finally, systems are able to release the re-allocated shares of the contested resource to a respective fractional bidding entity based on the different subsets of shares that were allocated to the different fractional bidding entities of the redefined fractional group.

As described above, in some instances, each bidding entity of the plurality of bidding entities is associated with an individual maximum investment amount. Each bidding entity of the plurality of bidding entities is a verified bidding entity based on applying a different verification process for different individual maximum investment amounts. For example, a first bidding entity of the plurality of bidding entities is associated with a first individual maximum investment amount, wherein the computing system applies a first verification process comprising requesting self-reported investor accreditation.

Additionally, a second bidding entity of the plurality of bidding entities is associated with a second individual maximum investment amount that is higher than the first individual maximum investment amount, wherein the computing system applies a second verification process comprising requesting authorization to run a credit check on the second bidding entity. Furthermore, a third bidding entity of the plurality of bidding entities is associated with a third individual maximum investment amount that is higher than the second individual maximum investment amount, wherein the computing system applies a third verification process comprising requesting a validation letter for the third bidding entity.

During the first bidding round, systems are provided for generating and dynamically updating a user interface displayed on a computing screen included in the computing system associated with a particular fractional bidding entity, the user interface displaying textual and graphical information representing a current individual fractional bid amount placed by the particular fractional bidding entity relative to (i) a sum of additional individual fractional bid amounts placed by additional fractional bidding entities and (ii) the first asking price, such that when new bids are placed by the additional fractional bidding entities, the textual and graphical information is updated to reflect changes in the sum of additional individual fractional bid amounts relative to the current individual fractional bid amount.

In some instances, entry to the fractional group is prioritized by timestamps associated with individual fractional bids placed by the different fractional bidding entities, such that bids with earlier timestamps are more likely to be included in the fractional group than bids with later timestamps. Accordingly, time priority primarily controls which bids are accepted in the fractional group. However, in some alternative embodiments, the system is (additionally or alternatively) configured to control entry to the fractional group based on prioritization of bid amounts based on valuation associated with individual fractional bids placed by the different fractional bidding entities, such that bids with larger bid amounts are more likely to be included in the fractional group than bids with smaller bid amounts.

Like in previously described methods, methods related to FIG. 46 are also related to solutions for allocation of computing resources across different computing nodes. For example, methods are provided for identifying a pool of node entities in the computing system requesting allocation of a contested resource associated with an initial reciprocal resource amount, including singular node entities and distributed node entities. Systems determine that a first total reciprocal resource amount corresponding to a first node entity at least meets the initial reciprocal resource amount for the contested resource in a first allocation round and determine that a second total reciprocal resource amount corresponding to a second node entity does not meet a subsequent reciprocal resource amount for the contested resource in a second allocation round.

Additionally, systems determine whether the first node entity is a singular node entity or a distributed node group comprising a plurality of distributed node entities. In response to determining that the bidding entity is a distributed node group, systems are configured for allocating different portions of the contested resource to different distributed node entities included in the distributed node group. Alternatively, in response to determining that the bidding entity is a singular node entity, systems are configured for allocating all of the contested resource to the singular node entity.

It should be appreciated that the computing resources being allocated may comprise any type of computing resource. For example, in some instances, the contested or limited resource is a certain amount of hardware storage in the computing system. Similarly, the different reciprocal resource amounts can comprise different computing resources. For example, in some instances, the first total reciprocal resource amount comprises a plurality of processing cycles for shared cloud computing.

For each distributed node entity in the distributed node group in the first allocation round, determine a subset of processing cycles that is proportional to an individual reciprocal resource amount corresponding to each distributed node entity. During the first allocation round, systems are provided for generating and dynamically updating a user interface displayed on a computing screen included in the computing system associated with a particular distributed node entity. The user interface is configured to display: textual and graphical information representing a current individual distributed node reciprocal resource amount placed by the particular distributed node entity relative to (i) a sum of additional individual reciprocal resource amounts placed by additional distributed node entities and (ii) the first total reciprocal resource amount associated with the contested resource, such that when new reciprocal resource amounts are transmitted by the additional distributed node entities, the textual and graphical information is updated to reflect changes in the sum of additional individual reciprocal resource amounts relative to the current individual distributed node reciprocal resource amount.

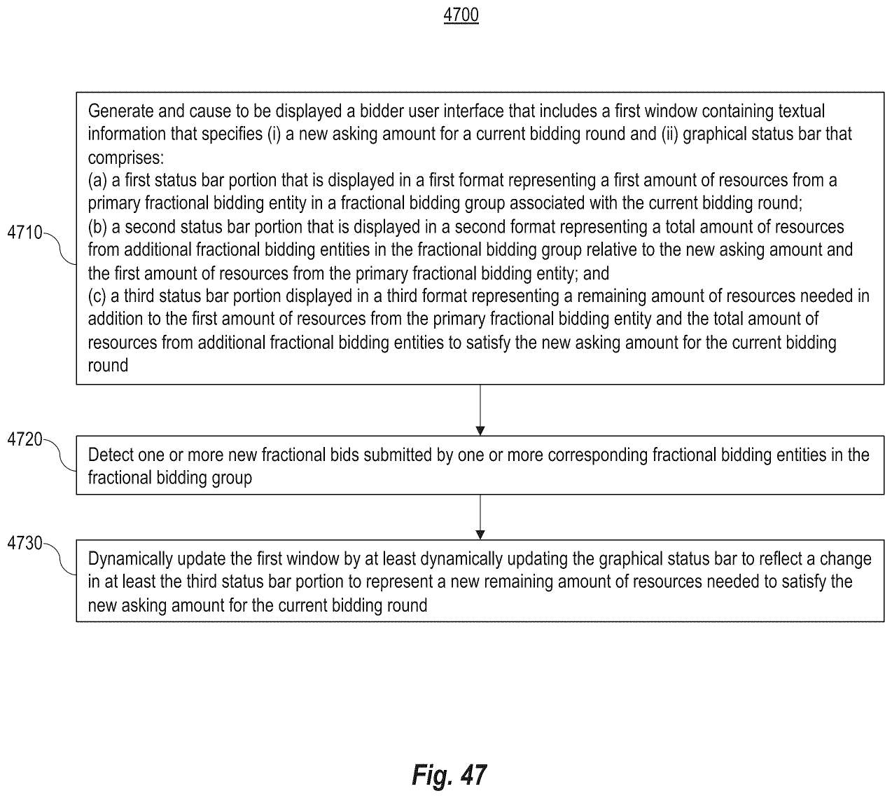

Attention will now be directed to FIGS. 47-49, which illustrate various example embodiments of flow diagrams having a plurality of acts associated with a method for generating and modifying user interfaces for facilitating management of auctions involving fractional ownership bidders and whole ownership bidders. Attention will first be directed to FIG. 47, which illustrates an example flow diagram having a plurality of acts (acts 4710, act 4720, and act 4730) associated with methods implemented by computing system 110 for generating and updating user interfaces for facilitating an auction for contested resources and for enabling fractional bidding entities registered to place fractional bids for fractional ownership of the contested resources and full bidding entities registered to place full bids for full ownership of the contested resources.

A first illustrated act is provided for generating and causing to be displayed a bidder user interface that includes a first window containing textual information that specifies (i) a new asking price for a current bidding round and (ii) graphical status bar (act 4710).

The graphical status bar comprises (a) a first status bar portion that is displayed in a first format representing a first amount of resources from a primary fractional bidding entity in a fractional bidding group associated with the current bidding round; (b) a second status bar portion that is displayed in a second format representing a total amount of resources from additional fractional bidding entities in the fractional bidding group relative to the new asking price and the first amount of resources from the primary fractional bidding entity; and (c) a third status bar portion displayed in a third format representing a remaining amount of resources needed in addition to the first amount of resources from the primary fractional bidding entity and the total amount of resources from additional fractional bidding entities to satisfy the new asking price for the current bidding round.

Systems detect one or more new fractional bids submitted by one or more corresponding fractional bidding entities in the fractional bidding group (act 4720) and dynamically update the first window by at least dynamically updating the graphical status bar to reflect a change in at least the third status bar portion to represent a new remaining amount of resources needed to satisfy the new asking price for the current bidding round (act 4730). In some instances, systems dynamically update the graphical status bar to additionally reflect a change in at least an additional status bar portion (e.g., first and/or second status bar portion).

In some instances, systems generate and cause to be displayed a second window comprising a first selectable object that is selectable to cause the computing system to display a third window configured to receive user input from the primary fractional bidding entity to edit a previously placed bid in the current bidding round and dynamically update the first window by at least dynamically updating the graphical status bar to reflect a change in the first status bar portion to represent the new, edited bid placed by the primary fractional bidding entity.

Additionally, in some instances, systems generate and cause to be displayed a fourth window comprising textual information representing a total amount of resources bid by the primary fractional bidding entity including the new amount of resources bid by the primary fractional bidding and any auction fees associated with the new amount of resources bid by the primary fractional bidding entity.

Systems also display a fifth window comprising textual information representing a previously completed bid amount and a second graphical status bar comprising a length representing the previously completed bid amount, wherein a first portion of the second graphical status bar displayed in the first format represents a total amount of resources bid by additional fractional bidding users and a second portion of the second graphical status bar displayed in the second format represents a previous amount of resources bid by the primary fractional bidding user relative to the total amount of resources bid by the additional fractional bidding users such that the first portion and second portion span the length of the second graphical status bar.

Other information is displayed in a sixth window comprising one or more previously completed bidding rounds, each bidding round comprising textual information representing a previously completed total bid amount and a type of bidding user as either fractional bidding users or a full bidding user associated with the previously competed total bid amount, and a previous amount bid by the primary fractional bidding user included in the previously completed total bid amount.

Some user interfaces display a seventh window comprising a live video feed of an environment in which the auction is currently taking place. Additionally, or alternatively, systems display an eighth window comprising graphical and textual information describing an asset corresponding to the current bidding round, including an estimated valuation of the asset.

The user interfaces are configured to both display information to users and receive information from users. For example, systems receive user input at the graphical user interface comprising (i) an auto-bid amount to be bid automatically during each bidding round and (ii) a specified bidding criteria. In some instances, the specified bidding criteria is a maximum asking price of the asset associated with a particular bidding round. The specified bidding criteria can also be a minimum percentage of ownership associated with the current bidding round based on the auto-bid amount relative to a total amount of resources bid by all other fractional bidding users in the current bidding round.

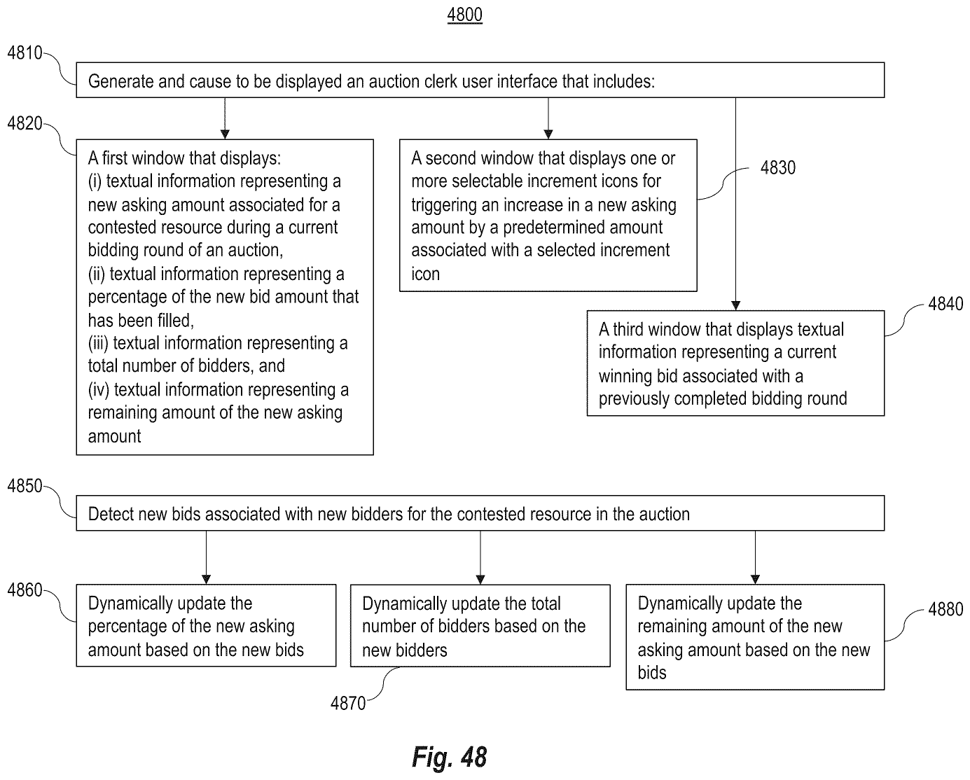

Attention will now be directed to FIG. 48, which illustrates an example flow diagram having a plurality of acts (acts 4810, act 4820, act 4830, act 4840, act 4850, act 4860, act 4870, and act 4880) associated with methods implemented by computing system 110 for generating and updating user interfaces for facilitating an auction for contested resources and for enabling fractional bidding entities registered to place fractional bids for fractional ownership of the contested resources and full bidding entities registered to place full bids for full ownership of the contested resources.

A first illustrated act is provided for generating and causing to be displayed an auction clerk user interface that includes various windows (act 4810). A first window that displays: (i) textual information representing a new asking price associated with a contested resource during a current bidding round of an auction, (ii) textual information representing a percentage of the new bid amount that has been filled, (iii) textual information representing a total number of bidders, and (iv) textual information representing a remaining amount of the new asking price (act 4820).

A second window displays one or more selectable increment icons for triggering an increase in a new asking price by a predetermined amount associated with a selected increment icon (act 4830) and a third window displays textual information representing a current winning bid associated with a previously completed bidding round (act 4840). Systems detect new bids associated with new bidders for the contested resource in the auction (act 4850) and dynamically update various components of the user interface.

For example, systems dynamically update the percentage of the new asking price based on the new bids (act 4860), dynamically update the total number of bidders based on the new bidders (act 4870), and dynamically update the remaining amount of the new asking price based on the new bids (act 4880).

Systems are also provided for detecting an end of a bidding round and receiving user input selecting a particular increment icon. Systems then dynamically update the first window by augmenting the previous bid amount by the selected amount associated with the selected increment icon. Systems also dynamically update a bidder user interface by updating any windows comprising textual or graphical information corresponding to the new asking bid price based on augmenting the previous bid amount by the selected amount associated with the selected increment icon. In some instances, the fair warning/last call will stop being displayed if the bidding round is incremented to a new asking price.

The user interfaces are also configured to display various notification banners. For example, in some instances, user interfaces display a banner selection icon window comprising: a fair warning selectable icon that, when selected, triggers a fair warning notification banner to be displayed on a bidder user interface, a last call selectable icon that, when selected, triggers a last call notification banner to be displayed on the bidder user interface, a sold selectable icon that, when selected, triggers a sold notification banner to be displayed on a bidder user interface, and a pass selectable icon that, when selected, triggers a pass notification banner to be displayed on a bidder user interface.

Systems are configured to update different windows based on different formats and auction characteristics. For example, systems update the third window being displayed in a different format based on a type of bidder associated with the current winning bid by: detecting the type of bidder as fractional bidders and updating the third window in a format corresponding to fractional bidders. Updating the third window in the format correspond to fractional bidders includes formatting the third window includes in one or more of the following: a different color, a different font, a different font size, a different texture, an animation, or any combination thereof.

User interfaces are also updated when a new bidding round is initiated. For example, systems display a selectable starting bid icon that, when selected, allows a user to update a starting bid associated with a current asset auction. Systems receive user input for a new starting bid and receive user input for selecting the starting bid icon. Subsequently, systems dynamically update the starting bid for the current asset auction to reflect the new starting bid.

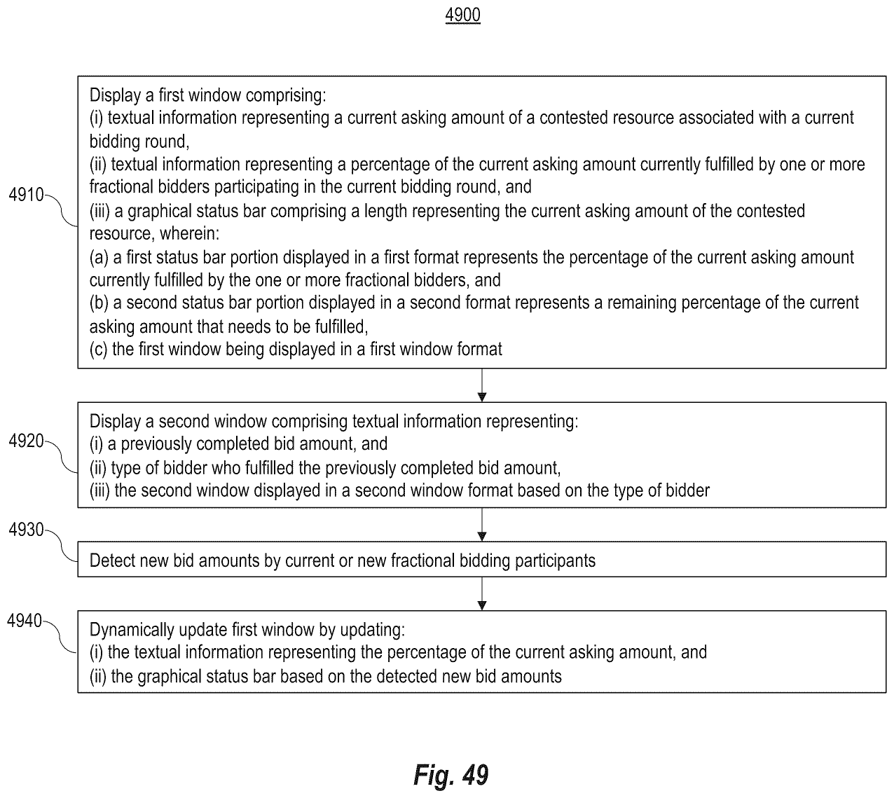

Attention will first now be directed to FIG. 49, which illustrates an example flow diagram having a plurality of acts (act 4910, act 4920, act 4930, and act 4940) associated with methods implemented by computing system 110 for generating and updating user interfaces for enabling participation in an auction of contested resources by fractional bidding participants registered to place fractional bids for fractional ownership of the contested resources and full bidding participants registered to place full bids for full ownership of the contested resources.

A first illustrated act is provided to display a first window comprising: (i) textual information representing a current asking price of a contested resource associated with a current bidding round, (ii) textual information representing a percentage of the current asking price currently fulfilled by one or more fractional bidders participating in the current bidding round, and (iii) a graphical status bar comprising a length representing the current asking price of the contested resource (act 4910). The graphical status bar comprises different portions: for example, (a) a first status bar portion displayed in a first format represents the percentage of the current asking price currently fulfilled by the one or more fractional bidders, and (b) a second status bar portion displayed in a second format represents a remaining percentage of the current asking price that needs to be fulfilled, (c) the first window being displayed in a first window format.

Systems also display a second window comprising textual information representing: (i) a previously completed bid amount, and (ii) type of bidder who fulfilled the previously completed bid amount, (iii) the second window displayed in a second window format based on the type of bidder (act 4920).

Systems detect new bid amounts by current or new fractional bidding participants (act 4930) and dynamically update first window (act 4940) by updating: (i) the textual information representing the percentage of the current asking price, and (ii) the graphical status bar based on the detected new bid amounts.

In some instances, computing systems display a third window comprising one or more sub-windows for each previously completed bidding round, each sub-window comprising: textual information representing a previously completed bidding amount, and a display icon comprising textual information representing a type of bidder associated with the previously completed bidding amount displayed in a different display icon format based on the type of bidder. User interfaces are also configured to display a fourth window comprising textual and graphical information representing pre-auction bidding activity including one or more absentee bids, among other windows described herein.

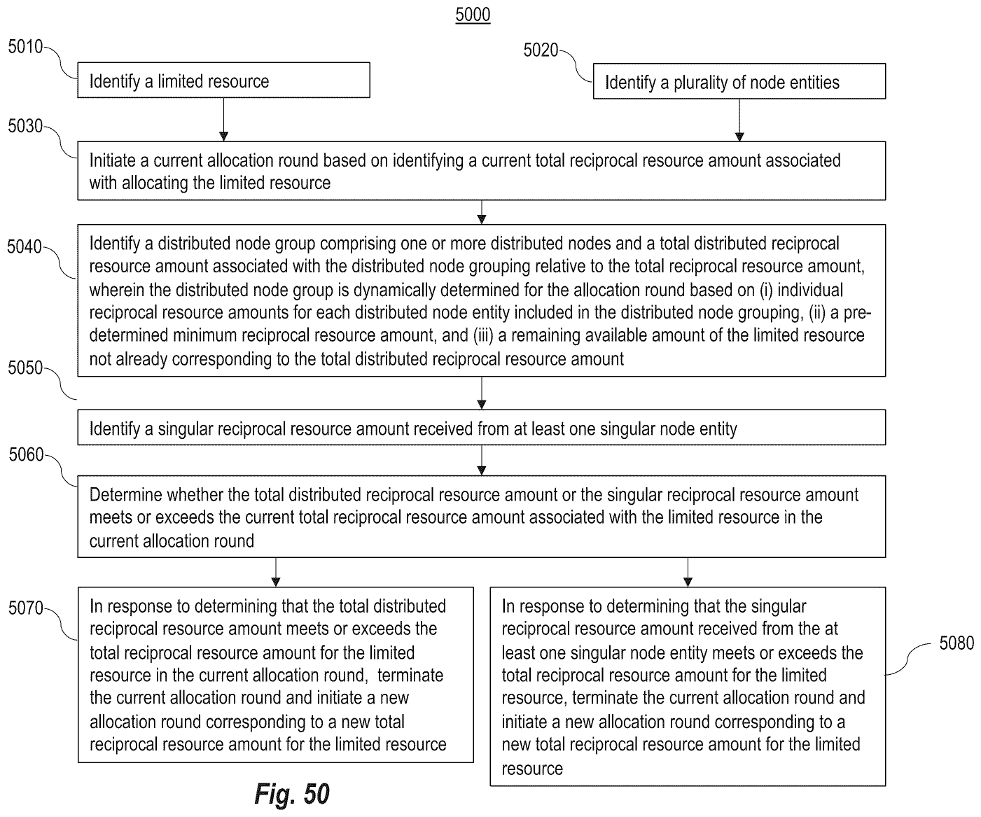

Attention will now be directed FIG. 50, which illustrates an example embodiment corresponding to the flow diagram of FIG. 44, having a plurality of acts (acts 5010, act 5020, act 5030, act 5040, act 5050, act 5060, act 5070, and act 5080) associated with a method that can be implemented by computing system 110 for managing allocation of limited computing resources between singular node entities and distributed node entities.

A first illustrated act is provided for identifying a limited resource (act 5010). Limited resources include different computing resources such as hardware storage capacity, processing capacity (e.g., processing cycles), network bandwidth, instantiations of different machine learning models, or other computing resources. These computing resources are limited and are allocated across different computing nodes. Accordingly, systems identify a plurality of node entities comprising singular computing nodes and distributed computing nodes requesting allocation of the limited resource (act 5020). Each node entity of the plurality of node entities being associated with a particular reciprocal resource amount.

In order to allocate the limited resources to the different nodes requesting the limited resources, the computing system may, in some instances, conduct allocation processes based on an auction-type allocation process. For example, systems can initiate a current allocation round based on identifying a current total reciprocal resource amount associated with allocating the limited resource (act 5030).

After initiating the allocation round, systems identify a distributed node group comprising one or more distributed nodes and a total distributed reciprocal resource amount associated with the distributed node grouping relative to the total reciprocal resource amount (act 5040). The distributed node group is dynamically determined for the allocation round based on (i) individual reciprocal resource amounts for each distributed node entity included in the distributed node grouping, (ii) a pre-determined minimum reciprocal resource amount, and (iii) a remaining available amount of the limited resource not already corresponding to the total distributed reciprocal resource amount.

Systems also identify a singular reciprocal resource amount received from at least one singular node entity (act 5050) and determine whether the total distributed reciprocal resource amount or the singular reciprocal resource amount meets or exceeds the current total reciprocal resource amount associated with the limited resource in the current allocation round (act 5060).

In response to determining that the total distributed reciprocal resource amount meets or exceeds the total reciprocal resource amount for the limited resource in the current allocation round, systems terminate the current allocation round and initiate a new allocation round corresponding to a new total reciprocal resource amount for the limited resource (act 5070). Alternatively, in response to determining that the singular reciprocal resource amount received from the at least one singular node entity meets or exceeds the total reciprocal resource amount for the limited resource, systems terminate the current allocation round and initiate a new allocation round corresponding to a new total reciprocal resource amount for the limited resource (act 5080). In this manner, systems are able to allocate the limited resources based on a “highest bidding” computing node, or set of distributed computing nodes.

To facilitate transparency in the computing processes for users, systems generate and cause to be displayed a user interface on a computing screen associated with the computing system, the user interface displaying textual and graphical information representing (i) the limited resource, (ii) the current allocation round, (iii) the total reciprocal resource amount, (iv) the distributed node group, and (v) the total distributed reciprocal resource amount relative to the reciprocal resource amount associated with the current allocation round.

During the allocation round, systems also identify one or more new distributed node entities and one or more new distributed reciprocal resource amounts associated with the one or more new distributed node entities. In response to identifying one or more new distributed node entities, systems dynamically update the distributed node group with one or more new distributed node entities and dynamically update the total distributed reciprocal resource amount based on the one or more new distributed reciprocal resources amounts associated with the one or more new distributed node entities.

In response to dynamically updating the distributed node grouping and the total distributed reciprocal resource amount, systems also dynamically update a user interface displayed on a computing screen associated with the computing system by updating the textual and graphical information with the updated distributed node grouping and the updated total distributed reciprocal resource amount relative to the total reciprocal resource amount associated with the allocation round.

After initiating the new allocation round, systems define a new distributed node group based on a plurality of distributed node entities and corresponding distributed reciprocal resource amounts received in the new allocation round.

All of the forgoing methods described in FIGS. 44-50 can be implemented using combinations of the systems, system components, interfaces and windows described in FIGS. 1-43.

It should be appreciated that are at least three different modes of operation for the described Auction System. In one mode, the auction is auctioneer led as a full English auction within the Auction System in operational control of all bids. This allows for online fractional bidders, online full bidders, in-room full bidders, and phone full bidders (e.g., via CSR) to participate in a single auction. In a second mode, the auction is an auctioneer-led full English auction with the auction house system managing the auction under the direction of the auctioneer, wherein the Auction System acts as a “Paddle in the Room” with a CSR manually submitting bids to the auctioneer that are received from online fractional bidders and online full bidders. In a third mode, the auction is a timed English auction, with the Auction System in operational control of all bids, allowing for online fractional bidders and online full bidders.

Across all modes, the Auction System enables the following capabilities and activities: validating auction system users, validating auction system users' spending limits or maximum investment amounts, presenting auction lot asset details to unregistered and registered bidders via various user interfaces, and manage the pre-bidding environment, timing, and process. Other functionalities include managing the bidding environment, timing and processing for bidders, assembling fractional users bidding submissions into valid auction “Now Asking” bids based on time priority (e.g., via pre-bids or live bids).

The Auction System is able to accept valid fractional bids (which may or may not include Auction accepted bids) and accept valid full bids (which also may or may not include Auction accepted bids). The Auction System also maintains an audit trail of all bids that are submitted through the system and is able to communicate the current status of bids to all bidders in the auction, including the user's own bidding history, the auction bidding history, and status of the “Now Asking” bid for system users and/or the public (e.g., unregistered users).

The Auction System is configured to manage auction termination and wins such as user communication, payment processing, document processing, share distribution and asset management (e.g., either storage or distribution of the contested resource).

In either the first or third mode of operation, the system will incrementally: manage the automatic allocation of fractional and full bids in line with auction rules, manage the progression of rounds in line with auction rules, inform the Auctioneer and Clerk of bidder pool size and bidding capacity form the Auctioneer and Clerk of system activity, and present in room and live feed information to bidders and viewing audience. User interfaces associated with the Auction System are also configured to allow the Auctioneer and Clerk to enter and process in-room or phone bids, allow the auctioneer to notify “Final Call”, and/or allow the Auctioneer to conclude the sale.

For the third mode of operation (e.g., timed auctions), the Auction System will manage the clock in the timed auction. Furthermore, at the conclusion of a timed round where no full bid has been received, the system is automatically triggered, in some instances, to conclude the auction.

In view of the foregoing, it should be appreciated that the disclosed embodiments are directed to improved systems and methods which provide technical advantages over conventional software and methods for facilitating auction-type transactions that include fractional bidding and that can also include pooled requests for contested computer resources. Some technical advantages include facilitating a networks' capability to identify and capture potential processing capabilities and other shared resources that are provided in consideration for, or as compensation for, winning a bidding/request contest for server and other system resources.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes which come within the meaning and range of equivalency of the claims are to be embraced within their scope.

### Numbered Clauses

The present invention can also be described in accordance with the following numbered clauses.

Clause 1. A computing system for managing an auction for contested resources between full bidding entities and fractional bidding entities that are enabled to place bids on the contested resources, the computing system comprising: a processor system; and a hardware storage device storing computer-executable instructions that are executable by the processor system to cause the computing system to: identify a contested resource; identify a plurality of bidding entities comprising: full bidding entities that are registered to individually bid on the contested resource for a full ownership of the contested resource, and/or fractional bidding entities that are registered to bid on the contested resource for a fractional ownership of the contested resource as part of a fractional bidding group that collectively has full ownership of the contested resource; initiate a current bidding round corresponding to a current asking price for the contested resource; after initiating the current bidding round, identify a fractional bidding group comprising a plurality of the fractional bidding entities, and a total fractional bidding amount associated with the fractional bidding group relative to the current asking price, wherein the fractional bidding group is dynamically determined for the current bidding round based on (i) a fractional bidding amount for each fractional bidding entity of the fractional bidding group, (ii) a pre-determined minimum bid amount, and (iii) an amount of remaining available shares of the contested resource; identify a full bidding amount received from at least one full bidding entity; determine whether the total fractional bidding amount or the full bidding amount meets or exceeds the current asking price associated with the contested resource in the current bidding round; and in response to determining that the total fractional bidding amount meets or exceeds the current asking price for the contested resource in the current bidding round, terminate the current bidding round and initiate a new bidding round corresponding to a new asking price for the contested resource that is higher than the current asking price, or alternatively, in response to determining that the full bidding amount received from the at least one full bidding entity meets or exceeds the current asking price for the contested resource, terminate the current bidding round and initiate a new bidding round corresponding to a new asking price for the contested resource that is higher than the current asking price.

Clause 2. The computing system of clause 1, the computer-executable instructions being further executable to cause the computing system to: generate and cause to be displayed a user interface on a computing screen associated with the computing system, the user interface displaying textual and graphical information representing (i) the contested resource, (ii) the current bidding round, (iii) the current asking price, (iv) the fractional bidding group, and (v) the total fractional bidding amount relative to the current asking price.

Clause 3. The computing system of clause 1, the computer-executable instructions being further executable to cause the computing system to: during the current bidding round, identify one or more new fractional bidding entities and one or more new fractional bidding amounts associated with the one or more new fractional bidding entities; and in response to identifying one or more new fractional bidding entities, dynamically update the fractional bidding group with one or more new fractional bidding entities and dynamically update the total fractional bidding amount based on the one or more new fractional bidding amounts associated with the one or more new fractional bidding entities.

Clause 4. The computing system of clause 3, the computer-executable instructions being further executable to cause the computing system to: in response to dynamically updating the fractional bidding group and the total fractional bidding amount, dynamically update a user interface displayed on a computing screen associated with the computing system by updating the textual and graphical information with the updated fractional bidding group and the updated total fractional bidding amount relative to the current asking price associated with the current bidding round.

Clause 5. The computing system of clause 1, the computer-executable instructions being further executable to cause the computing system to: after initiating the new bidding round, define a new fractional bidding group based on a plurality of fractional bidding entities and corresponding fractional bid amounts submitted in the new bidding round.

Clause 6. The computing system of clause 5, the computer-executable instructions being further executable to cause the computing system to: in response to defining the new fractional bidding group, dynamically update a user interface displayed on a computing screen associated with the computing system by updating the textual and graphical information with the new fractional bidding group and total fractional bidding amount corresponding to the new fractional bidding group.

Clause 7. The computing system of clause 5, wherein the new fractional bidding group is defined such that the plurality of fractional bidding entities in the new bidding round (i) comprises a new fractional bidding entity not included in the fractional bidding group from the current bidding round and (ii) excludes a fractional bidding entity previously included in the fractional bidding group from the current bidding round.

Clause 8. The computing system of clause 5, wherein the new fractional bidding group associated with the new bidding round is defined such that the plurality of fractional bid entities comprises one or more new fractional bidding entities in addition to the fractional bidding entities included in the fractional bidding group associated with the current bidding round.

Clause 9. The computing system of clause 1, wherein the new asking price for the contested resource in the new bidding round at least meets the total fractional bidding amount from the current bidding round.

Clause 10. The computing system of clause 5, wherein the new asking price for the contested resource in the new bidding round at least meets the full bidding amount from the current bidding round.

Clause 11. The computing system of clause 1, the computer-executable instructions being further executable to cause the computing system to: prior to initiating the new bidding round, identifying at least one initial fractional bidding group comprising one or more fractional bidding entities associated with one or more pre-bid amounts and at least one initial full bidding entity associated with an absentee bid.

Clause 12. A method for managing an auction for contested resources between full bidding entities and fractional bidding entities that are enabled to place bids on the contested resources, the method comprising: identifying a contested resource; identifying a plurality of bidding entities comprising: full bidding entities that are registered to individually bid on the contested resource for a full ownership of the contested resource, and fractional bidding entities that are registered to bid on the contested resource for a fractional ownership of the contested resource as part of a fractional bidding group that collectively has full ownership of the contested resource; initiating a current bidding round corresponding to a current asking price for the contested resource; after initiating the current bidding round, identifying a fractional bidding group comprising a plurality of the fractional bidding entities, and a total fractional bidding amount associated with the fractional bidding group relative to the current asking price, wherein the fractional bidding group is dynamically determined for the current bidding round based on (i) a fractional bidding amount for each fractional bidding entity of the fractional bidding group, (ii) a pre-determined minimum bid amount, and (iii) an amount of remaining available shares of the contested resource; identifying a full bidding amount received from at least one full bidding entity; determining whether the total fractional bidding amount or the full bidding amount meets or exceeds the current asking price associated with the contested resource in the current bidding round; and in response to determining that the total fractional bidding amount meets or exceeds the current asking price for the contested resource in the current bidding round, terminating the current bidding round and initiating a new bidding round corresponding to a new asking price for the contested resource that is higher than the current asking price, or alternatively, in response to determining that the full bidding amount received from the at least one full bidding entity meets or exceeds the current asking price for the contested resource, terminating the current bidding round and initiating a new bidding round corresponding to a new asking price for the contested resource that is higher than the current asking price.

Clause 13. The method of clause 12, wherein each bidding entity in the plurality of bidding entities is verified based on applying a different verification process to different entities based on a maximum investment amount requested by the different entities.

Clause 14. The method of clause 12, wherein each bidding entity in the plurality of bidding entities is associated with a different maximum investment amount and the fractional bidding group is dynamically determined to include a particular fractional bidding entity based on determining that a pre-determined minimum bidding amount does not exceed the maximum investment corresponding to the particular fractional bidding entity.

Clause 15. The method of clause 12, wherein each different maximum bidding amount is adjusted for fees incurred during a particular bidding round.

Clause 16. A computing system for managing an allocation of limited computing resources to one or more consumer computing nodes requesting the allocation of the limited resources, the computing system comprising: a processor system; and a hardware storage device storing computer-executable instructions that are executable by the processor system to cause the computing system to: identify a limited resource; identify a plurality of node entities comprising singular computing nodes and distributed computing nodes requesting allocation of the limited resource, each node entity of the plurality of node entities being associated with a particular reciprocal resource amount; initiate a current allocation round based on identifying a current total reciprocal resource amount associated with allocating the limited resource; after initiating the allocation round, identify a distributed node group comprising one or more distributed nodes and a total distributed reciprocal resource amount associated with the distributed node grouping relative to the total reciprocal resource amount, wherein the distributed node group is dynamically determined for the allocation round based on (i) individual reciprocal resource amounts for each distributed node entity included in the distributed node grouping, (ii) a pre-determined minimum reciprocal resource amount, and (iii) a remaining available amount of the limited resource not already corresponding to the total distributed reciprocal resource amount; identify a singular reciprocal resource amount received from at least one singular node entity; determine whether the total distributed reciprocal resource amount or the singular reciprocal resource amount meets or exceeds the current total reciprocal resource amount associated with the limited resource in the current allocation round; and in response to determining that the total distributed reciprocal resource amount meets or exceeds the total reciprocal resource amount for the limited resource in the current allocation round, terminate the current allocation round and initiate a new allocation round corresponding to a new total reciprocal resource amount for the limited resource, or alternatively, in response to determining that the singular reciprocal resource amount received from the at least one singular node entity meets or exceeds the total reciprocal resource amount for the limited resource, terminate the current allocation round and initiate a new allocation round corresponding to a new total reciprocal resource amount for the limited resource.

Clause 17. The computing system of clause 1, the computer-executable instructions being further executable to cause the computing system to: generate and cause to be displayed a user interface on a computing screen associated with the computing system, the user interface displaying textual and graphical information representing (i) the limited resource, (ii) the current allocation round, (iii) the total reciprocal resource amount, (iv) the distributed node group, and (v) the total distributed reciprocal resource amount relative to the reciprocal resource amount associated with the current allocation round.

Clause 18. The computing system of clause 1, the computer-executable instructions being further executable to cause the computing system to: during the allocation round, identify one or more new distributed node entities and one or more new distributed reciprocal resource amounts associated with the one or more new distributed node entities; and in response to identifying one or more new distributed node entities, dynamically update the distributed node group with one or more new distributed node entities and dynamically update the total distributed reciprocal resource amount based on the one or more new distributed reciprocal resources amounts associated with the one or more new distributed node entities.

Clause 19. The computing system of clause 3, the computer-executable instructions being further executable to cause the computing system to: in response to dynamically updating the distributed node grouping and the total distributed reciprocal resource amount, dynamically update a user interface displayed on a computing screen associated with the computing system by updating the textual and graphical information with the updated distributed node grouping and the updated total distributed reciprocal resource amount relative to the total reciprocal resource amount associated with the allocation round.

Clause 20. The computing system of clause 1, the computer-executable instructions being further executable to cause the computing system to: after initiating the new allocation round, define a new distributed node group based on a plurality of distributed node entities and corresponding distributed reciprocal resource amounts received in the new allocation round.

What is claimed is:

1. A computing system for managing an auction for contested resources between full bidding entities and fractional bidding entities that are enabled to place bids on the contested resources, the computing system comprising:
a processor system; and
a hardware storage device storing computer-executable instructions that are executable by the processor system to cause the computing system to:
identify a contested resource;
identify a plurality of bidding entities comprising:
full bidding entities that are registered to individually bid on the contested resource for a full ownership of the contested resource, and/or
fractional bidding entities that are registered to bid on the contested resource for a fractional ownership of the contested resource as part of a fractional bidding group that collectively has full ownership of the contested resource;
initiate a current bidding round corresponding to a current asking price for the contested resource;
after initiating the current bidding round, identify
a fractional bidding group comprising a plurality of the fractional bidding entities, and
a total fractional bidding amount associated with the fractional bidding group relative to the current asking price,
wherein the fractional bidding group is dynamically determined for the current bidding round based on (i) a fractional bidding amount for each fractional bidding entity of the fractional bidding group, (ii) a pre-determined minimum bid amount, and (iii) an amount of remaining available shares of the contested resource;
identify a full bidding amount received from at least one full bidding entity;
determine whether the total fractional bidding amount or the full bidding amount meets or exceeds the current asking price associated with the contested resource in the current bidding round; and
in response to determining that the total fractional bidding amount meets or exceeds the current asking price for the contested resource in the current bidding round, terminate the current bidding round and initiate a new bidding round corresponding to a new asking price for the contested resource that is higher than the current asking price, or alternatively,
in response to determining that the full bidding amount received from the at least one full bidding entity meets or exceeds the current asking price for the contested resource, terminate the current bidding round and initiate a new bidding round corresponding to a new asking price for the contested resource that is higher than the current asking price.

2. The computing system of claim 1, the computer-executable instructions being further executable to cause the computing system to:
generate and cause to be displayed a user interface on a computing screen associated with the computing system, the user interface displaying textual and graphical information representing (i) the contested resource, (ii) the current bidding round, (iii) the current asking price, (iv) the fractional bidding group, and (v) the total fractional bidding amount relative to the current asking price.

3. The computing system of claim 1, the computer-executable instructions being further executable to cause the computing system to:
during the current bidding round, identify one or more new fractional bidding entities and one or more new fractional bidding amounts associated with the one or more new fractional bidding entities; and
in response to identifying one or more new fractional bidding entities, dynamically update the fractional bidding group with one or more new fractional bidding entities and dynamically update the total fractional bidding amount based on the one or more new fractional bidding amounts associated with the one or more new fractional bidding entities.

4. The computing system of claim 3, the computer-executable instructions being further executable to cause the computing system to:
in response to dynamically updating the fractional bidding group and the total fractional bidding amount, dynamically update a user interface displayed on a computing screen associated with the computing system by updating the textual and graphical information with the updated fractional bidding group and the updated total fractional bidding amount relative to the current asking price associated with the current bidding round.

5. The computing system of claim 1, the computer-executable instructions being further executable to cause the computing system to:
after initiating the new bidding round, define a new fractional bidding group based on a plurality of fractional bidding entities and corresponding fractional bid amounts submitted in the new bidding round.

6. The computing system of claim 5, the computer-executable instructions being further executable to cause the computing system to:
in response to defining the new fractional bidding group, dynamically update a user interface displayed on a computing screen associated with the computing system by updating the textual and graphical information with the new fractional bidding group and total fractional bidding amount corresponding to the new fractional bidding group.

7. The computing system of claim 5, wherein the new fractional bidding group is defined such that the plurality of fractional bidding entities in the new bidding round (i) comprises a new fractional bidding entity not included in the fractional bidding group from the current bidding round and (ii) excludes a fractional bidding entity previously included in the fractional bidding group from the current bidding round.

8. The computing system of claim 5, wherein the new fractional bidding group associated with the new bidding round is defined such that the plurality of fractional bid entities comprises one or more new fractional bidding entities in addition to the fractional bidding entities included in the fractional bidding group associated with the current bidding round.

9. The computing system of claim 1, wherein the new asking price for the contested resource in the new bidding round at least meets the total fractional bidding amount from the current bidding round.

10. The computing system of claim 5, wherein the new asking price for the contested resource in the new bidding round at least meets the full bidding amount from the current bidding round.

11. The computing system of claim 1, the computer-executable instructions being further executable to cause the computing system to:
prior to initiating the new bidding round, identifying at least one initial fractional bidding group comprising one or more fractional bidding entities associated with one or more pre-bid amounts and at least one initial full bidding entity associated with an absentee bid.

12. A method for managing an auction for contested resources between full bidding entities and fractional bidding entities that are enabled to place bids on the contested resources, the method comprising:
identifying a contested resource;
identifying a plurality of bidding entities comprising:
full bidding entities that are registered to individually bid on the contested resource for a full ownership of the contested resource, and
fractional bidding entities that are registered to bid on the contested resource for a fractional ownership of the contested resource as part of a fractional bidding group that collectively has full ownership of the contested resource;
initiating a current bidding round corresponding to a current asking price for the contested resource;
after initiating the current bidding round, identifying
a fractional bidding group comprising a plurality of the fractional bidding entities, and
a total fractional bidding amount associated with the fractional bidding group relative to the current asking price,
wherein the fractional bidding group is dynamically determined for the current bidding round based on (i) a fractional bidding amount for each fractional bidding entity of the fractional bidding group, (ii) a pre-determined minimum bid amount, and (iii) an amount of remaining available shares of the contested resource;
identifying a full bidding amount received from at least one full bidding entity;
determining whether the total fractional bidding amount or the full bidding amount meets or exceeds the current asking price associated with the contested resource in the current bidding round; and
in response to determining that the total fractional bidding amount meets or exceeds the current asking price for the contested resource in the current bidding round, terminating the current bidding round and initiating a new bidding round corresponding to a new asking price for the contested resource that is higher than the current asking price, or alternatively,
in response to determining that the full bidding amount received from the at least one full bidding entity meets or exceeds the current asking price for the contested resource, terminating the current bidding round and initiating a new bidding round corresponding to a new asking price for the contested resource that is higher than the current asking price.

13. The method of claim 12, wherein each bidding entity in the plurality of bidding entities is verified based on applying a different verification process to different entities based on a maximum investment amount requested by the different entities.

14. The method of claim 12, wherein each bidding entity in the plurality of bidding entities is associated with a different maximum investment amount and the fractional bidding group is dynamically determined to include a particular fractional bidding entity based on determining that a pre-determined minimum bidding amount does not exceed the maximum investment corresponding to the particular fractional bidding entity.

15. The method of claim 12, wherein each different maximum bidding amount is adjusted for fees incurred during a particular bidding round.

16. A computing system for managing an allocation of limited computing resources to one or more consumer computing nodes requesting the allocation of the limited resources, the computing system comprising:
a processor system; and
a hardware storage device storing computer-executable instructions that are executable by the processor system to cause the computing system to:
identify a limited resource;
identify a plurality of node entities comprising singular computing nodes and distributed computing nodes requesting allocation of the limited resource, each node entity of the plurality of node entities being associated with a particular reciprocal resource amount;
initiate a current allocation round based on identifying a current total reciprocal resource amount associated with allocating the limited resource;
after initiating the allocation round, identify
a distributed node group comprising one or more distributed nodes and
a total distributed reciprocal resource amount associated with the distributed node grouping relative to the total reciprocal resource amount,
wherein the distributed node group is dynamically determined for the allocation round based on (i) individual reciprocal resource amounts for each distributed node entity included in the distributed node grouping, (ii) a pre-determined minimum reciprocal resource amount, and (iii) a remaining available amount of the limited resource not already corresponding to the total distributed reciprocal resource amount;
identify a singular reciprocal resource amount received from at least one singular node entity;
determine whether the total distributed reciprocal resource amount or the singular reciprocal resource amount meets or exceeds the current total reciprocal resource amount associated with the limited resource in the current allocation round; and
in response to determining that the total distributed reciprocal resource amount meets or exceeds the total reciprocal resource amount for the limited resource in the current allocation round, terminate the current allocation round and initiate a new allocation round corresponding to a new total reciprocal resource amount for the limited resource, or alternatively,
in response to determining that the singular reciprocal resource amount received from the at least one singular node entity meets or exceeds the total reciprocal resource amount for the limited resource, terminate the current allocation round and initiate a new allocation round corresponding to a new total reciprocal resource amount for the limited resource.

17. The computing system of claim 16, the computer-executable instructions being further executable to cause the computing system to:
generate and cause to be displayed a user interface on a computing screen associated with the computing system, the user interface displaying textual and graphical information representing (i) the limited resource, (ii) the current allocation round, (iii) the total reciprocal resource amount, (iv) the distributed node group, and (v) the total distributed reciprocal resource amount relative to the reciprocal resource amount associated with the current allocation round.

18. The computing system of claim 16, the computer-executable instructions being further executable to cause the computing system to:
during the allocation round, identify one or more new distributed node entities and one or more new distributed reciprocal resource amounts associated with the one or more new distributed node entities; and
in response to identifying one or more new distributed node entities, dynamically update the distributed node group with one or more new distributed node entities and dynamically update the total distributed reciprocal resource amount based on the one or more new distributed reciprocal resources amounts associated with the one or more new distributed node entities.

19. The computing system of claim 18, the computer-executable instructions being further executable to cause the computing system to:
in response to dynamically updating the distributed node grouping and the total distributed reciprocal resource amount, dynamically update a user interface displayed on a computing screen associated with the computing system by updating the textual and graphical information with the updated distributed node grouping and the updated total distributed reciprocal resource amount relative to the total reciprocal resource amount associated with the allocation round.

20. The computing system of claim 16, the computer-executable instructions being further executable to cause the computing system to:
after initiating the new allocation round, define a new distributed node group based on a plurality of distributed node entities and corresponding distributed reciprocal resource amounts received in the new allocation round.
